(19) United States
(12) Patent Application Publication
(10) Pub. No.: US 2022/0053899 A1
(43) Pub. Date: Feb. 24, 2022

(54) Portable Workstation Component Case

(71) Applicant: ltsa Desk LLC, Rockland, ME (US)

(72) Inventor: Marcel Valliere, Rockland, ME (US)

(21) Appl. No.: 17/407,889

(22) Filed: Aug. 20, 2021

Related U.S. Application Data
(60) Provisional application No. 63/069,118, filed on Aug. 23, 2020.

(51) Int. Cl. A45C 11/00; A45C 13/00; A45C 13/02; A45C 5/14; A45C 13/26; G06F 1/16

(52) U.S. Cl. CPC A45C 11/00; A45C 13/005; A45C 13/02; A45C 5/14; A45C 2013/267; G06F 1/1628; A45C 2011/003; A45C 2013/025; A45C 13/262

(57) ABSTRACT

The case of the present disclosure can be configured to receive a computing device and at least one additional monitor. The case can have a base having a computing surface configured to receive the computing device. The case can also have a lid moveable relative to the base from a closed configuration to an open configuration, the closed configuration permitting transport of the computing device and the at least one additional monitor within the case, and the open configuration permitting use of the computing device in conjunction with the at least one additional monitor. Further, a monitor mount can be fixedly coupled to the at least one additional monitor, and move to position the at least one additional monitor for use generally above the computing device when the lid is in the open configuration and position the at least one additional monitor for storage generally parallel to the computing surface when the lid is in the closed configuration.

### PRIORITY CLAIM

This application claims the benefit of U.S. Provisional Patent Application No. 63/069,118, filed Aug. 23, 2020, which is incorporated by reference herein in its entirety.

### FIELD OF DISCLOSURE

The present disclosure relates to a case that provides an ergonomic and stable platform for computer use. The case can ergonomically position and safely stow a computer, mouse, keyboard, and one or multiple monitors. This can provide a portable desk-like configuration for computer hardware that can be easily erected and transported.

### BACKGROUND

Many people are now working remotely from home, either by choice or by mandate. And more companies are now embracing the “working remotely” mentality as a more permanent idea. This has created a range of problems that are solved by the current disclosure.

Many members of this population had a work environment that was set up to optimize their daily work. Now after being displaced from their office, they need to create that same or similar environment from home, or in any number of non-traditional office environments.

This is not an easy task. Many people live in homes and apartments that don't have space for a dedicated office. Often the dining room table becomes that with the addition of the laptop. This situation can be difficult when compared to the 2-3 monitors and/or standing ergonomic desk they previously enjoyed.

Many people travel for work and some work remotely. No matter where a computer worker may want to work, they should have the equipment to do it in a healthy and productive way. This disclosure makes that possible.

### BRIEF SUMMARY OF THE DISCLOSURE

A case of the present disclosure can store and transport a computer, mouse, soundbar speaker, and one, two, or more additional monitors, and stably and ergonomically position these components for use. The case can be designed to accommodate all or a number of these items. When fully erected, the case can allow one or more additional monitors to be set up at an appropriate height for a standing desk. The case may also locate the keyboard and mouse area at an appropriate height for its user. Further, the case can be adjustable for the user's height. It can also be designed to fit the dimensional constraints for standard airline carry-on luggage requirements. For example, the case may include integrated wheels and a slide-out handle for easy transport.

The case can be set up in one or more operational or “unpacked” configurations, in little time and on a variety of surfaces. The case may also be closed into one or more “packed” configurations for transport or storage. Such easy unpacking & packing can give a user back their dining-room table, bar-top, picnic table, or other surface after using it for the case platform. The case can be as simple to take down as it is to set up, with various moveable components easily & safely locking & unlocking as needed. The overall design of the case provides an ergonomic, stable, and safe platform from which to work for extended periods of time.

Related prior luggage suffered several drawbacks. For example, some luggage would only operate on a around or travel surface, and was therefore unsuitable for operating on a table or bench top. Other luggage was too unstable or flimsy, making them unsuitable for a computer platform that may require vigorous and constant typing. Other luggage was not suited for ergonomically positioning monitors relative to a keyboard or laptop computer. Those and other problems are solved by the case described herein.

Some luggage is known in the prior art. However, this luggage has limitations and is designed for different purposes. Moreover, this luggage is generally not adaptable to transport one or more additional monitors. In addition, the luggage of the prior art does not contemplate the new working requirements a user may need with a modern mobile computing platform.

Some prior art describes luggage with extendable legs. For example, U.S. Pat. No. 8,616,354 by Azirian describes a briefcase with extendable legs, and U.S. Pat. No. 6,811,006 by Mundle describes a convertible briefcase/table with extendable legs. However, the legs of Azirian are bulky and complicated, and thus not suitable for ease of transport and everyday use. And Mundle does not operate with additional monitors, and is not suitable for ergonomic use.

Various other prior art describes luggage for use with printers or other peripherals. For example, U.S. Pat. No. 6,578,708 by Barnett describes a laptop workstation with extendable stand, U.S. Pat. No. 5,212,628 by Bradbury describes a workstation with a moveable support tray, U.S. Pat. No. 5,647,484 by Fleming describes a laptop encasement device, U.S. Pat. No. 6,530,475 by Penney describes a portable office case with multiple shelves, US Patent Application Number US 2002/0063072 by Pham describes a computer case/table with extendable legs, and US Patent Application Number US 2008/0023283 by Sutker et al. describes a portable workstation with peripheral supports and telescoping legs. But none of these devices are suitable for storing or ergonomically using additional monitors.

Some prior art luggage is specifically designed to operate with laptops. For example, UK Patent Application Number GB 2558679 by Coley describes a portable workstation for use with a laptop, and U.S. Pat. No. 7,278,644 by Villarreal describes a portable workspace for laptop computers. However, Coley only contemplates positioning the laptop's monitor, and not additional monitors. And Villarreal is more like a cabinet than a suitcase and is not suitable for use with additional monitors or everyday use.

Much of the prior art suffers from at least one of several deficiencies. Many are essentially modified luggage or briefcases with recessed bodies hingedly connected to flat covers. As such, they are ill suited for ergonomic use of a keyboard located in the recessed bodies because long-term and comfortable access to the keyboard is limited or impossible. Many prior art devices are also specifically configured to operate with a printer. But a printer is bulky, statically located, and only sporadic access is needed. In contrast, monitors are generally flat, require specific storage, set-up, take-down, and should be easily adjustable for sustained ergonomic use.

The prior art also fails to properly address stability issues with their devices. Some telescoping legs would not be suitable for everyday use when a user needs to quickly and easily set-up or take down their devices. Further, their legs extend vertically and will not tolerate lateral instability or uneven load distribution. The prior art also fails to provide external surfaces on their devices to provide enough stability or load distribution when legs are not in use. And adequate load bearing considerations between the covers and bases are not fully addressed by the prior art.

These disadvantages of the prior art are solved by the current disclosure. In general, the current disclosure can provide a stable, ergonomic, useable, and compact way of storing, transporting, and operating a computing system with one or more additional monitors.

In some embodiments, a case can be configured to receive a computing device and at least one additional monitor. The case can comprise a base having a computing surface configured to receive the computing device. The case can also comprise a lid moveable relative to the base from a closed configuration to an open configuration, the closed configuration permitting transport of the computing device and the at least one additional monitor within the case, and the open configuration permitting use of the computing device in conjunction with the at least one additional monitor. Further, a monitor mount can be fixedly coupled to the at least one additional monitor, and configured to move to position the at least one additional monitor for use generally above the computing device when the lid is in the open configuration and position the at least one additional monitor for storage generally parallel to the computing surface when the lid is in the closed configuration.

In some embodiments, the base can be generally flat, the lid can further include a recess configured to receive the at least one additional monitor in the closed configuration, and the computing device can includes at least one of a laptop, a tablet, a mouse, and a keyboard.

In some embodiments, when in the open configuration, the lid can be positioned at about 110 degrees relative to base and a center of the at least one additional monitor can be located about 12 inches to about 20 inches above the computing surface of the base.

In some embodiments, at least one lid stay can be configured to limit the rotational movement of the lid relative to the base and releasably secure the lid and the base in the open configuration, wherein the at least one lid stay can be slidably or pivotably coupled to at least one of the lid and the base.

In some embodiments, the at least one additional monitor can be moveable from a first position wherein the at least one additional monitor can be located generally within the lid to a second position wherein the at least one additional monitor can be located generally above the lid.

In some embodiments, the base can coupled to at least one leg configured to move from a retracted configuration wherein the at least one leg can be generally parallel to a bottom surface of the base to an extended configuration wherein a distal end of the at least one lea can be in contact with a working surface located about 28 to about 36 inches above a travel surface to locate the bottom surface of the base about 4 inches to about 12 inches above the working surface.

In some embodiments, the at least one leg in the extended configuration can extend from the bottom surface of the base at an angle greater than 90 degrees such that the distal end of the at least one leg contacts the working surface generally behind a back edge of the bottom surface of the base.

In some embodiments, the at least one leg can include a front leg having a length between about 6 inches to about 9 inches and angled at about 90 degrees relative to the base in the extended configuration, and a back leg can have a length between about 8 inches and about 12 inches and angled at about 125 to about 145 degrees relative to the base in the extended configuration.

In some embodiments, the base can further include at least one leg box configured to receive at least one of the legs, wherein in the retracted configuration, the at least one leg can be generally within the leg box.

In some embodiments, the leg box can further include a leg mounting mechanism configured to releasable lock and unlock the at least one leg in at least one of the retracted and extended configurations.

In some embodiments, the base can have at least one base surface configured to contact a working surface when the case is in the open and closed configurations, and the lid can have at least one lid surface configured to contact the working surface in only the open configuration when the at least one base surface is in contact with the working surface to maintain the lid at an angle relative to the base of greater than about 90 degrees.

In some embodiments, the at least one lid surface can be located generally behind a center-of-mass of the case when the lid is in the open configuration and the at least one additional monitor is located generally above the computing device.

In some embodiments, the monitor mount can further include an L-bracket and the lid can further include a latch, wherein the L-bracket and the latch can be configured to releasably lock and unlock to releasably lock and unlock the monitor mount to the lid.

In some embodiments, the L-bracket can be pivotably coupled to the lid.

In some embodiments, the L-bracket can be pivotably and slidably coupled to the lid via a rail that extends from a first internal surface of the lid to a second internal surface of the lid generally located opposite the first internal surface of the lid.

In some embodiments, the rail can include at least one recess configured to receive a pivot of the L-bracket.

In some embodiments, the monitor mount can include an articulating monitor arm configured to provide general movement and fixed positioning of the monitor relative to the base.

In some embodiments, the monitor mount can further include at least one monitor bracket configured to receive one of the at least one additional monitors and allow movement of the one additional monitor relative to the monitor mount.

In some embodiments, the monitor mount can include two monitor brackets, each can be configured to receive one of the at least one additional monitors, wherein the two monitor brackets can include at least one hinge configured to allow the two monitors to rotate relative to each other from a closed configuration to an open configuration.

In some embodiments, a monitor mount release can be configured to releasable lock and unlock movement of the monitor mount relative to the lid.

### BRIEF DESCRIPTION OF THE EXEMPLARY DRAWINGS

Some embodiments of the present disclosure are illustrated as an example and not limited by the figures of the accompanying drawings, in which Ike references may indicate similar elements in which:

FIG. 1a illustrates a top-side perspective view of the case in a rolling configuration on a travel surface, with an extended handle.

FIG. 1b illustrates a base-side perspective view of the case in the rolling configuration on a travel surface, with an extended handle and retracted legs.

FIG. 2a illustrates a top-side perspective view of the case in a standing configuration on a travel surface, with a retracted handle.

FIG. 2b illustrates a base-side perspective view of the case in the standing configuration on a travel surface, with a retracted handle and retracted legs.

FIG. 3a illustrates a front-side perspective view of the case as placed on a working surface.

FIG. 3b illustrates a back-side perspective view of the case as placed on a working surface.

FIG. 3c illustrates a front-side perspective view of the case in a partially open configuration.

FIG. 3d illustrates a back-side perspective view of the case in a partially open configuration.

FIG. 3e illustrates a front-side perspective view of the case in an open configuration.

FIG. 3f illustrates a back-side perspective view of the case in an open configuration.

FIG. 4a illustrates an end view of the case with a back side resting on a travel surface.

FIG. 4b illustrates a right-side end view of the case with a base resting on a working surface and a lid in a partially open configuration,

FIG. 4c illustrates a left-side end view of the case with a base resting on a working surface and a lid in a fully open configuration and a monitor mount in a fully open configuration.

FIG. 5a illustrates an exterior perspective view of the case with a lid in a fully open configuration showing a lid stay limiting lid movement.

FIG. 5b illustrates an interior perspective view of the case with a lid in a fully open configuration showing a lid stay limiting lid movement.

FIG. 5c illustrates an interior perspective view of hinge components of the case in a fully open configuration showing a lid stay limiting movement.

FIG. 5d illustrates an interior perspective view of hinge components of the case in a partially open configuration showing movement of a lid stay.

FIG. 6a illustrates a front-base perspective view of the case in a standing configuration on a travel surface with deployed legs.

FIG. 6b illustrates a perspective view of a right leg box of the case with retracted legs.

FIG. 6c illustrates a perspective view of a right lea box of the case with deployed or extended legs.

FIG. 6d illustrates a detailed perspective view of a leg mounting mechanism of a leg box with retracted legs.

FIG. 6e illustrates a detailed perspective view of a leg mounting mechanism of a leg box with deployed legs.

FIG. 7a illustrates a front-side perspective view of the case in a laying configuration on a working surface with deployed legs and closed lid.

FIG. 7b illustrates a front-left-side perspective view of the case on a working surface with deployed legs and open lid.

FIG. 7c illustrates a front-right-side perspective view of the case on a working surface with deployed legs, fully open lid, and partially open storage lid.

FIG. 7d illustrates a front-right-side perspective view of the case on a working surface with deployed legs, fully open lid, and partially open or extended monitor mount.

FIG. 7e illustrates a front-right-side perspective view of the case on a working surface with deployed legs, fully open lid, and fully open or deployed monitor mount.

FIG. 7f illustrates a perspective view of a left leg box of the case with retracted legs and monitor mount release.

FIG. 8a illustrates a detailed top-side perspective view of an L-bracket locked to a base-lid latch with the monitor mount in a fully deployed configuration aligned with the lid.

FIG. 8b illustrates a detailed top-side perspective view of an L-bracket locked to a base-lid latch with the monitor mount in a tilted configuration relative to the lid.

FIG. 8c illustrates an internal view of an L-bracket locked to a base-lid latch with the monitor mount in a fully deployed configuration aligned with the lid.

FIG. 8d illustrates an internal view of an L-bracket of the case locked to a base-lid latch with the monitor mount in a titled configuration relative to the lid.

FIG. 9a illustrates a front-side perspective view of the additional monitors in a storage or retracted position.

FIG. 9b illustrates a perspective view of a monitor bracket.

FIG. 9c illustrates a back-side perspective view of the additional monitors in a storage or retracted position.

FIG. 9d illustrates a back-side perspective view of the additional monitors in a partial storage or retracted position.

FIG. 10a illustrates a top view of two monitors in a closed configuration mounted to a monitor bracket in an un-extended configuration.

FIG. 10b illustrates a top view of two monitors in a closed configuration mounted to the monitor bracket in a partially extended configuration with two swing arms.

FIG. 10c illustrates a top view of two monitors in a closed configuration mounted to the monitor bracket in a more partially extended configuration than shown in FIG. 10b,

FIG. 11a illustrates a front-left-side perspective view of the case with two monitors in a closed configuration and a rear monitor bracket in a final or operational position relative to a monitor mount.

FIG. 11b illustrates a front-right-side perspective view of the case with two monitors in a final open or operational configuration.

FIG. 12a illustrates a left-side end view of the case, with legs deployed and one or more additional monitors in a fully open configuration.

FIG. 12b illustrates a left-side end view of the case, with legs deployed and one or more additional monitors in a tilted forward configuration.

FIG. 13a illustrates a top right perspective view of the case, with legs deployed, the lid in an open configuration, and one or more additional monitors in a closed or storage configuration, according to another embodiment.

FIG. 13b illustrates a cut-through sagittal view of the lid shown in FIG. 13a, with two additional monitors in a closed or storage configuration.

FIG. 13c illustrates a top right perspective view of the case, with legs deployed, the lid in an open configuration, and one additional monitor in a partially open configuration.

FIG. 13d illustrates a detailed internal left perspective view of the lid in an open configuration, and one additional monitor in a partially open configuration.

FIG. 13e illustrates a perspective view of a monitor rail alone.

FIG. 13f illustrates a detailed internal left perspective view of the lid in an open configuration, and one additional monitor in a fully open or operational configuration.

FIG. 14a illustrates a top right perspective view of the case, with leas deployed, the lid in an open configuration, one additional monitor in an open configuration, and another additional monitors in a partially open configuration.

FIG. 14b illustrates a detailed internal left perspective view of the lid in an open configuration, one additional monitor in an open configuration, and another additional monitors in an almost open configuration with an L-bracket about to be received within a recess of a monitor rail.

FIG. 14c illustrates a detailed internal left perspective view of the lid in an open configuration, and two additional monitors in fully open or operational configurations coupled to two monitor rails.

FIG. 14d illustrates a cut-through sagittal view of the lid shown in FIG. 14c, with a second additional monitor in a fully open or operational configuration showing an L-bracket coupled to a monitor rail.

FIG. 14e illustrates a back top perspective view of the case, with the lid in an open configuration, and two additional monitors open configurations, with one monitor positioned higher than the other monitor.

FIG. 15a illustrates a top right perspective view of the case, with legs deployed, the lid in an open configuration, and one or more additional monitors in a closed or storage configuration, according to another embodiment.

FIG. 15b illustrates a perspective view of an articulating monitor arm alone, in a closed or storage configuration.

FIG. 15c illustrates a top right perspective view of the case, with legs deployed, the lid in an open configuration, and one or more additional monitors in a partially open configuration.

FIG. 15d illustrates a top right perspective view of the case, with legs deployed, the lid in an open configuration, and one or more additional monitors in a fully open or operational configuration.

FIG. 15e illustrates a perspective view of an articulating monitor arm alone, in a fully open or operational configuration.

### DETAILED DESCRIPTION OF THE DISCLOSURE

The terminology used herein is for the purpose of describing particular embodiments only and is not intended to be limiting of the disclosure. As used herein, the term “and/or” includes any and all combinations of one or more of the associated listed items. As used herein, the singular forms “a” “an,” and, “the” are intended to include the plural forms as well and the singular forms, unless the context clearly indicates otherwise. It will be further understood that the terms “comprises” and/or “comprising”, when used in this specification, specify the presence of stated features, steps, operations, elements and/or components, but do not preclude the presence or addition of one or more of the other features, steps, operations, elements, components, and/or groups thereof.

In describing the disclosure, it will be understood that a number of configurations and steps are disclosed. Each of these has an individual benefit and can also be used in many different settings. Accordingly, for the sake of clarity, this description will refrain from repeating every possible combination of the individual configurations in an unnecessary fashion. Nevertheless, the specifications and claims should be read with the understanding that such combinations are entirely within the scope of this disclosure and the claims.

As described below and shown in the figures, case 10 can include a base 20 and a lid 30. Base 20 or lid 30 may be constructed from a range of suitable materials, including for example, plastic, steel, fabric, or aluminum. These materials may be coated to resist damage, for example, carbon fiber or wrapped aluminum. One or more corners or edges of base 20 or lid 30 may be formed of one or more plastic components. Base 20 or lid 30 may be formed from a single material (e.g., injection molded plastic or stamped & folded aluminum), or from multiple materials (e.g., aluminum & plastic sections).

In selecting suitable materials for base 20 or lid 30, weight and load distribution are considerations. Ideally, base 20 and lid 30 should be light, strong, and impact resistant to tolerate the demands of travelers and their hardware components stored within case 10. As explained in more detail below, base 20 and lid 30 should also provide suitable load distribution to allow safe operation during use in a fully open configuration, and be easily convertible from open-to-closed and closed-to-open configurations.

Consequently, some components associated with base 20 and lid 30 may be lighter or heavier depending on the hardware components case 10 is designed to accommodate.

As shown and described below, lid 30 can include a volume or recess generally configured to contain one or more hardware components, while base 20 can be generally flat by comparison. For example, this volume or recess of lid 30 can be dimensioned or configured to accommodate the one or more additional monitors contained within case 10. Additional hardware components may also be contained within the volume or recess of lid 30 if needed to ergonomically position one or more additional monitors relative to a user. And various components and features of base 20 and lid 30 may be interchanged or reversed.

Without the improvements described below, traditional cases would be unbalanced and may topple over. Additional vibrations caused by typing can also create instabilities with traditional cases, Space is also generally limited, so components of case 10 cannot be overly bulky or occupy significant space. Various types of padding or shock-absorbing materials may be used to protect delicate components. And strong and light-weight components may be needed to support one or more larger additional monitors. Case 10 solves these problems, as described in more detail below.

In some embodiments, as described below and shown in the figures, base 20 can include one or more legs configured to extend from base 20 to raise case 10 generally above a working surface. Raising case 10 from a working surface can allow for more ergonomic positioning of case 10 relative to a user. It is also contemplated that case 10 can be used when a bottom surface of base 20 is located directly on a working surface.

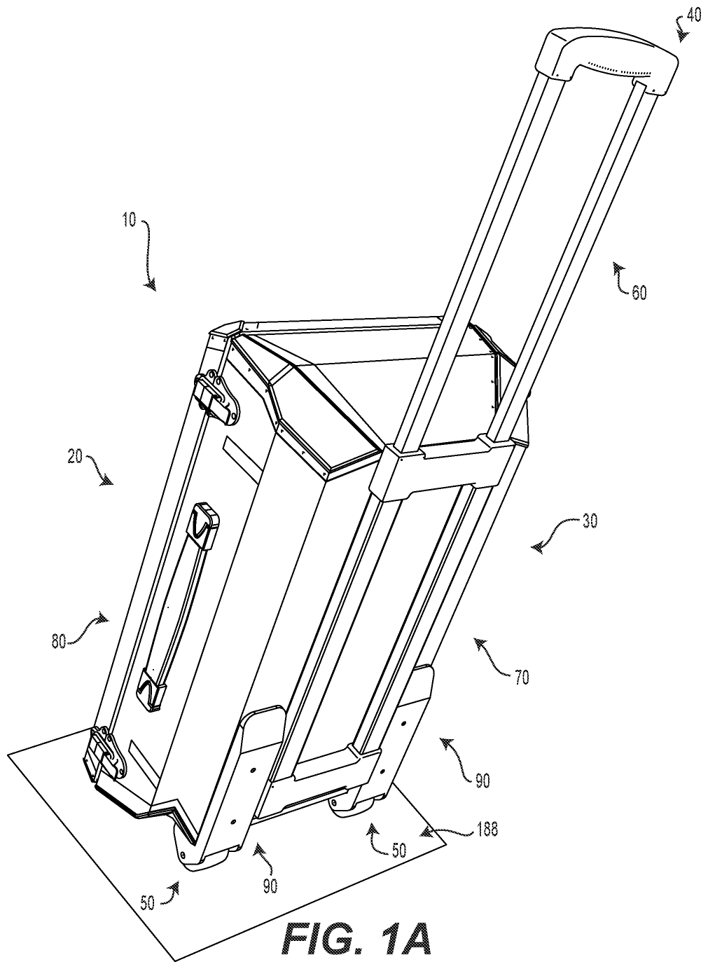

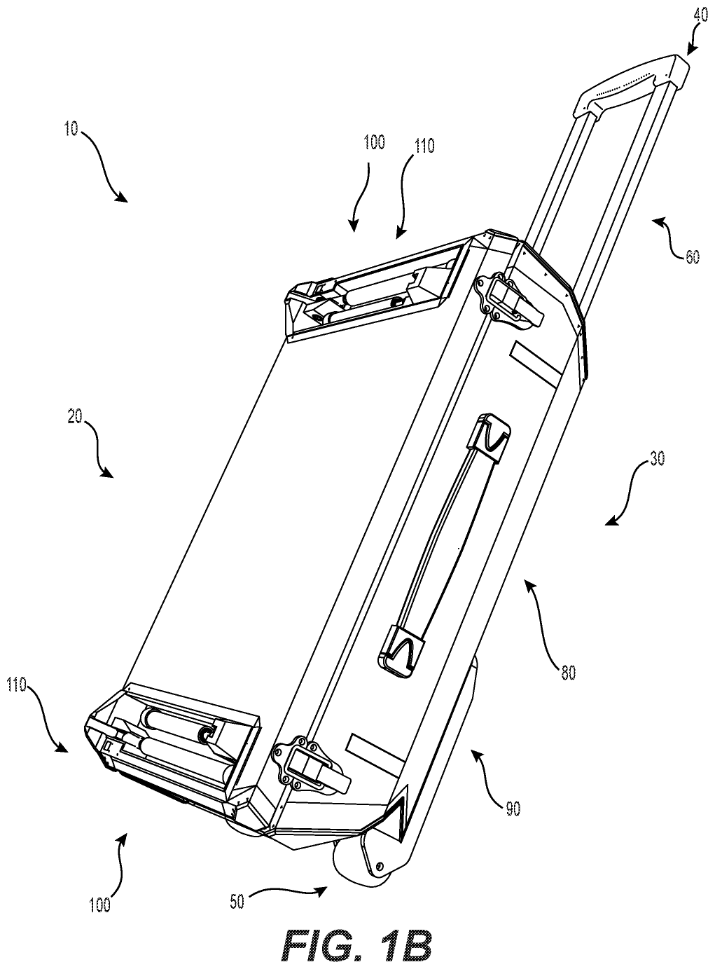

When closed, case 10 may assume various configurations. For example, as shown in FIGS. 1a, 1b, case 10 may be closed and used in a rolling configuration. Such a configuration may be possible if case 10 includes a handle 40 and one or more wheels 50, wherein handle 40 can be extendable from case 10, and wheels 50 can freely rotate. Thus, case 10 can be transported on or over a travel surface 188. Travel surface 188 can include a ground, road, path, sidewalk, floor, etc. or any surface that case 10 travels over or on, or is stored on, Typically, case 10 may be in a closed configuration during transport.

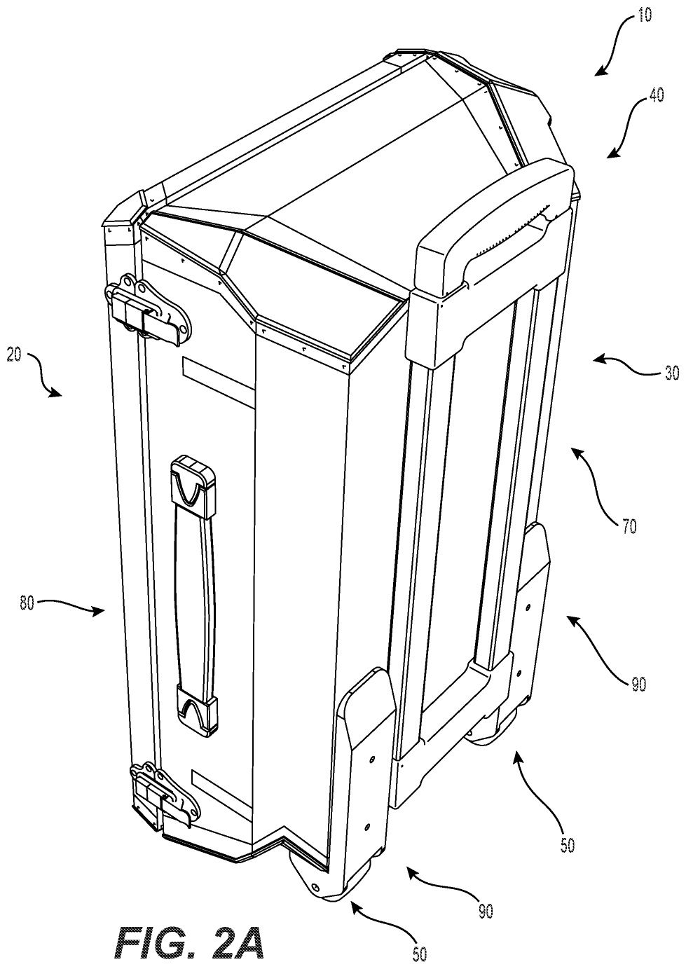

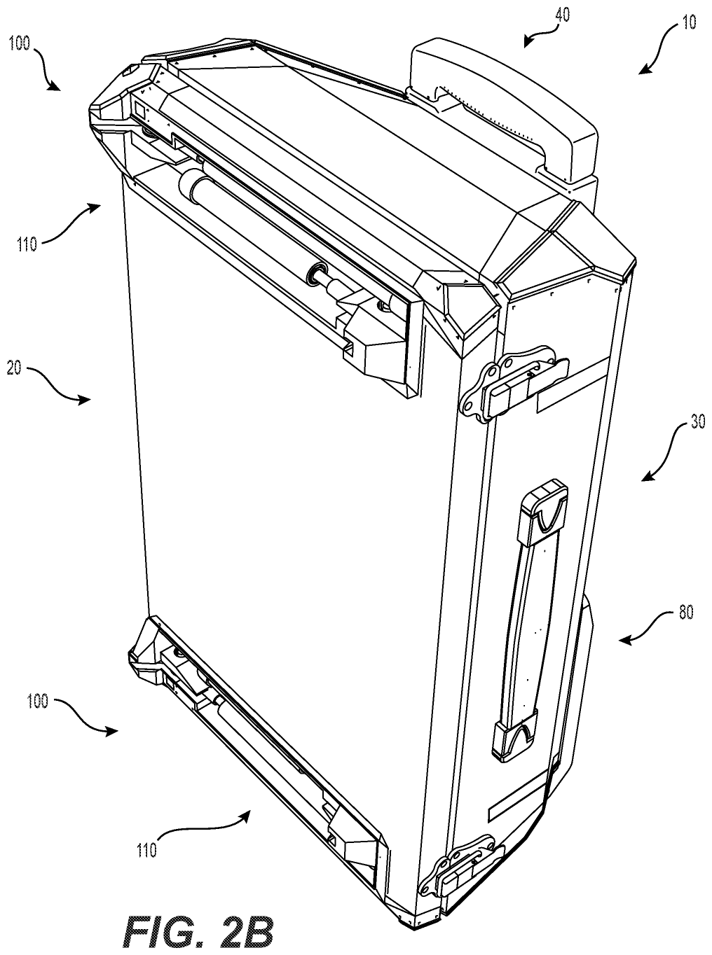

Case 10 may also assume a standing configuration, as shown in FIGS. 2a, 2b, whereby case 10 may be configured to stand or remain stationary on travel surface 188. There handle 40 may be collapsed relative to the position of handle 40 in the rolling configuration, and wheels 50 may not be able to freely rotate because another part of case 10 is also in contact with a ground or travel surface. Other configurations of case 10 are possible and are associated with the various features and functions of case 10, as explained in more detail below.

As shown in FIGS. 2a, 2b, when the case 10 is closed and in a standing position, two wheels 50 and base 20 and/or lid 30 may be in contact with the travel surface it stands on, Base 20 and/or lid 30 may have integrated feet or rubber bumper feet that could separate the base 20 and/lid 30 from the travel surface. In another embodiment, case 10 could have four wheels 50 located at a lower end of standing case 10 (not shown). In such an embodiment, base 20 and lid 30 may each have two wheels attached to each section. It is also possible that lid 30 may have four wheels attached to that single section. Other embodiments of case 10 could include no wheels 50, or any number of wheels 50.

When the case 10 is being transported over travel surface 188, handle 40 can be pulled up to facilitate a suitable angle from the case 10 to its user's hand when in the rolling position (see FIGS. 1a, 1b). When handle 40 is pulled out it, in turn, can pull out handle arms 60 that may be attached to handle 40. As shown in FIGS. 1a, 2a handle arms 60 can slide out of one or more handle arm sleeves 70.

As shown in FIGS. 1a, 2a, handle components 40, 60, 70 may be attached to lid 30 or integrated into the structure of lid 30. These handle components 40, 60, 70 may further be lockable in an open, closed, or any number of intermediate positions to accommodate users of different heights. It is also contemplated that case 10 may not include any handle components 40, 60, 70, or base 20 may include one or more handle components 40, 60, 70.

Case 10 can also include any number of stationary or non-extendable handles. For example, as shown in FIGS. 1a-2b, case 10 has a stationary handle 80 mounted to lid 30. Although not shown, one or more stationary handles 80 could be located on either or both short ends of lid 30. A stationary handle 80 could also be located between the wheels 50 on an angled part of lid 30. Stationary handle 80 can also be located on the angled section of lid 30 near handle 40. In other embodiments, one or more stationary handles 80 can be located on base 20.

It is contemplated that the location and/or dimensions of one or more stationary handles 80 can be positioned and configured as required. Also, stationary handles 80 may be used for pulling and pushing when sliding into overhead bins, vehicle trunks, and lifting vertically when the case 10 is in a standing position. Stationary handles 80 may also be located specifically at each end of case 10 so it can be easily lifted onto a working surface with or without any base legs deployed or opened, as explained below in detail.

As shown in FIGS. 1a-2b, stationary handle 80 is generally centrally located on a long side of lid 30 not containing any hinges. Stationary handle 80 may also be located closer to the edge side of lid 30 so that weight within case 10 can be more evenly distributed to allow better balance when carried by stationary handle 80.

As shown in FIGS. 1a, 1b, when case 10 is in a rolling position only the two wheels 50 of case 10 may be in contact with the ground or travel surface 188. If case 10 has four wheels 50, then the rolling position may be the same as the standing position. As shown in FIGS. 1a, 2a, wheels 50 may be mounted on, below, or beside one or more stair skids 90. Case 10 may also not have any stair skids 90.

In some embodiments, stair skid 90 may be formed as a single integral component with wheel 50. Further, stair skid 90, wheel 50, and handle arm sleeve 70 may also be formed as a single integral component. As described below, one or more various other components of case 10 may be formed as single integral pieces with at least one of stair skid 90, wheel 50, and handle arm sleeve 70. In addition, one or more handles 80 or other components of case 10 could be formed as single integral pieces with lid 30 and/or base 20.

FIGS. 1b, 2b also show two leg boxes 100 located in base 20. And within each leg box 100 is shown two base legs 110. As shown and described below in detail, base legs 100 may assume a deployed, open, or extended configuration and a retracted, closed, or un-extended configuration, as shown in FIGS. 1b, 2b. As shown and explained below, base legs 110 can allow case 10 to be positioned and operated at a height above a working surface.

Although leg boxes 100 and legs 110 are shown along the shorter sides of base 20, they may also be located along the longer sides of base 20. Further, the length of legs 110 may be limited by the maximum dimensions of case 10. For example, if case 10 is dimensioned about 9 inches by about 14 inches by about 22 inches, legs 110 may be less than about 14 inches in length if located as shown in FIGS. 1b, 2b. Alternatively, legs 110 could be located along the longer sides of base 20 and be less than about 22 inches in length. However, such legs 110 should also be configured to extend at an angle greater than ninety degrees beyond a back edge of base 20 or lid 30 as explained below.

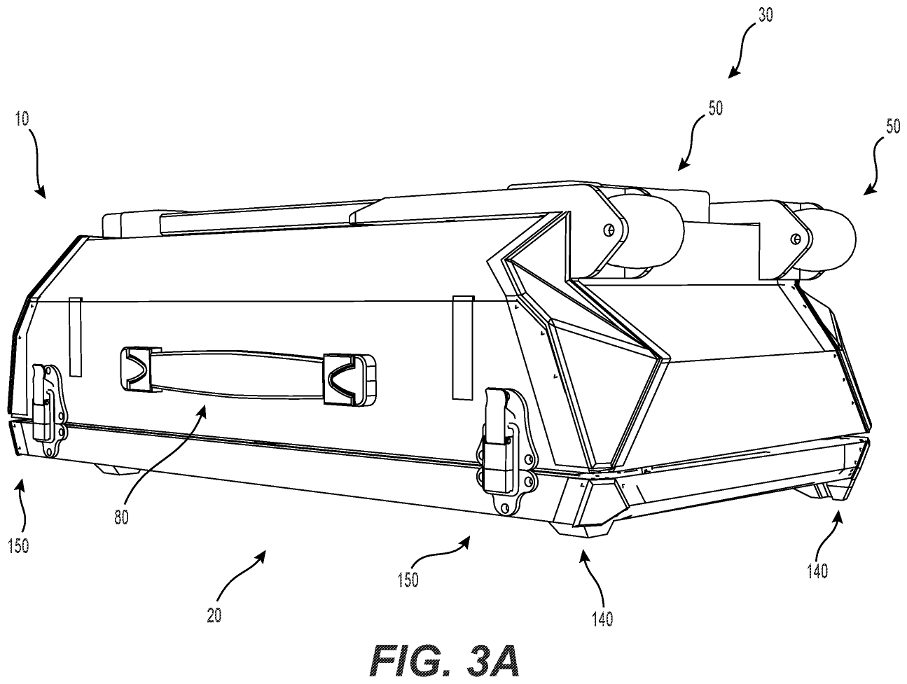

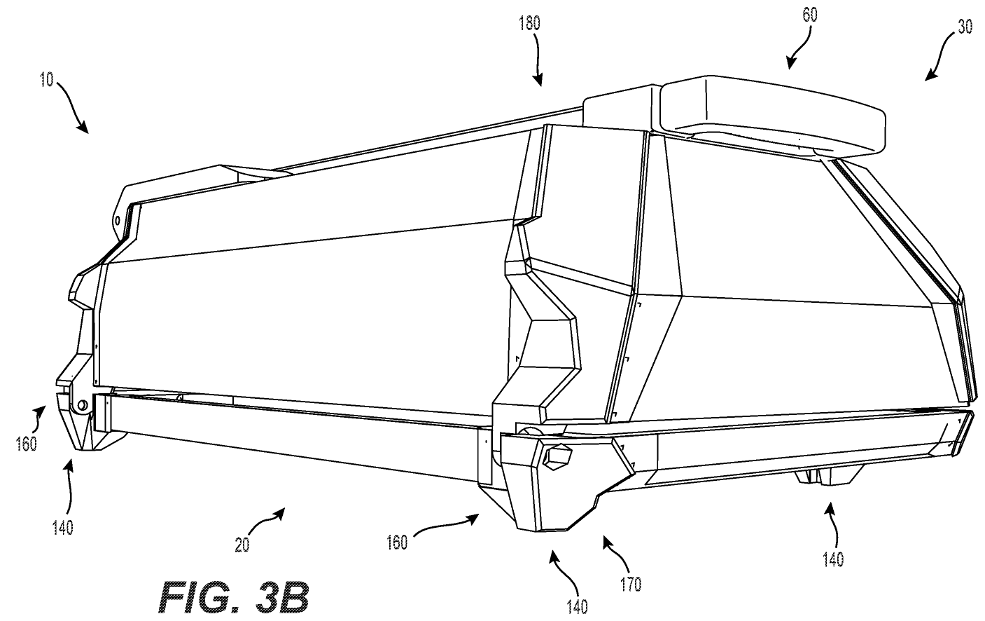

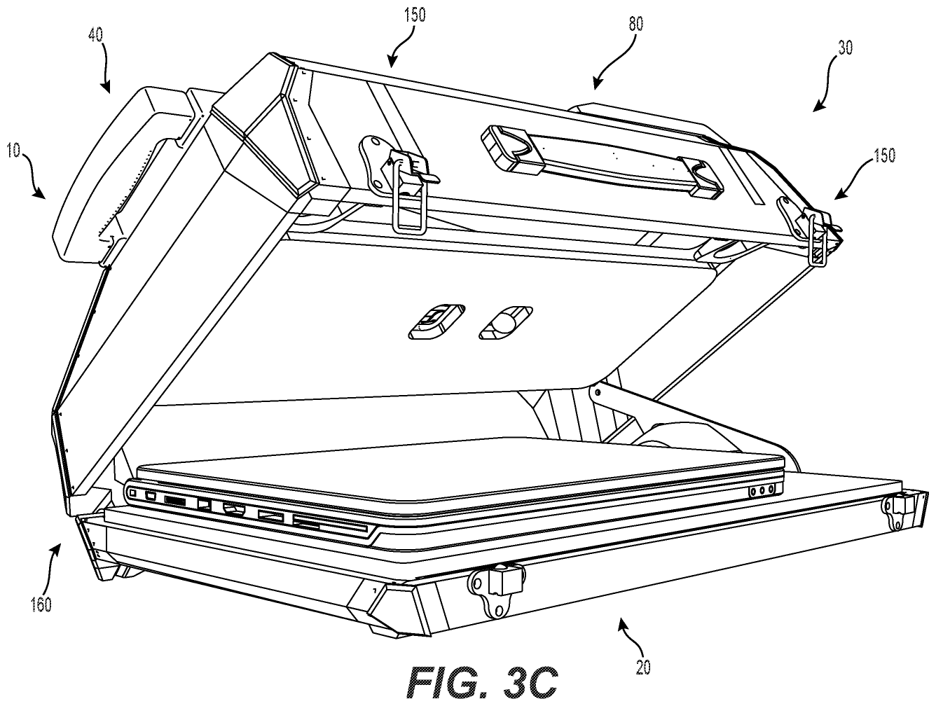

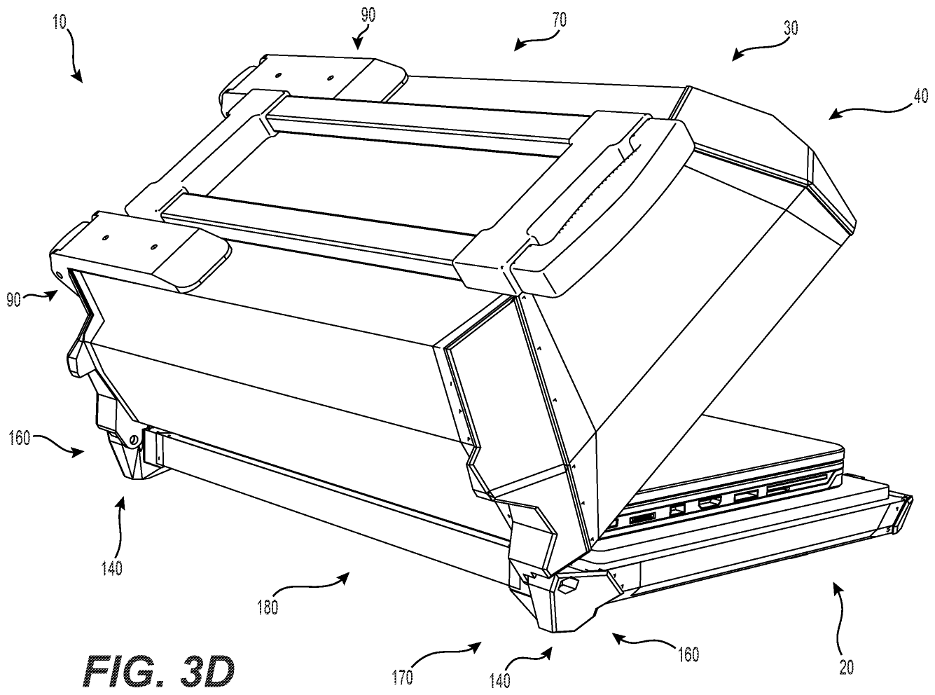

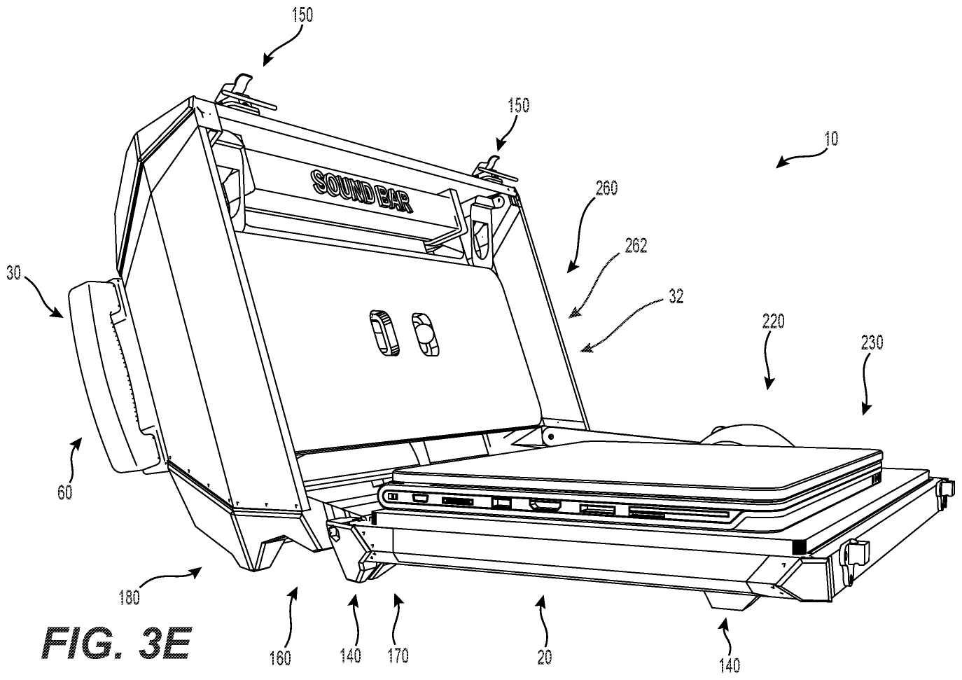

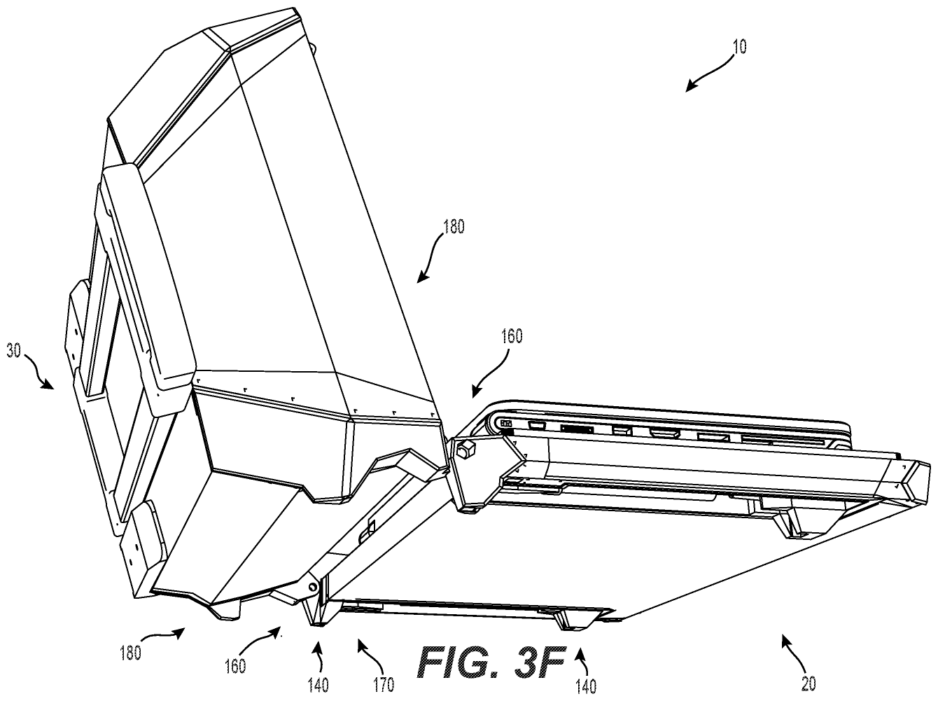

As described above, case 10 may be operated in various configurations. For example, as shown in FIG. 3a, case 10 may be operated on a working surface with base 20 in contact with, or resting on, the working surface. The working surface may be at various heights depending on the user's needs. For example, the working surface may be at counter-top or bench height of about 36 inches, table height of about 28 inches, or another working height to enhance or optimize the ergonomic positioning of case 10. It is understood that bench & table heights can vary by up to six inches or more, meaning the working surface can range from about 22 inches to about 42 inches. The working surface can be where a user locates case 10 so the user can operate a computer with case 10 in an open configuration. Working surface can include a table, bench, desk, or other such horizontal plane.

FIG. 3b shows a back-side perspective view of the case shown in FIG. 3a. When base 20 is positioned on the working surface, one or more base feet 140 may contact the working surface. In some embodiments, a single base foot 140 may be positioned at each corner of base 20. One or more base feet 140 may provide a flat contact plane with the working surface to ensure that base 20 remains stationary during operation. It is also contemplated that base feet 140 may include a non-slip or non-scratch material to improve ease of use of case 10. For example, base feet 140 may be rubber-coated to ensure delicate table surfaces are not scratched during use of case 10.

FIG. 3a also shows two base-lid latches 150, configured to lock and unlock a movement of lid 30 relative to base 20, For example, one or more base-lid latches 150 may be positioned on one or more sides of base 20 and lid 30. Base-lid latches 150 may be commercially available latches configured to operate with travel luggage. It is also contemplated that base-lid latches 150 may be configured to operate as described below. For example, as explained in detail below, base-lid latches 150 can be configured to operate with other components of case 10 to assist a user setting up case 10 in various operating configurations.

FIG. 3b also shows case 10 with two base-lid hinges 160. Base-lid hinge 160 can provide a pivot point to allow lid 30 to move or “open” relative to base 20. For example, once base-lid latches 150 are unlocked, lid 30 may pivot at base-lid hinges 160 to open relative to base 20. FIGS. 3c & 3d show lid 30 partially open relative to base 20, and FIGS. 3e & 3f show lid 30 fully open relative to base 20.

One or more base-lid hinges 160 may be positioned on a back side of base 20 and lid 30. Base-lid hinges 160 can include a bolt, rivet, or other structural element configured to provide pivoting between lid 30 and base 20. It is also contemplated that base-lid hinge 160 could be formed of a flexible material configured to allow relative movement between base 20 and lid 30. For example, base-lid hinge 160 could be formed from a plastic material having a seam or recess configured to provide rotational movement between base 20 and lid 30. Such a hinge could extent along a partial or a full length of a side of base 20 and lid 30.

Base-lid hinge 160 could be formed of various one or more materials, including steel, aluminum, or plastic. They should be strong enough to support the weight and positioning of other components of case 10, as described below. Base-lid hinge 160 can also include one or more features to improve the stability of case 10, For example, base-lid hinge 160 can include one or more base feet 140. Base-lid hinge 160 may also be integral with at least one of base 10, lid 30, leg box 100, handle arm sleeve 70, or stair skid 90.

As shown in FIGS. 3a-f, one or more surfaces of base-lid hinge 160 can be configured to provide support to case 10 in various configurations. For example, as shown in FIG. 3b, base-lid hinge 160 can include a base-hinge component 170 and a lid-hinge component 180 (see also FIGS. 3b, 3d), Base-hinge component 170 may be coupled to or form part of base 20 and lid-hinge component 180 may be coupled to or form part of lid 30. Each hinge component 170, 180 may be formed from plastic or another suitable material. As explained below, each hinge component 170, 180 may also include one or more surfaces configured to contact a working surface and/or a travel surface. In other embodiments, base 20 and/or lid 30 may include these surfaces.

FIG. 3e also shows a mouse 220 and a laptop 230 (in a closed configuration) located on base 20, and a monitor mount 260 contained within a lid recess 32 of lid 30. Operation of these computing hardware components that may be generally stored within lid recess 32 will be described below. In some embodiments, lid recess 32 may be about 22 inches long by 13 inches wide by about 5.5 inches deep. In some embodiments, lid recess 32 may form at least 50% of a total volume of all volumes enclosed by lid 30 and base 20 in the closed configuration.

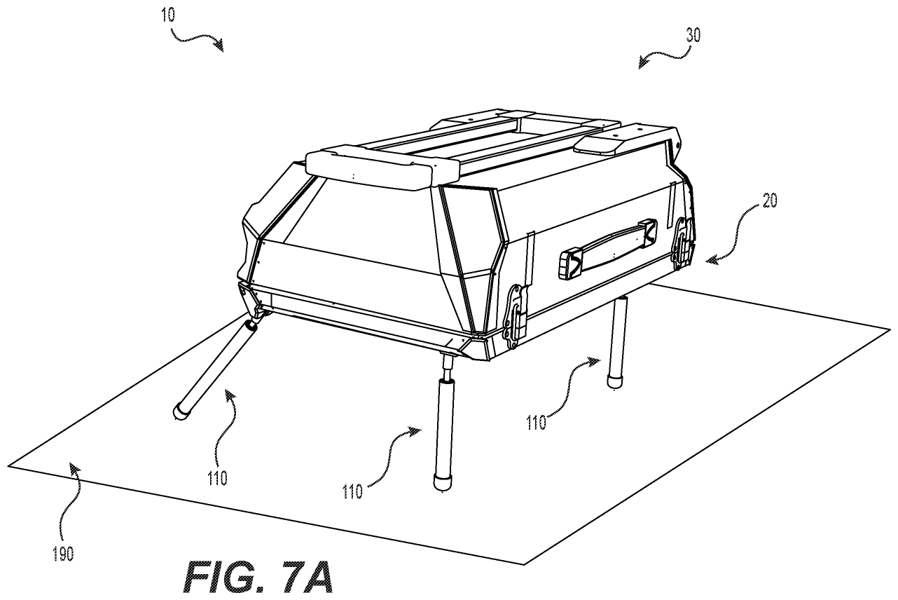

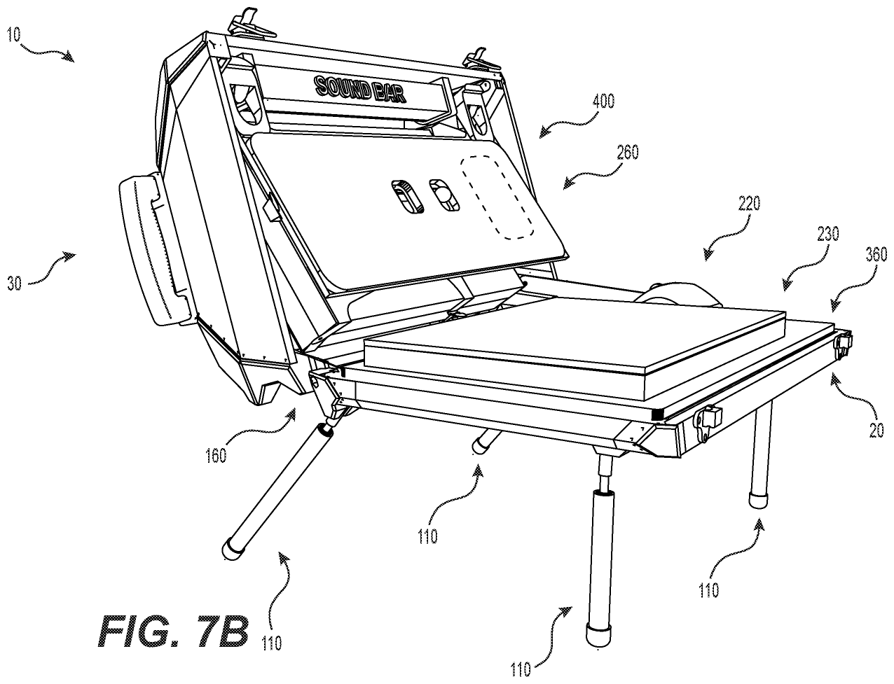

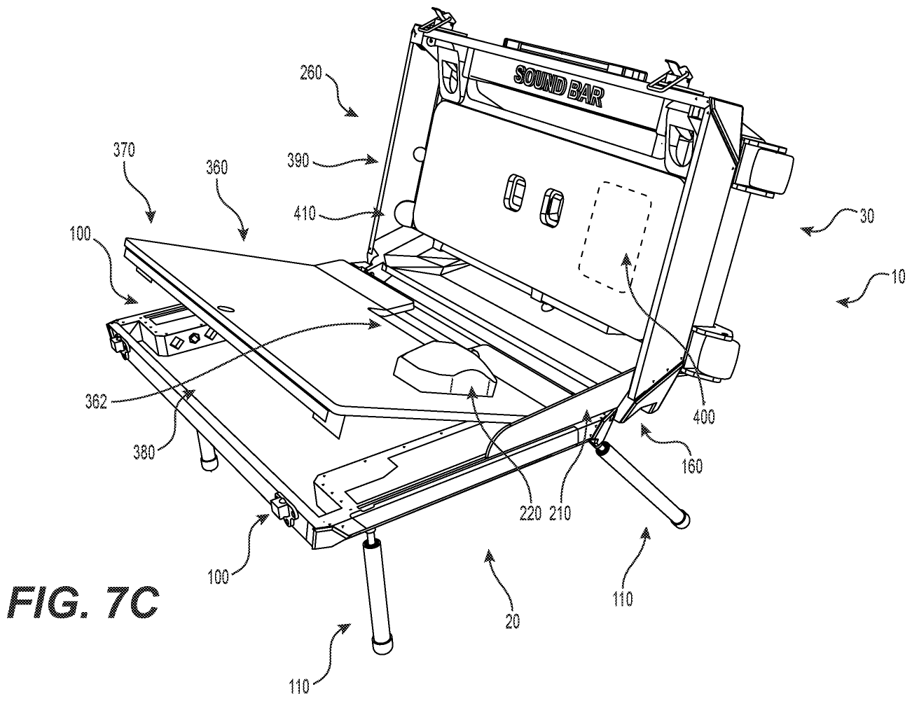

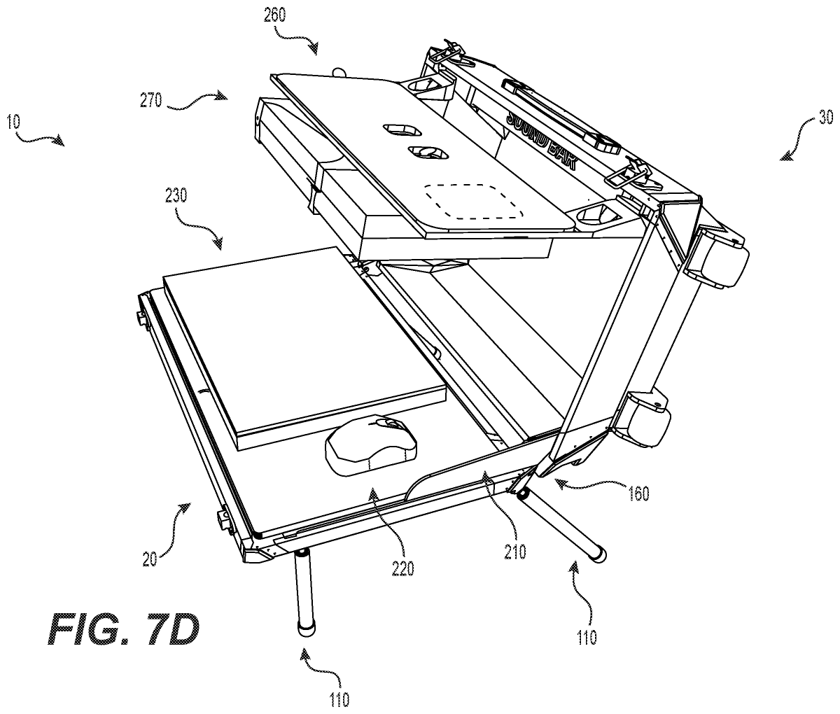

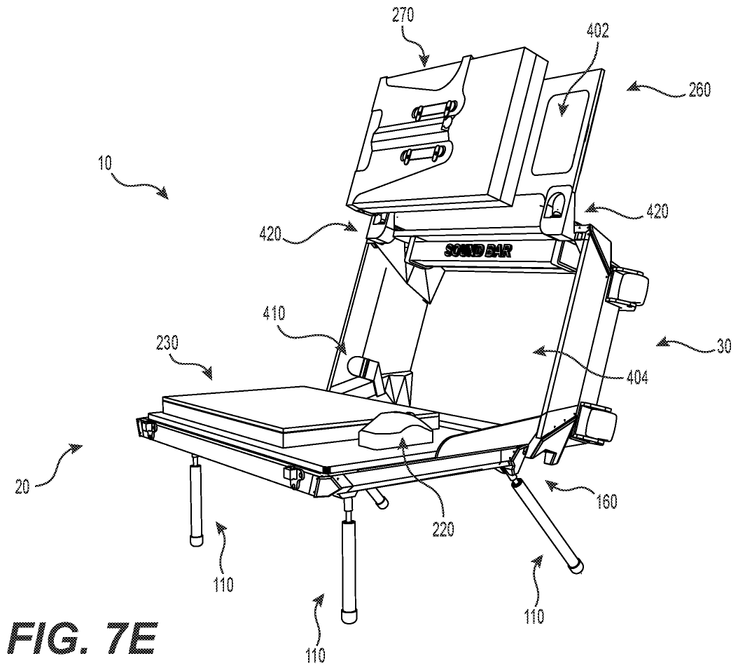

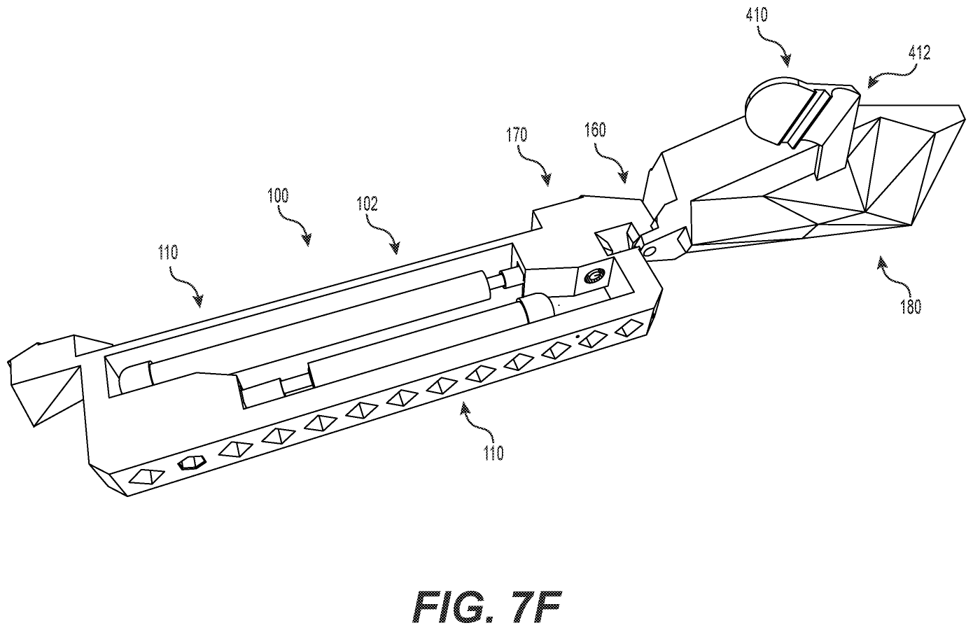

Lid recess 32 may be configured to receive at least one additional monitor (not shown) coupled to monitor mount 260 when lid 30 is in a closed configuration relative to base 20 (FIGS. 3a, b). Moreover, lid recess 32 can be configured to generally enclose one or more computing devices, such as mouse 220 and/or laptop 230 when case 10 is in a closed configuration. And when lid 30 is in an open configuration relative to base 20, as shown in FIG. 3e, monitor mount 260 can also initially be releasably contained within lid recess 32. But as shown in FIGS. 7a-e and described below, monitor mount 260 can also be moved relative to case 10 when lid 30 is open relative to base 20.

Monitor mount 260 can also include one or more padded surfaces 262 configured to contact laptop 230, mouse 220, or any other type of computing device located on base 20. Padded surface 262 can include a foam material and may be about a quarter of an inch to about an inch thick to provide protection to computing devices stored within case 10. Padded surfaces 262 can be of various thicknesses and may include cut-out sections to accommodate computing devices of approximate sizes. For example, one padded surface 262 may be thinner to receive a computing device having a larger thickness. Also, a generally rectangular section can be configured to receive a standard laptop while another generally rectangular section can be configured to receive a standard tablet, such as an iPad. Various padded surfaces 262 may also be removable or replaceable to better accommodate computing devices of various dimensions.

Padded surface material may include memory foam, rubber, soft-plastic, neoprene, or other flexible material configured to general conform a shape of one or more computing devices located within case 10. Moreover, one or more surfaces of lid 30 or base 20 may include such materials. For example, one or more internal surfaces of lid 30 may include such materials to protect one or more additional monitors 270 during transport or movement into open or closed configurations. As explained below, one or more surfaces of base 20 may include such materials to protect one or more computing devices.

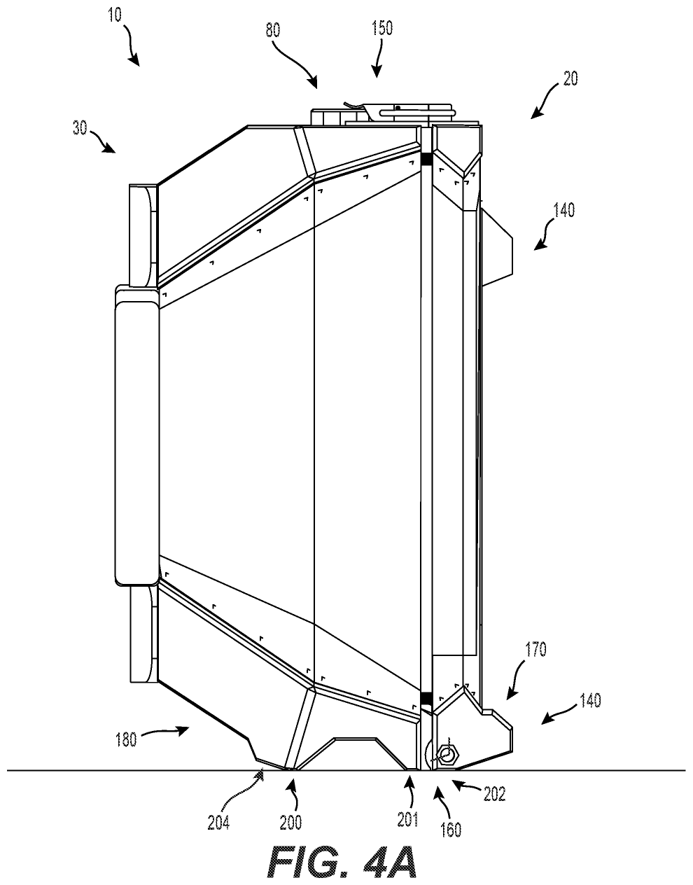

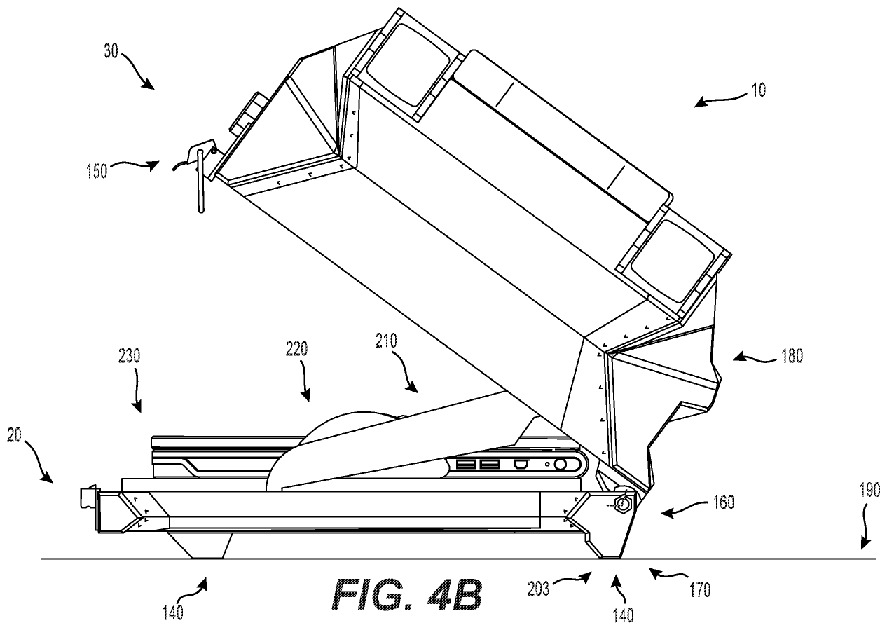

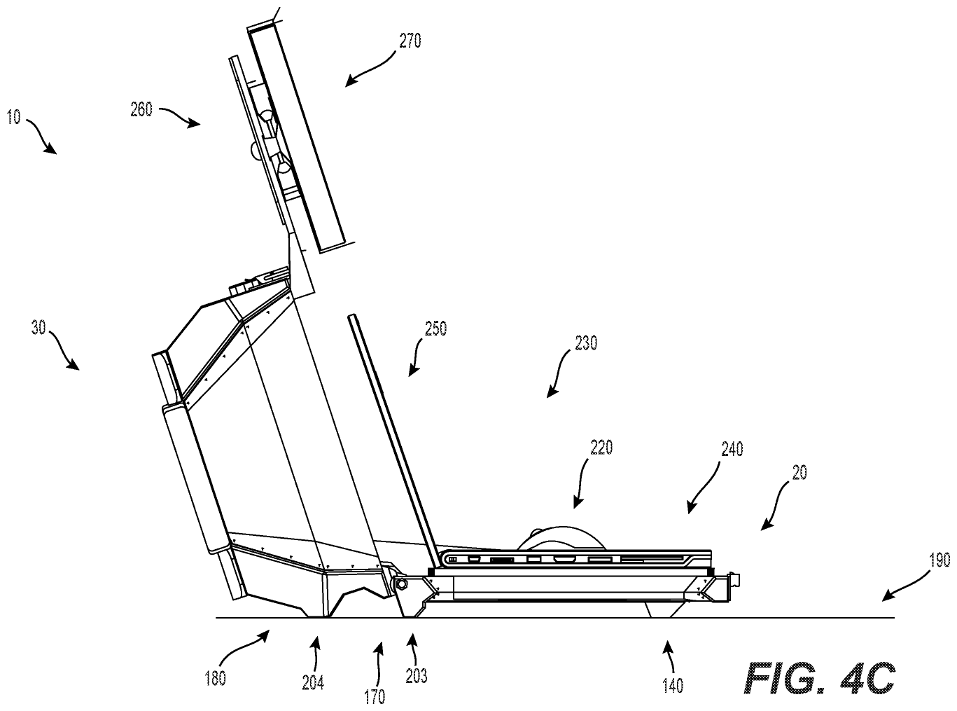

FIG. 4a shows case 10 in a standing configuration with a back side resting on a surface that can be either travel surface 188 or work surface 190. Stationary handle 80 and base-lid latch 150 are located on a front side of case 10 facing upwards. As indicated, base 20 and lid 30 can include a plurality of flat surfaces 200, 201, 202, configured to rest upon travel surface 188. A greater or a lesser number of surfaces 200, 201, 202, on any one or more of base 20, lid 30, and/or hinge components 170, 180, are also contemplated.

These flat surfaces 200, 201, 202 allow case 10 to be generally stable in this standing configuration. For example, it is contemplated that lid surface 200 can be located at a position to the left of the center-of-mass of case 10, as shown in FIG. 4a. Also shown, at least one of flat surfaces 201 or 202 can be located to the right of the center-of-mass of case 10. Such positioning of one or more flat surfaces 200, 201, 202 relative to the center-of-mass of case 10 can provide sufficient stability when case 10 is in the standing configuration shown in FIG. 4a. It is also contemplated that one or more fiat surfaces 200, 201, 202 could be moved closer to or further away from the center-of-mass of case 10 in such a standing configuration.

Note that lid surface 204 as shown in FIG. 4a is not in contact with the ground surface shown in FIG. 4a, Rather, as described and shown below in FIG. 4c, lid surface 204 is configured to contact working surface 190 only when base 20 is also in contact with working surface 190. Thus, lid surface 204 can provide case 10 with additional stability by at least partially supporting the weight of lid 30 and/or one or more additional monitors 270 when case 10 is in an operational configuration. But as shown in FIG. 4a, lid surface 204 may be at an angle relative to lid surface 200, so that surface 204 only contacts working surface 190 when lid 30 is fully open relative to base 20, as shown in FIG. 4c. This angle may be about 10, 20, 30, or 40 degrees depending on the desired angle of lid 30 relative to base 20. And conversely, lid surface 200 does not contact working surface 190 when lid 30 is positioned fully open relative to base 20 as shown in FIG. 4c.

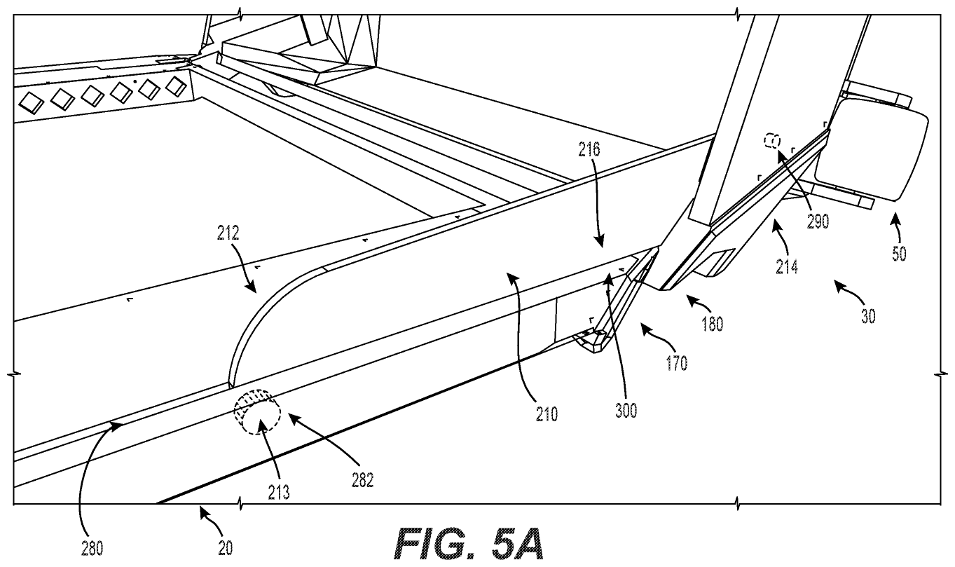

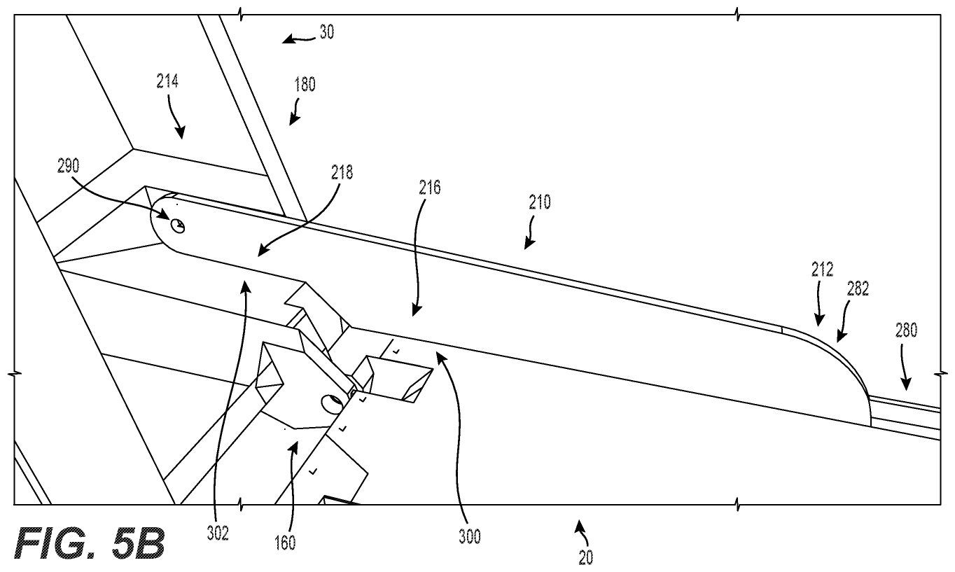

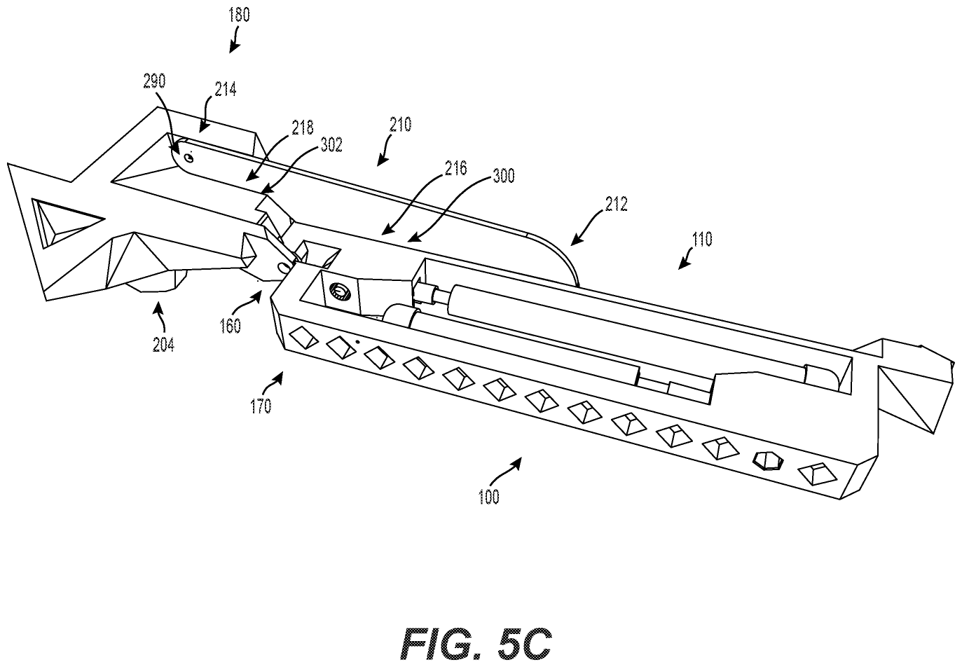

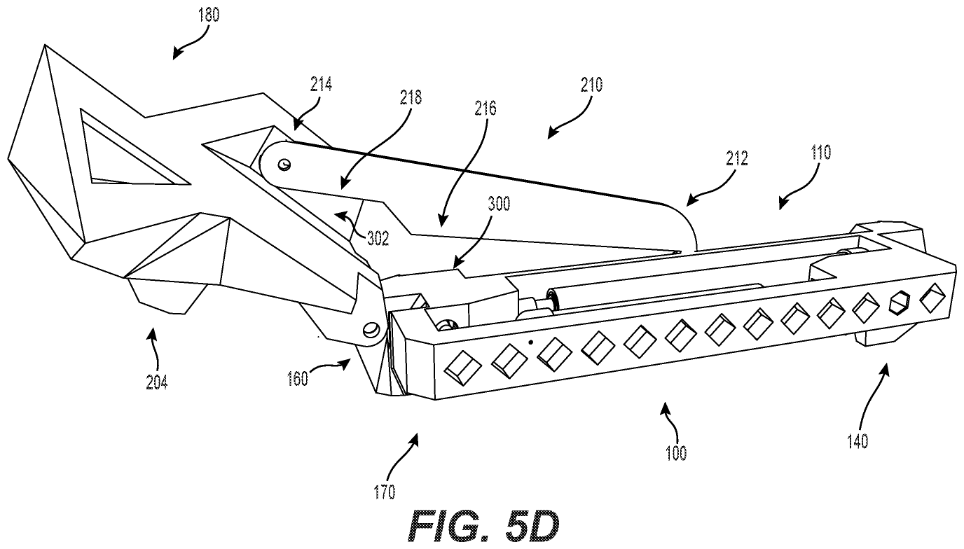

FIG. 4b shows case 10 in a laying configuration, with lid 30 partially open relative to base 20, and with base feet 140 contacting working surface 190. As indicated, base hinge component 170 can includes one or more flat surfaces 203 configured to contact working surface 190. Also shown is a lid stay 210, which is moveably coupled to lid 30 and base 20. The function and structural features of lid stay 210 are explained below and shown in FIGS. 5a-d.

FIG. 4c shows case 10 in a fully open or operational configuration, with lid 30 in an open configuration relative to base 20, and base feet 140 contacting working surface 190. Flat surface 203 of base 20 is shown in contact with working surface 190. In addition, a lid surface 204 of lid 30 is also shown in contact with working surface 190. Such one or more flat surfaces 203, 204 can allow case 10 to be sufficiently stable when in a fully open position and resting directly on working surface 190. It is also contemplated that one or more flat surfaces 200-204 may be provided on other parts or features of case 10. For example, hinge components 170, 180 may include one or more flat surfaces 200-204. Such surfaces 200-204 may be provided on lid 30, base 20, or other components or features of case 10.

FIG. 4c also shows mouse 220, laptop 230 (in an open or operational configuration), with a laptop keyboard 240 and a laptop monitor 250. Mouse 220 and laptop 230 can be readily available commercial products, having standard dimensions and weight. For example, mouse 220 may be about four inches long and about 2 inches wide. Laptop 230 may be about fourteen inches wide and about ten inches deep. One or more dimensions of case 10 can be varied accordingly to accommodate standard or non-standard sized devices.

While shown and described below with laptop 230, case 10 and its components may also be configured to receive a computing device, wherein the computing device can include laptop 230, a tablet, mouse 230, a keyboard, or other similar computational device.

Also shown in FIG. 4c is a monitor mount 260 extending from lid 30, wherein monitor mount 260 can be fixedly coupled to one or more additional monitors 270 positioned generally above laptop monitor 250, FIG. 4c shows monitor mount 260 in a fully extended or open configuration, while FIG. 3e shows monitor mount 260 in a fully retracted or closed configuration within lid 30 when lid 30 is open relative to base 20. In some embodiments, monitor mount 260 can be configured to position two additional monitors 270 side-by-side and centered generally above a top surface of lid 30. Note that the relative position of monitors 270 and mount 260 within lid 30 shown in FIG. 3e can be the same as shown in FIGS. 1a-3f. These can be considered the “closed” configuration for one or more additional monitors 270 or monitor mount 260. Monitor mount 260 can be configured to move to position the at least one additional monitor 270 for storage generally on top of a computing device when lid 30 is in the closed configuration.

One or more additional monitors 270 can include any type of flat screen monitor, such as, an LCD, TFT, OLED, ePaper, or other type of thin screen. Such thin screens are generally about 2 inches of less in depth. Monitors 270 could be curved or ultrawide, depending on the dimensions of case 10. Monitors 270 could include various mounting mechanisms, including, for example, VESA, rack, or other types of mounts. Monitors 270 could include a tablet screen, touch screen, or other type of interactive screen. Such interactive screens can be configured to operate with a pen, stylus, or a user's finger.

As shown in FIG. 4c. one or more additional monitors 270 can be ergonomically positioned at about 110 degrees relative to base 20 or keyboard 240. Likewise, laptop monitor 250 can be readily adjustable to various angles, such as shown at about 120 degrees relative to base 20 or keyboard 240. For example, the angle between lid 30 and base 20 could be between about 100 degrees to about 120 degrees. More preferably, the angle between the lid 30 and base 20 could be about 110 degrees.

Such variable positioning of monitors 250, 270 relative to each other and to keyboard 240 or another keyboard located on a working surface, can allow a user to customize and optimize their ergonomic experience. In addition, one or more flat surfaces 200-204 may provide a sufficiently stable platform for a user to operate laptop 230. For example, the structure of, and coupling between, at least one of base 20, lid 30, and monitor mount 260 may provide sufficient rigidity and balance to allow a user to easily, safely, and/or ergonomically position one or more additional monitors 270. The flat surfaces 200-204 may provide sufficient grip with working surface 190 so that vigorous typing on keyboard 240 does not cause noticeable movement of additional monitors 270 during operation. Base 20 may contain impact absorbing materials to lessen vibrations and sounds resulting from typing and movement of mouse 220. More specific features and functions of case 10 are described below.

In some embodiments, lid 30 may be coupled to base 20 via one or more base-lid hinges 160. These hinges 160 may allow relative movement of lid 30 and base 20 but may not lock this movement, merely limit the movement between lid 30 and base 20. In some embodiments the movement between lid 30 and base 20 may be releasably lockable and unlockable when case 10 is in an open configuration.

Because of weight, balance, and stability requirements resulting from ergonomically positioning additional monitors 270, the forces exerted on hinges 160 alone may be too high. In order to reduce these forces, lid stay 210 may be coupled to lid 30 and base 20 to provide limited and/or lockable movement between lid 30 and base 20. For example, lid stay 210 can be pivotably coupled to lid 30 and slidably coupled to base 20. It is also possible that lid stay 210 can be slidably coupled to lid 30 and pivotably coupled to base 20. Various locking mechanisms between lid 30 and base 20 could include one or more of a latch, clip, sleeve, friction fit, or other type of locking and unlocking mechanism.

FIG. 5a shows a top side perspective view from an external perspective of lid stay 210, when lid 30 is fully open relative to base 20, as shown in FIG. 4c. FIG. 5b shows the same configuration from an internal perspective of lid stay 210, when lid 30 is in a fully open configuration relative to base 20. Base 20 can also include a lid stay track 280, configured to slidably receive a first end 212 of lid stay 210. Lid 30 can also include a lid stay pivot 290, configured to pivotably receive a second end 214 of lid stay 210.

Lid stay 210 can also include one or more surfaces configured to limit or lock a position of lid 30 relative to base 20. For example, a first end 282 of lid stay track 280 can be positioned so that when lid stay 210 is fully extended (i.e., lid 30 is fully open relative to base 20), first end 212 of lid stay 210 will contact first end 282 of track 280. Such contact can limit the movement of lid stay 210, thereby limiting the movement of lid 30 relative to base 20.

In some embodiments, first end 212 for lid stay 210 can include an internal protrusion 213, surface, or other feature configured to contact or engage with a corresponding feature of first end 282 of track 280. For example, as shown in FIG. 5a, protrusion 213 can be configured to limit movement of lid stay 210 within track 280. Protrusion 213 may provide a pivot point between first end 212 of lid stay 210 and a rear edge of base 20 or base-hinge component 170, or lid stay pivot 290. Such pivoting can be limited by various contact surfaces or features of case 10 to stably stop the movement of lid 30 relative to base 20. Such a mechanism may provide sufficient structural rigidity to limit movement of lid 30 relative to base 20 to maintain case 10 in a fully open or operational configuration.

While first end 212 of lid stay 210 may slide within base 20, second end 214 of lid stay 210 may be pivotably coupled to lid 30. As shown in FIGS. 5a, 5b, second end 214 can include lid stay pivot 290 configured to pivotably couple to lid 30. In other embodiments, lid stay 210 may be variously coupled to lid 30 and/or base 20 to limit the movement of lid 30 relative to base 20. For example, both ends 212, 214 of lid stay 210 could slidably engage lid 30 and base 20. In other embodiments, both ends 212, 214 of lid stay 210 could pivotably engage base 20 and lid 30, wherein lid stay 210 may be further configured to bend or pivot at a location between ends 212, 214. Case 10 may include one or more lid stays 210.

Lid stay 210 may also include a contact surface 216 configured to contact a corresponding lid stay surface 300. Contact surface 216 may extend a long at least a portion of lid stay 210. For example, contact surface 216 may extend generally near a mid-point of lid stay 210 along an underside of lid stay 210. Likewise, corresponding lid stay surface 300 may extend along an inner portion of base 20 or base-hinge component 170. When surfaces 216, 300 are in contact, movement of lid stay 210 may be limited. In some embodiments, lid stay 210 may not include any surfaces configured to contact other portions of case 10. In other embodiments, lid stay 210 may also include more than one contact surface 216.

Similar to described above for contact surface 216, lid stay 210 may also include a second surface 218 configured to contact a corresponding lid stay surface 302 (see FIG. 5b), Second surface 218 may also extend a long at least a portion of lid stay 210, For example, second surface 218 may extend generally from second end of lid stay 214 but not extend beyond a mid-point of lid stay 210. Likewise, corresponding lid stay surface 302 may extend along an inner portion of lid 30 or lid-hinge component 180. When surfaces 218, 302 are in contact, movement of lid stay 210 may be limited. Having multiple surfaces 216, 218 of lid stay 210 in contact with corresponding surfaces 300, 302 within case 10 may provide enough structural rigidity between lid 30 and base 20 to maintain case 10 in an open or operational configuration.

FIG. 5c shows a similar perspective view as shown in FIG. 5b, but showing base-hinge component 170 with the rest of base 20 removed and showing lid-hinge component 180 with the rest of lid 30 removed. FIG. 5c shows lid stay 210 when case 10 is fully open, with surfaces 216, 218 of lid stay 210 in contact with corresponding surface 300 of base-hinge component 170 and with corresponding surface 302 of lid-hinge component 180. FIG. 5d shows the same components as shown in FIG. 5c, but with case 10 in a partially open configuration. Base-hinge 170 includes corresponding lid stay surface 300, and lid-hinge component 180 includes corresponding lid stay surface 302. Base-hinge component 170 also includes two base feet 140 (only one is shown) and lid-hinge component 180 includes corresponding flat surface 204.

These and various other features of case 10 can be provided with hinge components 170, 180 to enhance stability. Examples of several integrated or directly bonded forms are described below. It is also contemplated that different manufacturing techniques could be used to form single or modular components where currently multiple components are required. For example, molding of lid 30 or base 20 may incorporate various other components of case 10 that have been separately described herein.

FIGS. 5c, 5d also show leg box 100 integrally formed with base-hinge component 170. Such single-piece formation can contribute to the structural rigidity of case 10 because fewer components are used and movement between components may be reduced or eliminated. Two base legs 110 are shown fully retracted within leg box 100. In some embodiments, case 10 may not include leg box 100 or base leg 110. In other embodiments, as described below in detail, case 10 may include one or more leg boxes 100, coupled to one or more base legs 110.

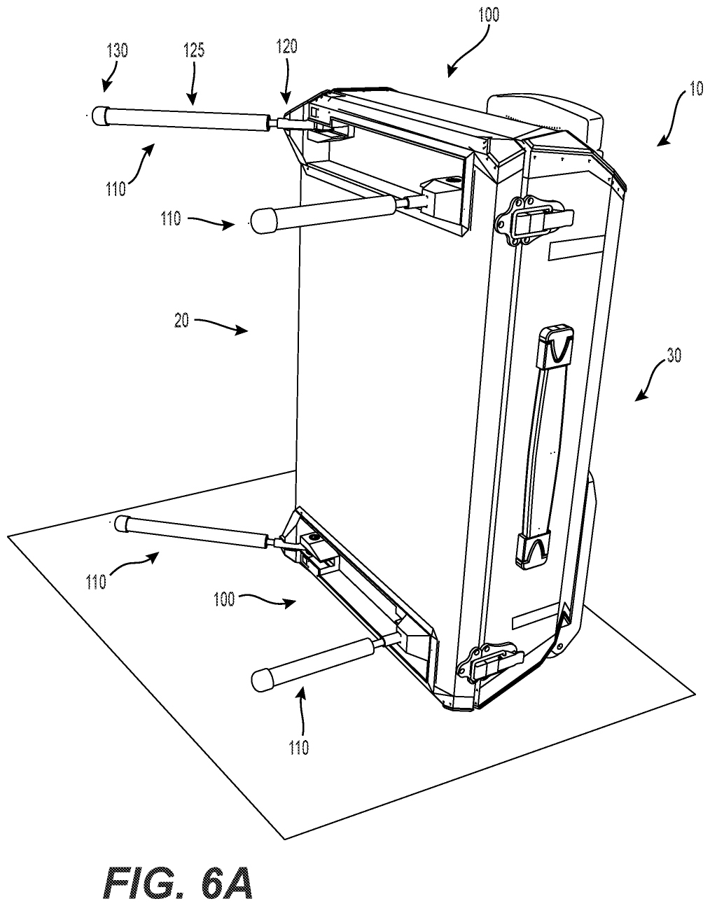

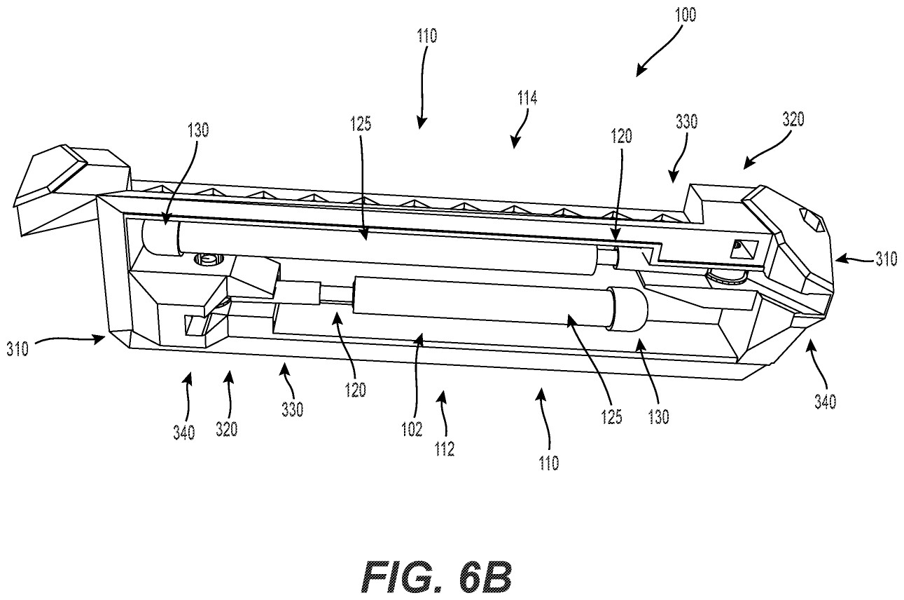

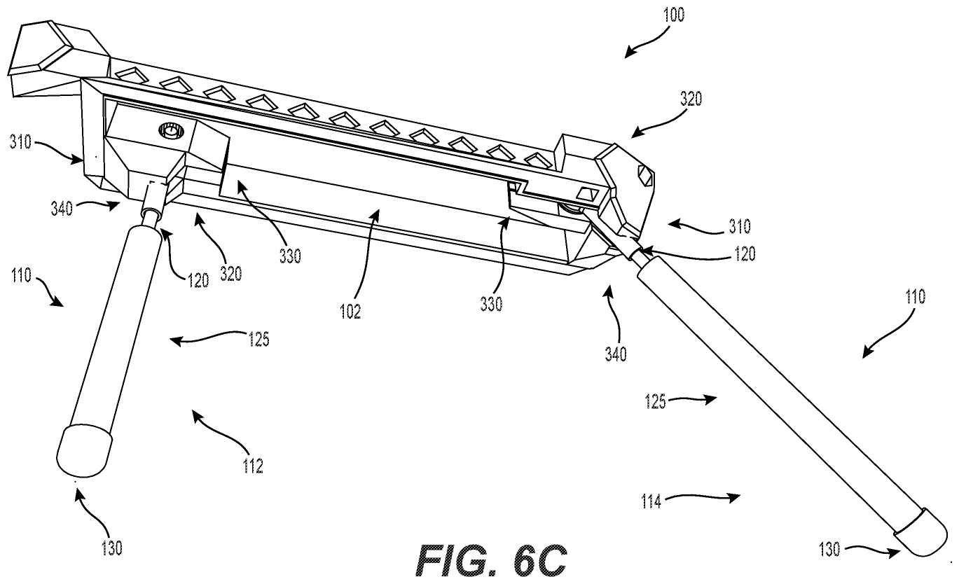

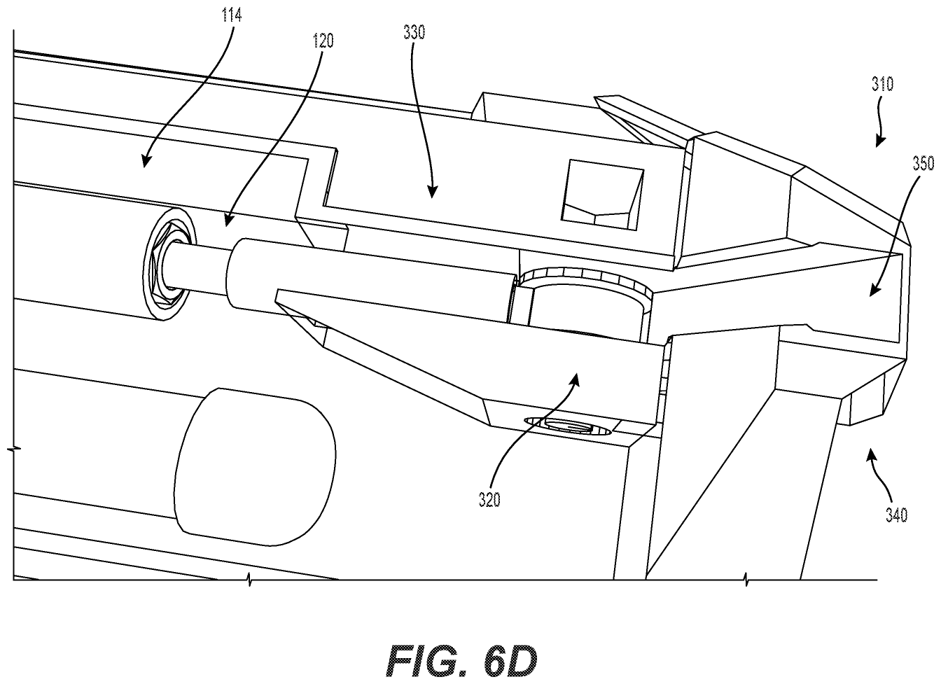

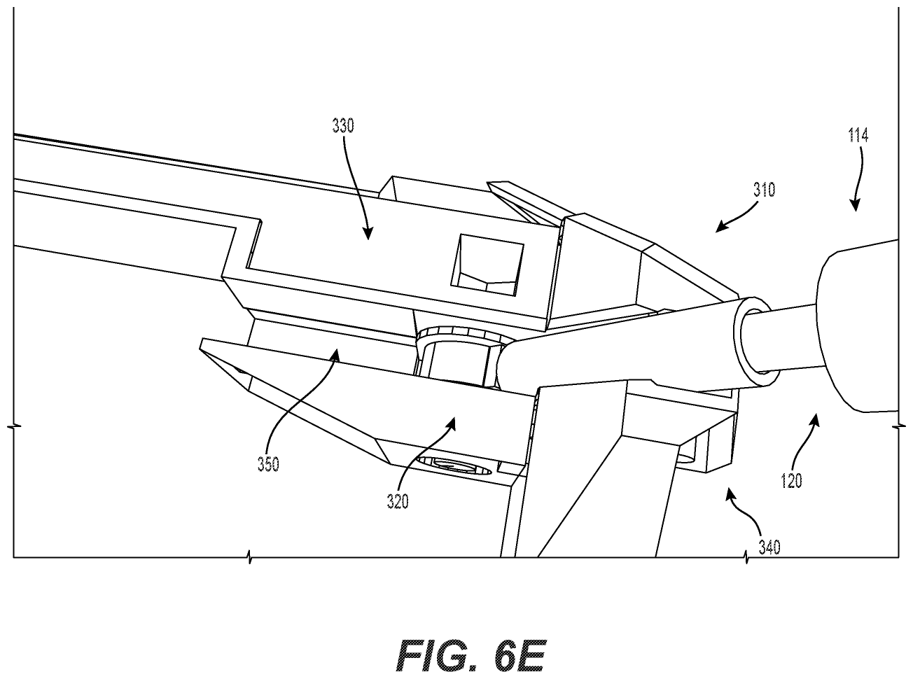

Referring to FIG. 2b, case 10 is shown in a standing configuration with base legs 110 all fully retracted within leg boxes 100. FIG. 6a shows a similar perspective view of case 10, but with four base legs 110 in their fully extended configurations from two leg boxes 100 contained within base 20. As shown in FIGS. 2b & 6a, leg box 100 can encompass a section of case 10 that one or more base legs 110 can reside within during transport and generally extend from during operation. Although not shown, leg box 100 may include a cover to at least partially protect legs 110 when stowed from damage likely during travel.

Case 10 can generally include one or more leg boxes 100, containing one or more base legs 110. When case 10 is in a standing or rolling position, one or more base legs 110 can be contained generally within lea box 100 (see FIGS. 1a-2b, 4a). As described below in more detail, one or more base legs 110 can generally extend from within leg box 100 when case 10 is in various configurations (see, for example, FIGS. 6a, 7a-e, 11a-b), It is also contemplated that one or more base legs 110 can be attached to base 20 without leg box 100. For example, similar to the attachment of handle arm sleeve 70, one or more base legs 110 can be attached to an outer surface of base 20.

As shown and described below, one or more base legs 110 may be pivotably coupled to leg box 100. It is also contemplated that base legs 110 may be variously mounted to base 20. Such mountings may not require leg box 100.

In some embodiments, legs 110 may use a pivot, elastic, ball and socket, or other type of coupling to allow movement between a stowed configuration and a deployed configuration.

Legs 110 should ideally be constructed and configured for easy transition from open to closed configurations, lock in place when in the open and closed configurations, be flexible enough to absorb some vibrations, and sturdy enough to provide a stable operating platform for a user when one or more additional monitors are ergonomically positioned. With appropriate design considerations of these factors, legs 110 may be removable and could be attached to leg box 100 and/or base 20 via a thread, friction fit, bayonet, or other type of connection. Legs 110 may also be extendable or static in length. Preferably, legs 110 may be generally static in length but minor adjustments in length may be possible.

In some embodiments, legs 110 may have three parts but may have more or less parts in other embodiments. For example, as shown in FIG. 6a, leg 110 may include a mounting strut 120, a leg cap 130, and a support member 125. As explained below, mounting strut 120 can be configured to pivot relative to base 20 or leg box 100 (see FIGS. 6b-d). Mounting strut 120 can also be moveably coupled support member 125 to allow the overall length of leg 110 to be slightly varied if needed. Thus, a distance between a pivot point of mounting strut 120 and a distal tip of leg 110 can be adjusted. For example, support member 125 may be threadedly coupled to mounting strut 120. Rotating support member 125 clockwise relative to mounting strut 120 may slightly increase a length of leg 110, whereas rotating support member 125 anti-clockwise relative to mounting strut 120 may slightly decrease a length of leg 110. Thus, while minor adjustments to the length of leg 110 in the extended configuration are possible, leg 110 in the extended configuration can be generally fixed in length.

Support member 125 may have an outer diameter of about 0.5 inches and mounting structure 120 may have an outer diameter of about 0.25 inches. Further, leg 110 may include distally located leg cap 130 to provide traction with a working surface. Leg cap 130 may or may not be integrated into the leg 110 as one part. Leg cap 130 may be a rubberized material or have a geometry to enhance grip to a working surface.

Base 20 or leg box 100 may include one or more integrated or installed clips, stays, or geometry that allows base leg 110 to snap into for stability when leg 110 is in a deployed (e.g., FIG. 6a) or stowed (e.g., FIG. 2b) position. One such a leg mounting mechanism 310 is shown in detail in FIGS. 6b-d.

FIG. 6b shows a detailed underside perspective view of leg box 100 as shown in FIG. 2b, with two legs 110 both fully retracted within a leg box cavity 102 contained generally within leg box 100. FIG. 6c shows a detailed underside perspective view of leg box 100 as shown in FIG. 6a, with two legs 110 both fully extended from leg box 100. As shown, legs 110 are generally located outside cavity 102. Specifically, FIGS. 6b & 6c show a front base leg 112 and a rear base leg 114 moveably coupled to leg box 100.

As shown, first ends 320 of base legs 110 are shown pivotably coupled to leg mounting mechanisms 310. Leg mounting mechanism 310 is shown integrally formed with leg box 100. Mounting mechanism 310 is also shown with a first strut clamp 330 and a second strut clamp 340. First strut clamp 330 can be configured to receive mounting strut 120 when leg 110 is in a retracted position (FIG. 6b) and second strut clamp 340 can be configured to receive mounting strut 120 when leg 110 is in a deployed or extended position (FIG. 6c).

Strut clamps 330, 340 may be configured to lock or limit a position of leg 110 relative to leg box 100 or base 20. For example, strut clamps 330, 340 can be configured to temporarily retain mounting strut 120 with a snap fit connection. When case 10 is positioned as shown in FIG. 2b, first strut clamps 330 may retain corresponding legs 110 within leg boxes 100 as shown in FIG. 6b. Then a user may reach into leg box 100 and pull leg 110 outwards. The snap fit connection between first strut clamp 330 and the mounting strut 120 of leg 110 being pulled outwards may be released, allowing leg 110 to move from a retracted position within leg box 100. The user may then continue to move leg 110 outwards until leg cap 130 is almost in a fully deployed position. At about this point, mounting strut 120 may engage second strut clamp 340. The user may then move leg 110 some more, to snap fit mounting strut 120 into second strut clamp 340, thereby limiting or locking the movement of leg 110. Such a releasably limiting/locking mechanism for leg 110 can allow a user to quickly and easily move one or more legs 110 from fully retracted positions (as shown in FIG. 2b, 6b) to fully extended or deployed positions (as shown in FIG. 6a, 6c), Once one or more legs 110 are deployed, a user may then adjust the length of one or more legs so that case 10 flatly rests on a working surface, as described below.

FIGS. 6d and 6e show detailed perspective view of leg mounting mechanism 310 for rear base leg 114, whereby FIG. 6d shows leg 114 in a fully retracted configuration and FIG. 6e shows leg 114 in a fully extended or deployed configuration. As shown, strut clamps 330, 340 may require one or more internal surfaces 350 configured to contact a length of mounting strut 120. Such internal surfaces 350 may be needed to provide adequate stability when mounting struts 120 have dimensional limitations. It is recognized that mounting struts 120 should not be overly heavy or wide as case 10 should be designed for light weight and ease of transport. As such, mounting struts should preferably be less than about 1 cm in diameter.

Given the weight and stability requirements of case 10, second strut clamp 340 should have sufficient contact with mounting strut 120 to ensure that movement between these components is minimized during operation of case 10. For example, strut clamp surface 350 for rear leg 114 may be at least about 3 cm in length. Strut clamp surface 350 for front leg 112 may be shorter, such as, for example, at least about 1 cm in length. These features can provide sufficient surface area to absorb high torsional forces placed on rear legs 114 positioned at an angle relative to base 20 compared to front legs 112 that have angles closer to about 90. Strut clamp surface 350 can be configured to contact a proximal region of at least one leg 110 in a deployed configuration.

As shown in FIGS. 6b & 6c, one or more front legs 112 may be positioned about 90 degrees relative to lid box 100 or base 20. One or more rear legs 114 may be positioned about 125-140 degrees, and preferably about 130 degrees, relative to lid box 100 or base 20. Moreover, front legs 112 can be about 90 mm length and rear legs 114 can be about 148 mm length. Depending on lift or height requirements of base 20 and/or lid 30, angles and lengths of legs 110 can be varied.

In addition, recess 102 can be configured to receive one or more legs 110. As shown, leg box recess 102 can be about 1 inch deep by about 12 inches long by about 2 inches wide. Such dimensions can allow for easy placement of case 10 with legs 110 deployed on a standard countertop.

As explained below, such positioning and lengths of legs 110 may improve the stability and usability of case 10. In addition, one or more of leg mounting mechanism 310, leg box 100, or second strut clamp 340 may include one or more base feet 140. For example, first strut clamp 340 may be located at a distance from leg mounting mechanism 310 within leg box 100.

FIG. 7a shows case 10 in a closed configuration with lid 30 in full contact with base 20, and four base legs 110 fully deployed and extending from base 20. FIG. 7a shows the configuration of case 10 as shown in FIG. 6a, but with base 20 positioned above working surface 190 rather than as shown in FIG. 6a. Further, FIG. 7a shows case 10 in a closed configuration and raised above working surface 190 via legs 110, rather than base 20 resting directly on working surface 190 as shown in FIG. 3a. And as described and shown above when legs 110 remain retracted during use (see FIGS. 3a-3f), lid 30 can be opened relative to base 20 into an open configuration, as shown in FIG. 7b.

FIG. 7b shows case 10, with legs 110 extended, in a configuration with lid 30 fully open relative to base 20. Similar to FIG. 3e, the open configuration shown in FIG. 7b shows mouse 220, laptop 230, and monitor mount 260. Also shown is a computing surface 360, which can provide a general surface for a user to operate a computing device, such as a laptop, a tablet, a mouse, and a keyboard. Surface 360 can be generally flat, and can generally cover a majority of a top surface of base 20. For example, if an outer dimension of base 20 is about 13 inches by about 22 inches, computing surface 360 may have outer dimensions of about 11 inches by about 20 inches. Computing surface 360 can be about 18 inches wide and about 10 inches deep. In some embodiments, computing surface 360 can form at least about 50% of a total surface area of all top surfaces of base 20.

Computing surface 360 can also be located about two inches or less above a bottom surface of base 20. Such a small height can allow a user to ergonomically position base 20 directly on work surface 190 (see FIG. 4c), and/or extend legs 110 to work at a standing height. Computing surface 360 can further include one or more sections with a padded material such as neoprene. Such material may act as both protection for laptop 230 and/or mouse 220 when the case 10 is in its fully closed configuration. Such material may also absorb vibrations when case 10 is being used in its operational configuration. Other similar materials are also contemplated.

As shown in FIG. 7c, computing surface 360 can include one or more apertures 362. Computing surface apertures 362 can be configured to receive a power pack, outlet strip, one or more cables, or other components of computer hardware. Aperture 362 may be centrally located along a back edge of surface 360, and may continue along a substantial portion of a back edge of surface 360. Such a located and dimensioned aperture 362 may provide a user with ready access to one or more cables connected to various computer hardware in case 10.

Computing surface 360 may also form part of a storage lid 370. Storage lid 370 can be coupled to base 20 along one side of base 20. For example, the coupling could include one or more pivot points generally located along a back edge of base 20. Moreover, the locations of these one or more pivot points could allow storage lid 370 to be pivoted up and away from base 20 so the user can access to a storage compartment 380 beneath storage lid 370. Storage compartment 380 could be used to contain a notebook, paper files, writing utensils, wireless keyboard, power cords, and more.

Storage lid 370 may include one or more protrusions configured to extend into base 20. These or other features of lid 370 could be configured to rest on an internal surface of base 20 when lid 370 is in a closed configuration. Also, lid 370 could be configured to rest upon a surface of lea box 100. In addition, lid 370 and compartment 380 may include various padded materials as described above. Lid 370 may also include one or more apertures, configured to allow easy opening of lid 370 relative to base 20. One or more apertures in lid 370 or computing surface 360 may also allow cables or other parts of components to readily access compartment 380.

In addition, the specific dimensions and arrangement of storage lid 370, base 20, and one or more leg boxes 100 may function in combination to maintain a steady, stable, base or working surface 190 when case 10 is erected or fully closed for transport.

As shown in FIGS. 3e, 4c, & 7c, case 10 can assume an open configuration, whereby lid 30 can be positioned at a predetermined angle relative to base 20. As noted above, legs 110 can be stowed or deployed. When case 10 is in the open configuration, monitor mount 260 can be accessible to a user. As described below, monitor mount 260 can be configured to move to ergonomically position one or more additional monitors 270 relative to a user.

The positioning, dimensions, and movement of monitor mount 260 can be configured to accommodate a computing device (e.g., laptop 230) and one or more additional monitors 270 of various dimensions. For example, enough space should allow laptop 230 to be stowed between computing surface 360 and a storage cushion 390 located on a front surface of monitor mount 260 when monitor mount 260 is stowed and lid 30 is locked to base 20. Also, monitor mount 260 should be able to move to locate one or more additional monitors 270 at an ergonomic height when, either base legs 110 are deployed, or base legs 110 are stowed.

Base legs 110 can be sized such that when deployed case 10 can be located on a working surface between about 28 inches to about 33 inches above the users standing or travel surface, one or more additional monitors 270 will be ergonomically positioned relative to a user. Alternatively, when legs 110 are stowed within case 10, case 10 can be placed on a working surface between about 33 inches to about 38 inches above the users standing or travel surface to ergonomically position one or more additional monitors 270 relative to a user. Such positioning of case 10 can be used when a user is standing.

Minor adjustments in the dimensions or positioning of legs 110, lid 30, base 20 and monitor mount 260 are contemplated to accommodate users of different heights. For example, smaller users may benefit from having case 10 having smaller dimensions or shorter legs 110. A taller user may benefit by having legs 110 and/or monitor mount 260 positioned to provide more height to the final position of one or more additional monitors 270.

In some embodiments, monitor mount 260 or other surfaces within lid 30 or base 20 can also include padded materials. For example, storage cushion 390 can be attached to one or more surfaces of monitor mount 260. Storage cushion 390 can include a lightweight padded material such as neoprene, but not limited to this example. Storage cushion 390 can protect laptop 230, one or more monitors, or other computer hardware when the case 10 is in its fully closed position.

In addition, storage cushion 390 can be configured to retain a position of mouse 220 when case 10 is in a closed configuration. Such a mouse cushion 400 may be available on one or both sides of storage cushion 390 to accommodate a left-handed and a right-handed user. Mouse cushion 400 can be located within regions of monitor mount 260 to allow space for mouse 220 to be stowed between computing surface 360 and mouse cushion 400 when monitor mount 260 is stowed and case 10 is closed. Mouse cushion 400 may include a lightweight stretchy synthetic material like a shock cord net or spandex, but not limited to those examples. This material can conform to the shape of the mouse 220 and securely stow it when being transported.

As shown in FIG. 3e above, monitor mount 260 can be located within a volume or recess 32 at least partially enclosed by lid 30. And as shown in FIG. 4c above, monitor mount 260 can be configured to allow one or more monitors 270 to be ergonomically and stably positioned relative to laptop 230. In some embodiments, monitor mount 260 can be generally flat and extend about a substantial portion of a back surface of lid recess 32. Monitor mount may also be dimensioned to substantially cover one or more additional monitors, as shown in FIGS. 7b-e. For example, monitor mount 260 may be about 10 inches wide by about 20 inches long if lid 30 is about 13 inches wide by about 22 inches long. And similar to surface 360, monitor mount 260 can include one or more apertures for cable management and/or for releasable locking and unlocking of other components of case 10. One or more soundbars, cables, or other components of computer hardware may be generally located about monitor mount 260 when case 10 is in an open and/or closed configuration. In other embodiments shown below and described below, monitor mount 260 can include a rail and/or an articulating arm.

When monitor mount 260 is fully positioned within lid 30, as shown in FIG. 7c, movement of monitor mount 260 can be locked relative to lid 30. Such locking can allow lid 30 to be opened relative to base 20, without monitor mount 260 moving relative to lid 30 (see FIGS. 3c, 3e, 4b). Thus, even when lid 30 is partially opened relative to base 20 (see FIGS. 3c, 4b), monitor mount 260 cannot move relative to lid 30 in this embodiment. Only when lid 30 is in an open position relative to base 20 (see FIG. 3e, 7c), can monitor mount 260 be released from lid 30 and moved to assume a fully open position relative to lid 30 (see FIG. 4c).

As shown in FIG. 7c and described below, a monitor mount release 410 can be located within lid 30. In some embodiments, monitor mount release 410 can be integrally formed with lid-hinge component 180. Monitor mount release 410 can releasably lock and unlock movement between monitor mount 260 and lid 30. For example, a user may depress release 410, which may allow monitor mount 260 to freely move relative to lid 30. Such release may allow monitor mount 260 to move slightly forward relative to lid 30, as shown in FIG. 7b. Note that monitor mount 260 is shown in FIG. 7b with a bottom edge extending slightly beyond base-lid hinge 160. In contrast, FIG. 7c shows the same bottom edge of monitor mount 260 fully retracted within lid 30.

Once monitor mount release 410 has unlocked the movement of monitor mount 260 relative to lid 30, a user may continue to rotate monitor mount 260 relative to lid 30. As shown in FIG. 7d, monitor mount 260 is shown about parallel to base 20. The user may then further rotate monitor mount 260 relative to lid 30 until monitor mount 260 passes beyond a vertical position. Once beyond the vertical, monitor mount 260 may lock into a fully open position relative to lid 30, as shown in FIG. 7e.

The locking of monitor mount 260 relative to lid 30 in a fully open configuration may be manual or automatic. As explained below, automatic locking is preferable because monitor mount 260 and one or more additional monitors 270 can be relatively heavy and cumbersome for a user to move and position. By positioning lid 30 relative to base 20 at an angle slightly greater than 90 degrees, a user does not require large forces to move monitor mount 260 and one or more additional monitors 270 much beyond a vertical plane. Ideally, monitor mount 260 and one or more additional monitors 270 should be controllably or slowly located in their final position. Such operation can also be achieved with different angles between lid 30 and base 20, depending upon the structure and function of one or more L-brackets 420, as described below in detail.

FIG. 7e also shows a mouse region 402 located on an exposed part of monitor mount 260 configured to receive a part of mouse 220 when lid 30 is closed onto base 20. Mouse region 402 is shown located to the right of one or more monitors 270, in a recess with enough space to receive part of mouse 220, as explained above.

In some embodiments, lid 30 could include a lid cushion 404 as shown in FIG. 7e. Lid cushion 404 could be a lightweight padded material such as neoprene but may not be limited to this example. Lid cushion 404 could be located on a back inside surface of lid 30, such as a back surface of lid recess 32. Lid Cushion 404 may be located to provide protection one or more monitors 270 while stowed, or other component of case 10.

FIG. 7f shows hinge components 170, 180 alone, similar to components shown in FIG. 5c, While FIG. 5c shows right-handed hinge components 170, 180, FIG. 7f shows left-handed hinge components 170, 180 when lid 30 (not shown) is fully open relative to base 20 (not shown). FIG. 7f specifically shows lid-hinge component 180 with monitor mount release 410 integrally formed therein. As shown, monitor mount release 410 can include one or more surfaces 412 configured to receive part of monitor mount 260 and/or monitor 270 (not shown). In operation, monitor mount release 410 can elastically deform to latch onto or release part of monitor mount 260. For example, one or more monitor mount releases 410 can be coupled to lid 30, Like base-hinge component 170 shown in FIG. 5c, base-hinge component 170 shown in FIG. 7f can include leg box 100 integrally formed therein. Also shown are two base legs 110 moveably coupled to leg box 100.

As described above and shown in FIGS. 4c & 7e, monitor mount 260 and one or more additional monitors 270 may be moved relative to lid 30 into a final or open configuration. In such a configuration, movement of mount 260 and monitors 270 may be limited or locked to ensure that these components of case 10 do not accidently collapse during use. Such locking should be reversible so that mount 260 and monitors 270 can be readily stowed in a closed configuration within lid 30, as described below.

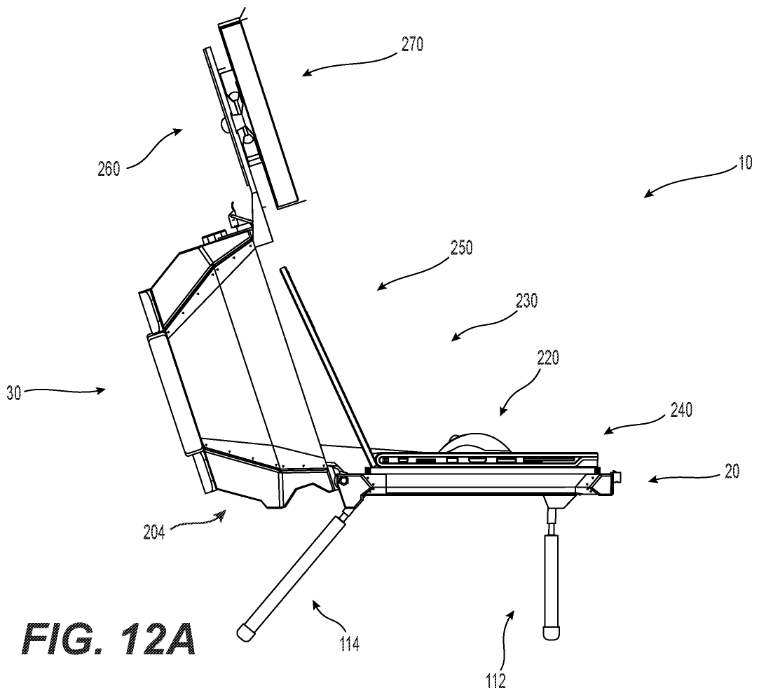

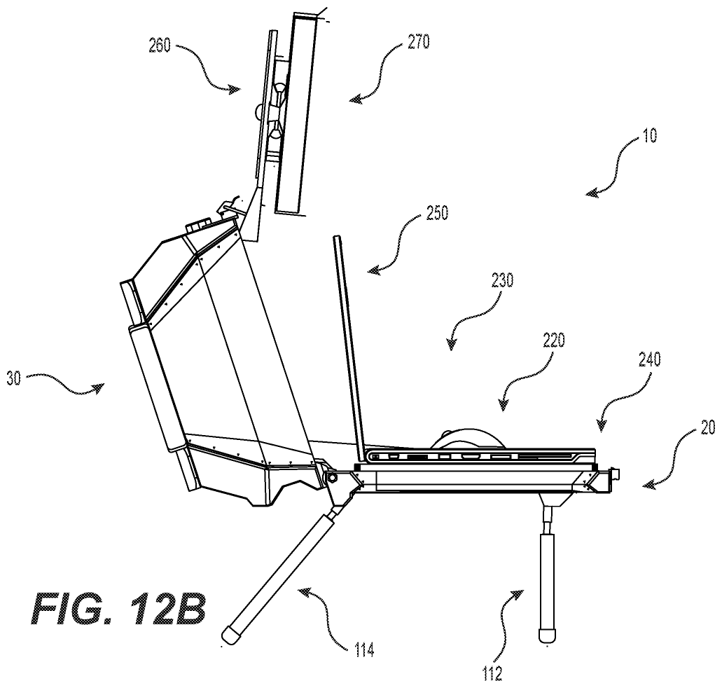

Another feature of case 10 can be the ability to easily adjust a position or angle of one or more additional monitors 270 relative to a user. For example, with reference to FIG. 4c, the angles of laptop monitor 250 and additional monitors 270 are similar. However, a shorter user may wish to tilt one or both monitors 250, 270 towards themselves, placing the angle of one or both monitors 250, 270 closer to, or even beyond, vertical (see and compare FIGS. 12a, b). Such monitor repositioning is relatively easy and known with laptop monitor 250. But such repositioning of additional monitors 270 can be more complicated because of the greater weight, higher center of mass, and structural rigidity required to generally position monitors 270 above lid 30 or base 20.

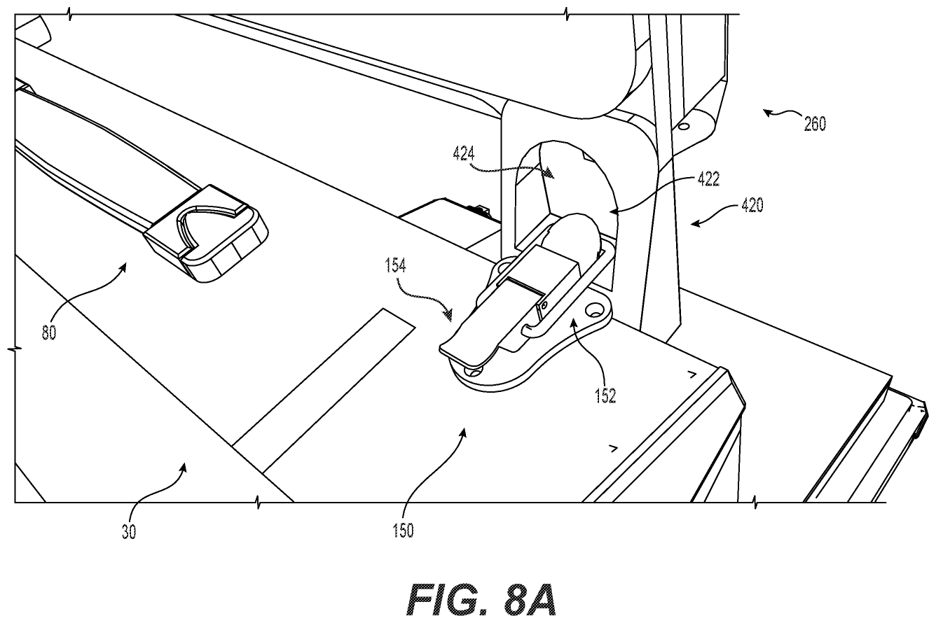

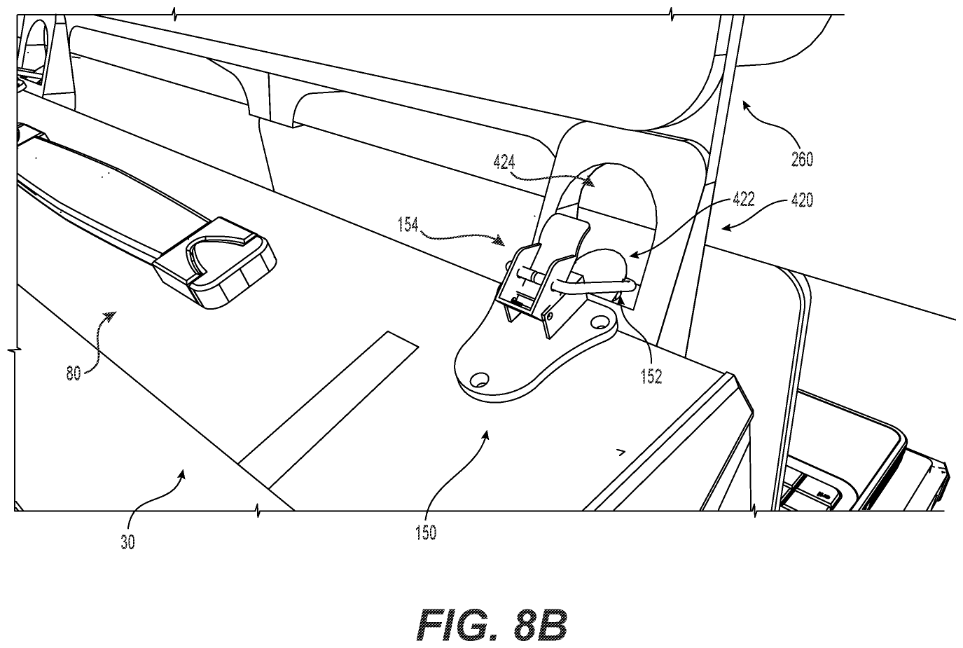

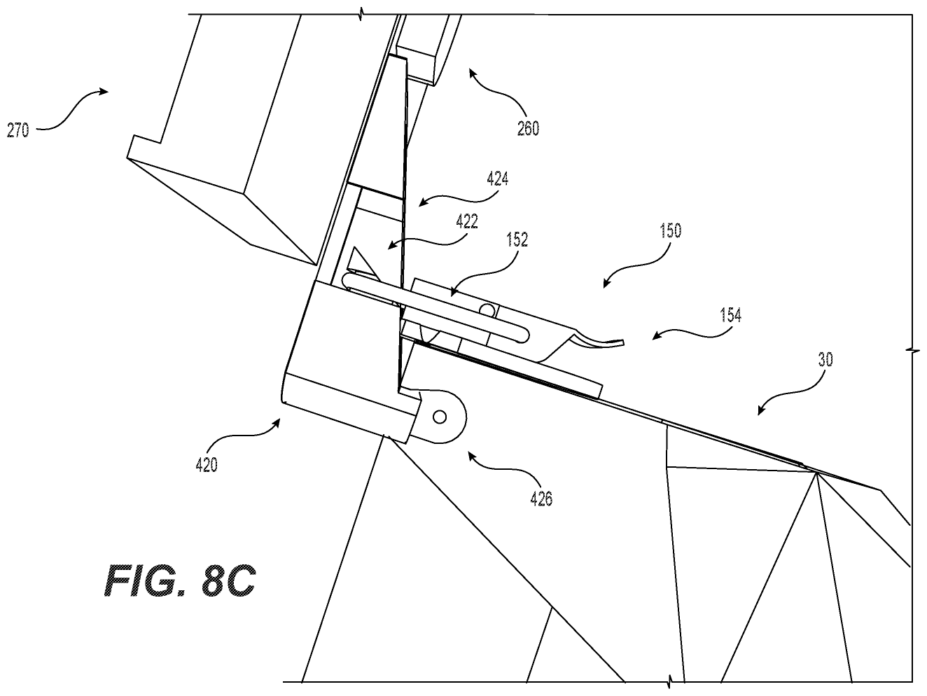

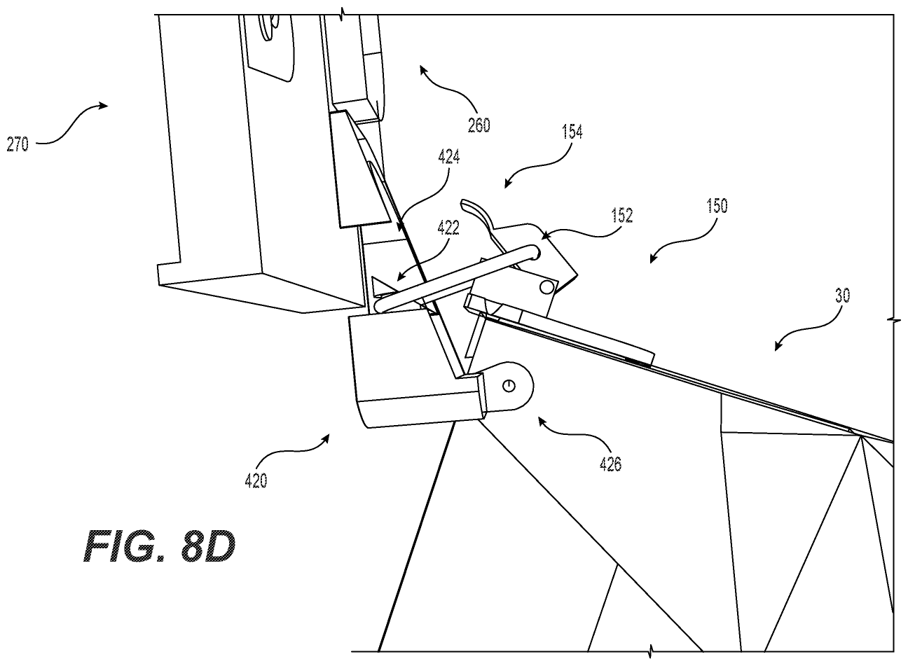

Releasable locking and unlocking of monitor mount 260 and one or more additional monitors 270 relative to lid 30 may be achieved using one or more L-brackets 420 as shown in FIGS. 8a-d. As described and shown, L-brackets 420 may also allow selective adjustment of monitors 270 to improve positioning for some users. While described as “L-brackets”, L-brackets 420 may not be specifically “L” shaped. For example, as shown and described below, L-brackets 420 may be curvilinear or other shapes. In use, L-brackets 420 may allow one or more monitors 270 to be moved from a closed configuration generally within lid 30 to an open configuration generally above lid 30. Monitor mount 260 can include one or more L-brackets 420 configured to moveably couple monitor mount 260 to lid 30.

FIG. 8a shows a detailed perspective view of the top and back of L-bracket 420 when monitor mount 260 is locked in a position relative to lid 30. As shown, base-hinge latch 150 may include a base-hinge latch arm 152 and a base-lid latch member 154 configured to move and/or lock/unlock arm 152. As shown, arm 152 can be configured to couple to L-bracket 420, though other configurations are contemplated. For example, base-hinge latch arm 152 could couple to monitor mount 260, monitor bracket 430, or other component associated with one or more monitors 270.

L-bracket 420 is shown with an L-bracket catch 422 that couples with base-hinge latch arm 152. Catch 422 is shown located within an L-bracket aperture 424 of L-bracket 420, though other configurations are contemplated. For example, catch 422 could be located on a side or back surface of L-bracket 420. However, locating catch 422 within aperture 424 allows a user to observe and operate member 154 and/or arm 152 from the front of case 10. And generally locating arm 152 and catch 422 within aperture 424 can help prevent accidental disengagement of arm 152 from catch 422 while using case 10. Various other locking and unlocking mechanisms are contemplated.

FIG. 8b shows a similar top-back view of L-bracket 420 as shown in FIG. 8a, but with monitor mount 260 located at a different angle relative to lid 30. As shown in FIG. 8b, base-lid latch member 154 is in an open or extended configuration. For comparison, base-lid latch member 154 in FIG. 8a is in a closed or retracted configuration. In this closed/retracted configuration, member 154 pulls arm 152 and catch 422 into general alignment with lid 30 (see also FIG. 12a). By contrast, as shown in FIG. 8b, member 154 in an extended configuration allows arm 152 and catch 422 to extend forwards and away from lid 30. This additional movement may allow monitor mount 260 (and monitors 270) to move through about 10 to about 50 degrees. In some embodiments, this movement can be about 20 to about 40 degrees. In yet other embodiments, this movement can be about 30 degrees. Such additional movement can allow a user to easily fine tune the angle or one or more additional monitors 270 (compare FIG. 12, b). Thus, when lid latch 150 is in a closed configuration, monitor mount 260 may be located about parallel to lid 30. And when lid latch 150 is in an open configuration, monitor mount 260 can tilt relative to lid 30 by an angle of less than about 30 degrees.

Similar to the configurations of case 10 shown in FIGS. 4c, 8a, & 12a, FIG. 8c shows an internal view of monitor mount 260 generally aligned with lid 30. That is, one or more side edges of monitor mount 260 and/or monitors 270, are generally parallel to one or more side edges of lid 30. And like the configurations of case 10 shown in FIGS. 8b, & 12b, FIG. 8d shows an internal view of monitor mount 260 generally tilted forward relative to lid 30. That is, one or more side edges of monitor mount 260 and/or monitors 270, are generally more vertical, or beyond vertical, relative to one or more side edges of lid 30.

FIGS. 8c & d show L-bracket 420 with an L-bracket pivot 426 coupled to lid 30. In some embodiments, L-bracket pivot 426 could be coupled to a corner component of lid 30 or lid-hinge component 180. The relative pivoting movement of L-bracket 420 about pivot 426 illustrates how monitor mount 260 and one or more monitors 270 can move relative to lid 30. As shown, the rotational movement is limited by the coupling between L-bracket 420 and base-lid latch 150. However, other locking/unlocking mechanisms could also be used. For example, a one-way ratcheting mechanism with release could be used to offer more tilting angles.

In other embodiments, pivot 426 could be selectively lockable to provide a range of adjustable angles between monitors 270 and lid 30. For example, pivot 426 can be configured with enough friction to allow the user to adjust the angle of monitor mount 260 (and thus monitors 270) in relation to lid 30 to optimize the user's viewing comfort. Further, pivot 426 could include a clock-spring or similar damping mechanism to slow a decent of mount 260 and monitors 270 relative to lid 30 when case 10 is being closed. Such mechanical biasing could also aid a user when lifting mount 260 and monitors 270 relative to lid 30 when case 10 is being opened. Various damping or biasing mechanisms could be added between L-bracket 420 or monitor mount 260 and lid 30, and between lid 30 and base 20, to assist a user open and/or close case 10.

In some embodiments, monitor mount 260 or one or more L-brackets 420 can be attached at one or more locations to lid 30. For example, one or more pivot points may couple monitor mount 260 or one or more L-brackets 420 to a side edge of lid 30, a front side edge of lid 30, or an internal edge of lid 30.

As shown in FIGS. 8c-d, monitor mount 260 can be attached to an inner side surface of lid 30 using pivoting L-brackets 420. L-brackets 420 can be dimensioned and arranged to allow monitor mount 260 and one or more monitors 270 to move between an open configuration and a closed configuration. In the closed configuration, L-brackets 420 can locate monitor mount 260 and one or more monitors 270 within the volume enclosed by lid 30. Preferably, L-brackets 420 can position monitor mount 260 and one or more monitors 270 towards rear inner surface 404 of lid 30 (see FIG. 7e), maximizing space utilization.

In some embodiments, L-bracket 420 may be dimensioned for use with case 10 approximately sized as carry-on luggage. For example, a distance from a center of L-bracket pivot 426 to a front surface of L-bracket 420 may be about 34 mm. Also, a distance from a center of L-bracket pivot 426 to a front surface of lid 30 may be about 12 mm. And a distance from a center of L-bracket pivot 426 to a top surface of lid 30 may be about 15 mm.

In the open or fully extended configuration, L-brackets 420 may be configured to apply a compressive force to an inner surface of lid 30. This can be achieved if a pivot point of L-bracket 420 is properly located on an internal surface of lid 30. Such brackets 420 may allow forces from the weight of the one or more monitors 270 and monitor mount 260 to be transferred to lid 30 through one or more reinforced corner pieces of lid 30. Alternatively, or in addition to, compressive forces from L-brackets 420 may be applied to an edge of lid 30.

Such brackets 420 may also allow the center-of-mass of monitor mount 260 and the one or more monitors 270 to be transferred through lid 30 to maintain stability of case 10. If the center-of-mass of monitor mount 260 and the one or more monitors 270 is too far back, case 10 may topple over backwards. And if the center-of-mass of monitor mount 260 and the one or more monitors 270 is too far forward, lid 30 and/or monitor mount 260 may topple over forwards.

Once movement of monitor mount 260 is properly limited or locked relative to lid 30, and monitor mount 260 finally positioned relative to lid 30, one or more monitors 270 may be moved from a closed to an open configuration. In some embodiments, a single monitor 270 can be coupled to monitor mount 260. Such a monitor (not shown) could be open to its final operational position as shown in FIG. 7e. However, in other embodiments, two or more monitors 270 may be coupled to monitor mount 260. Two monitors 270 may be preferred, given monitor costs, ergonomic benefits of larger viewing area, and dimensional constraints within lid 30.

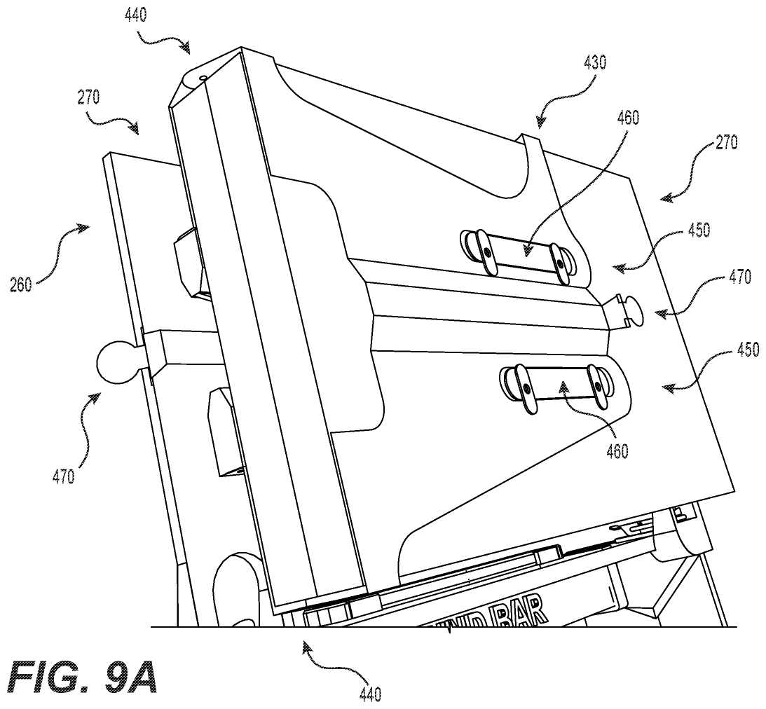

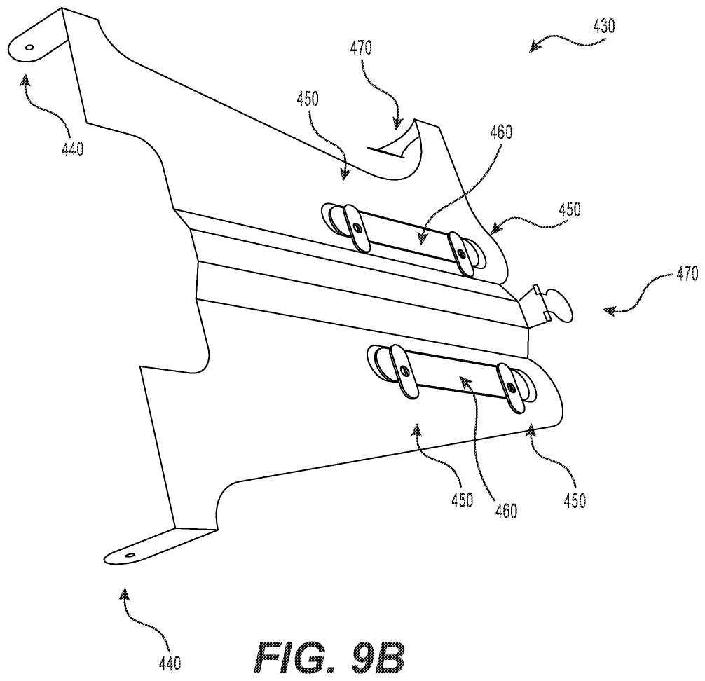

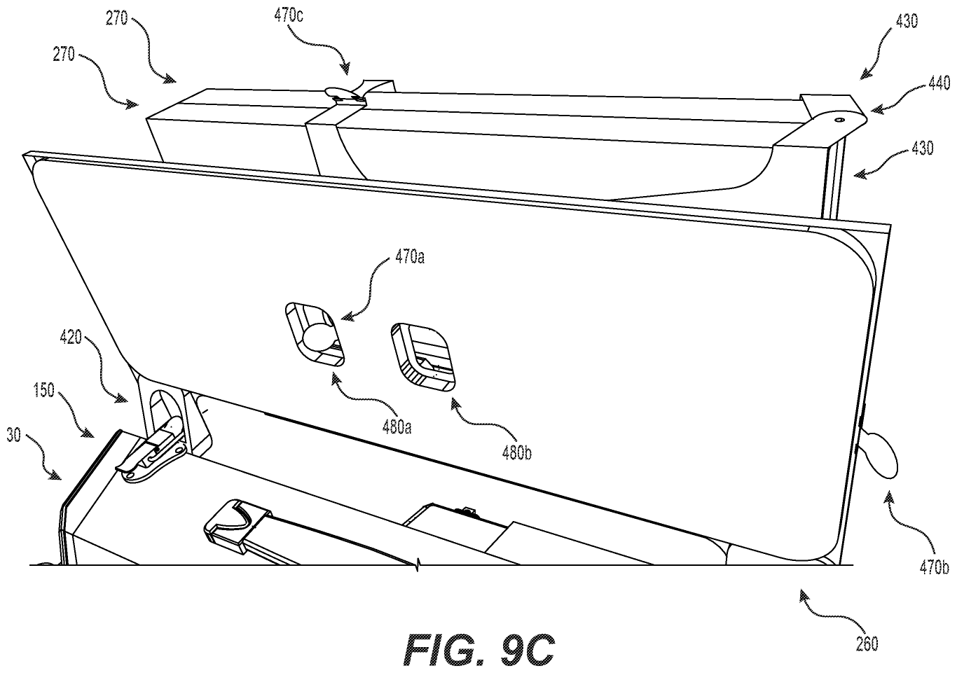

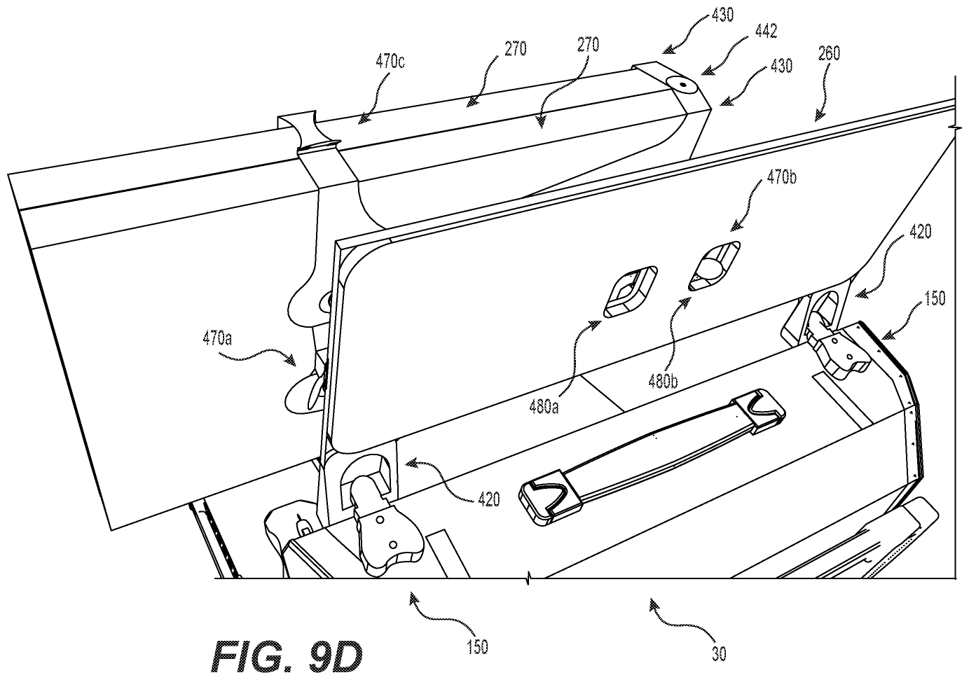

FIG. 9a shows a front detailed perspective view of monitor mount 260 and two monitors 270, as shown in FIG. 7e. As shown in FIGS. 7e and 9a, two monitors 270 are stacked or sandwiched together, with screens on front surfaces (not shown) facing one another. Such an arrangement can provide optimal protection during transport. For example, one or more adhesive pads (not shown) may be located at one or more corners and generally between the front surfaces of monitors 270 when stacked together. Each monitor 270 can also be attached to a monitor bracket 430. FIG. 9b shows such a monitor bracket 430 alone.

Monitor bracket 430 may be coupled to another monitor bracket 430 via one or more monitor bracket hinges 440. Two monitor bracket hinges 440 are shown in FIG. 9a along a left-hand edge of monitor 270. As described below, such hinge(s) 440 may allow the two monitors 270 to be open relative to each other.

Monitor mount 260 may include one or more monitor brackets 430 coupled to one or more monitors 270 via a variety of couplings. As shown, one or more monitor bracket latches 450 are configured to releasably attach to bracket 430. In some embodiments, monitor bracket latches 450 can be generally flat and/or rotatable to conserve space. Other parts of monitor bracket 430 should ideally be generally flat to conserve space within case 10 when in a closed configuration.

As shown in FIGS. 9a & b, and understood by those skilled in the art, one or more latches 450 can be rotated to a position(s) to allow monitor backing plate 460 to be detached from bracket 430. Typically, one or more backing plates 460 would be fixedly attached to a back surface of monitor 270. Alternatively, backing plate 460 could be integrally provided on the back of monitor 270 in a standard configuration. Latches 450, when vertical as shown, could lock bracket 430 to monitor 270. When latches 450 are rotated into a horizontal position, monitor 270 could be unlocked from bracket 430.

As shown in FIGS. 9a & b, monitor bracket 430 can also include one or more monitor bracket clips 470 configured to releasably lock and unlock movement of monitor bracket 430 relative to another component of case 10, including another monitor bracket 430. While clips 470 are shown as flexible couplings, other types of locking mechanisms are contemplated. For example, latches, Velcro, screws, or other locking mechanisms could be used in place of, or in conjunction with, clips 470.

FIG. 9c shows a back-perspective view of monitor mount 260 with monitors 270 located on the right side of monitor mount 260. As shown, a top monitor bracket clip 470c can releasably lock and unlock two additional monitors 270 stacked or sandwiched together in a closed or travel configuration. One or more other monitor bracket clips 470a, b can be variously positioned about monitor mount 260 to releasably lock and unlock movement of one or more monitor brackets 430 relative to monitor mount 260. For example, clip 470a may be clipped to a monitor mount aperture 480a and dip 470b may be dipped to a right-side edge of monitor mount 260.

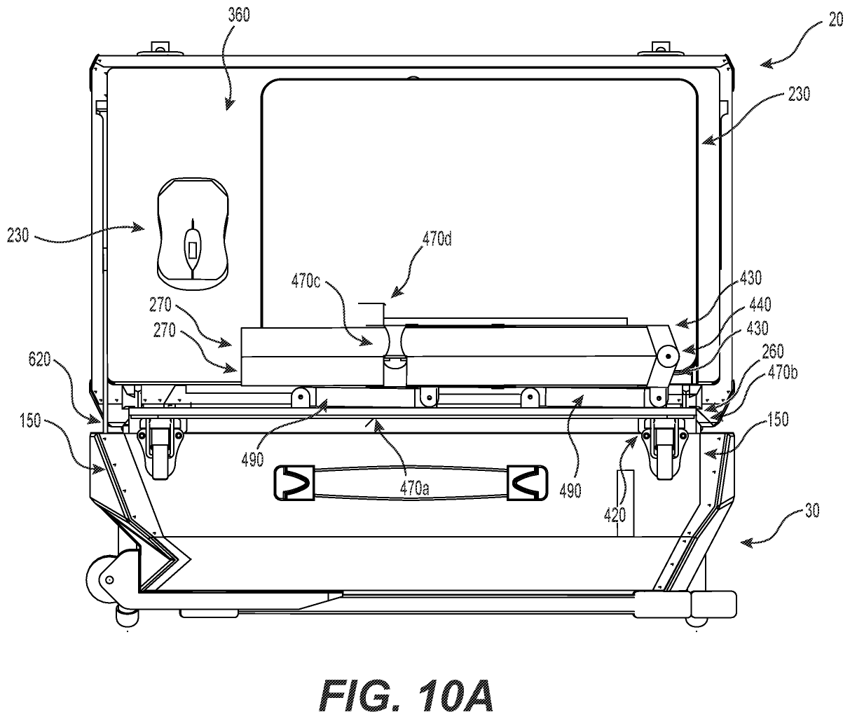

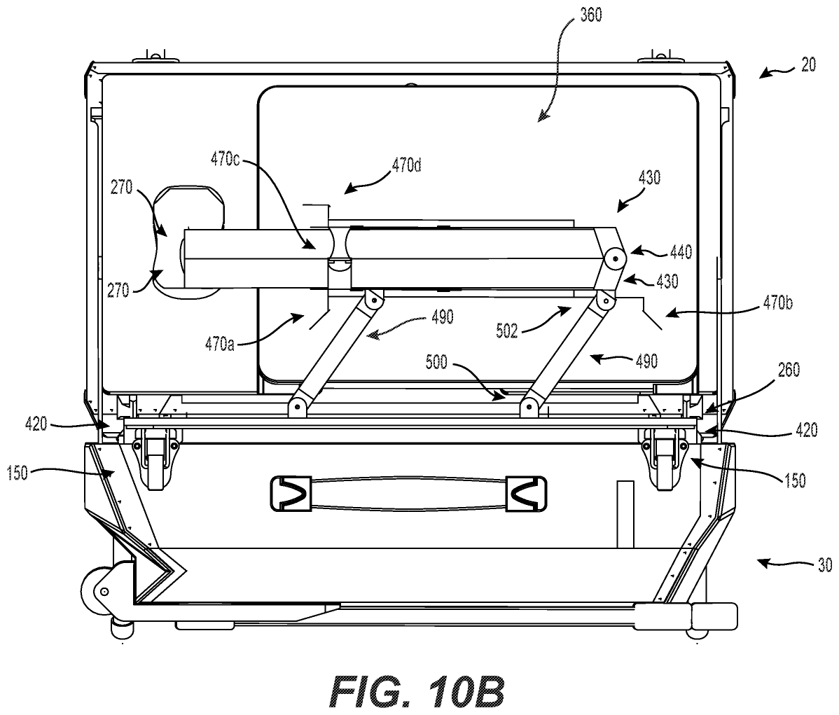

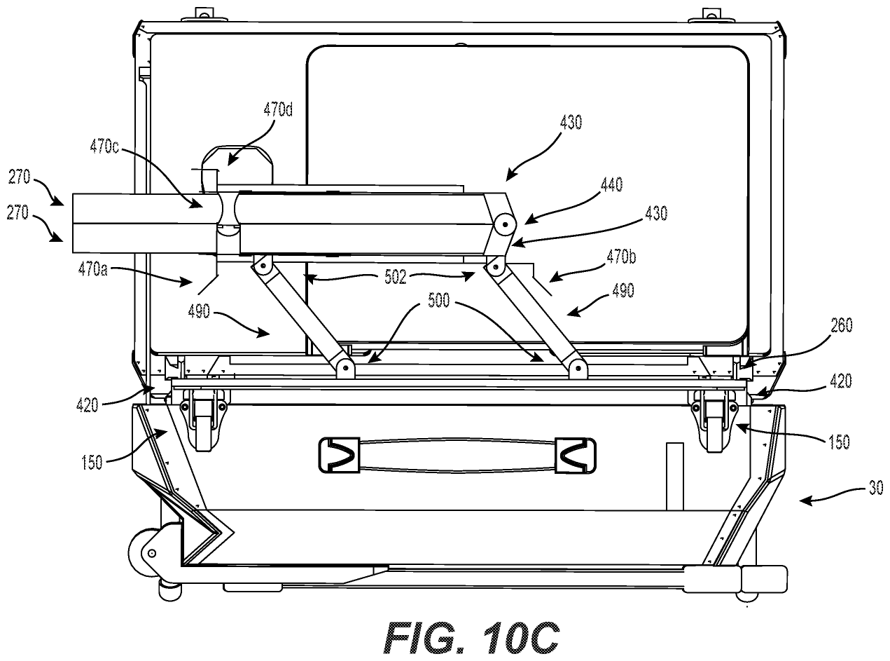

FIG. 9d shows a similar back perspective view as FIG. 9c of monitor mount 260 with monitors 270 located on the left side of monitor mount 260. As shown in FIG. 9c, top monitor bracket dip 470c has locked two additional monitors 270 together in closed configuration. But different to the configuration shown in FIG. 9c, clip 470a may be clipped to a left side edge of monitor mount 260 and clip 470b may be clipped to a monitor mount aperture 480b. Movement of monitors 270 from one side of monitor mount 260 to the other can be achieved with the use of one or more swing arms 490, as shown in FIGS. 10a-c.

FIG. 10a shows a top view of case 10 as shown in FIGS. 7e, 9a, & 9c, with monitors 270 generally located on a right side of monitor mount 260. Note that FIGS. 7e & 9a show monitors 270 located on a left side of monitor mount 260 as their perspective views are provided from the front of case 10 rather than from the back as in the other FIGS. 9c & 10a. One or more swing arms 490 can moveably couple one or more monitor brackets 430 to a front surface of monitor mount 260. Monitor mount 260 can be coupled to at least one monitor bracket 430 via at least one swing arm 490 configured to pivotably move at least one monitor bracket 430 relative to the monitor mount 260.

As shown in FIG. 10a, two swing arms 490 can be positioned generally parallel to a plane of monitor mount 260, one or more monitors 270, or one or more monitor brackets 430. This can be considered the closed or travel configuration of swing arm 490. When a user moves monitors 270 from the right to the left side of monitor mount 260 (when viewed from behind case 10), clips 470a, b may be disengaged from monitor mount 260. Then, as shown in FIG. 10b, swing arms 490 may allow for a movement of brackets 430 and monitors 270 relative to monitor mount 260. In some embodiments, one or more swing arms 490 are contemplated.

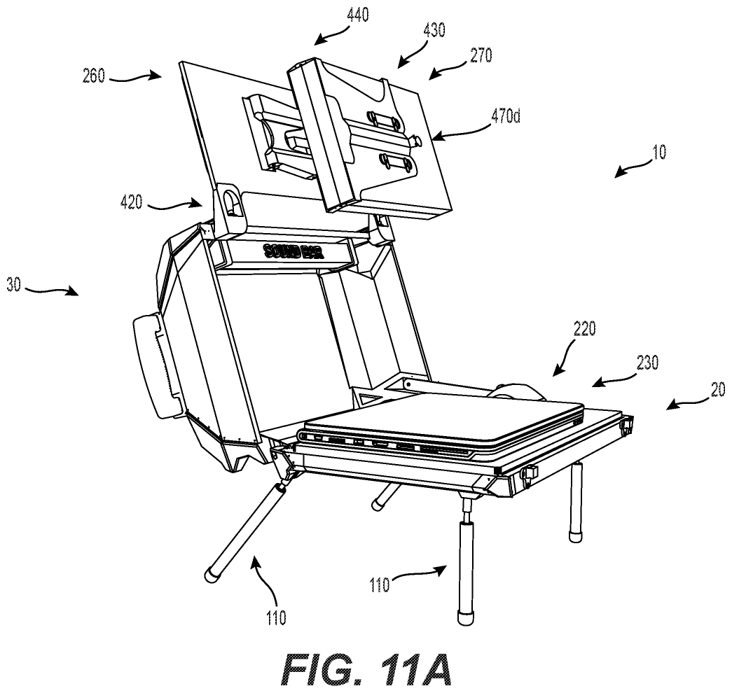

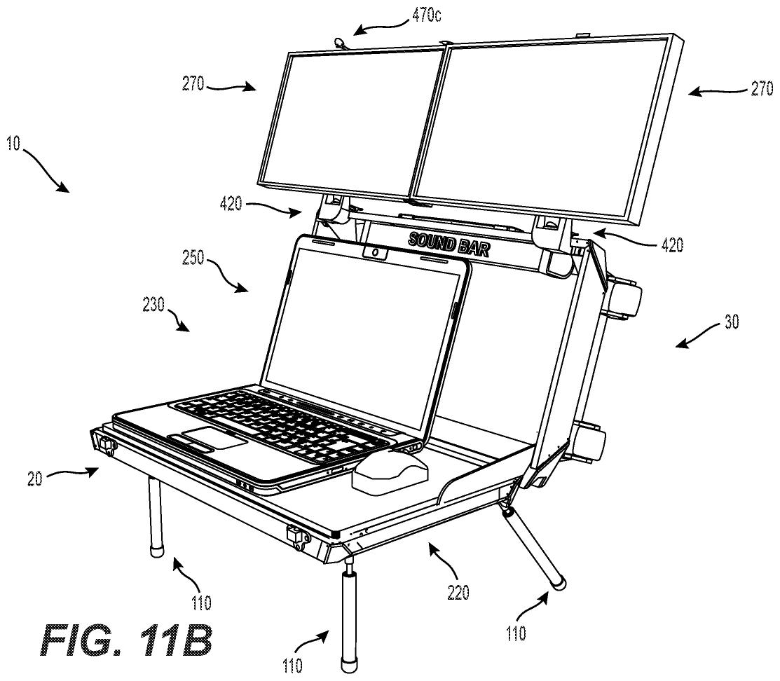

One or more swing arms 490 can be configured to pivot relative to monitor mount 260 and one or more monitor brackets 430. One or more swing arms 490 can include a first pivot point 500 mounted to monitor mount 260 and generally located at a first end of swing arm 490. In addition, one or more swing arms 490 can include a second pivot point 502 mounted to one or more monitor brackets 430 and generally located at a second end of swing arm 490. For example, FIGS. 10b, c shows two swing arms 490 pivotably mounted to rear monitor bracket 430. In other embodiments, one or more monitor brackets 430 may be configured to move relative to monitor mount 260 with one or more pivots, one or more slidable couplings, one or more rotational couplings, or combinations thereof, Such movement may allow one or more monitors 270 to be moved from a travel configuration (e.g., FIG. 10a) to an operational configuration (e.g., FIG. 11b).

As shown in FIG. 10b, one or more swing arms 490 can be located off-center on a front surface of monitor mount 260. Such positioning can provide off-center storage of monitors 270 (see FIG. 10a) and allow central positioning when monitors 270 are in an open configuration (see FIG. 11b). As shown in FIG. 10a, monitors 270 can be stored off-center to the right relative to monitor mount 260. This arrangement can provide a region located in front of monitor mount 260 that can receive at least part of mouse 220 when monitor mount 260 is in a storage configuration (see 7c, e).

FIG. 11a shows a front perspective view of case 10, in an open configuration, with swing arms 490 and monitor mount 260 located in a final open position. As shown by comparing FIG. 10a with FIG. 11a, when one or more swing arms 490 are pivoted 180+/−degrees relative to monitor mount 260, monitor hinge 440 can be aligned with a central axis of monitor mount 260. Once monitors 270 have been moved to the right as shown in FIG. 11a, a user could then release clip 470c on top of monitors 270 (see FIG. 10c), unlocking the movement of front monitor 270 relative to back monitor 270. Once unlocked, a user may then rotate front monitor 270 relative to the left and about hinge 440 to reveal the screens of both monitors 270 (see FIG. 11b). Once front monitor 270 is rotated and aligned generally flat relative to back monitor 270, both monitors 270 can be positioned relative to each other as shown in FIG. 11b. The left side monitor 270 shown in FIG. 11b may be clipped in place with a suitable clip (not shown) or remain in place via gravity.

In other embodiments, the arrangement of swing arm 490 and monitor bracket 430 can also be flipped and attached to different pivot points on monitor mount 260. Thus, the right-to-left movement of monitors 270 as shown in FIGS. 11a & b could instead be a left-to-right movement. Such an arrangement could permit mouse 220 and mouse cushion 400 to be located to the left of laptop 230 (not shown) rather than the right-handed configuration shown in FIGS. 11a, b.

In addition to a user operating the components of case 10 as shown in FIG. 11b, when a user may be standing on a travel surface, a user may use a wireless keyboard (not shown) positioned on a working surface on which legs 110 contact. The positioning of one or more monitors 270, 250 may be easily adjusted to enable the user to create and vary an ergonomic working experience. Side-by-side positioning of monitors 270 generally above and at a similar angle to laptop monitor 250 (see FIG. 11b, 12a, b) can provide an ergonomic advantages to a user. A user may predominantly work on applications displayed on monitors 270, while monitor 250 may display back-up or secondary applications. Such monitor use can reduce neck and eye strain by allowing a user to maintain a comfortable working position for longer periods of time. Occasionally they may look down to monitor 250 to check email or refer to a secondary document. Further, a camera (not shown) centrally mounted between monitors 250, 270 can allow a user to easily use all monitors 250, 270 during a Zoom, Webex, Skype, or other type of video conference meeting. Centrally locating sound (see “Sound Bar” shown in FIG. 11b) and lighting (not shown) can provide similar benefits.

Various other features could be used with, or added to, case 10. For example, lid 30 could be configured to receive a soundbar as shown in FIG. 11b, In addition, a camera mount (not shown) could be added to monitor bracket 430, monitor mount 260, lid 30, or other suitable component of case 10. Further, various cords, cables, outlets, speakers, drives, and lighting could be provided within or about case 10 as required by users.

In general, a user may revert case 10 from the operational or fully open configuration shown in FIG. 11b, to the travel or fully closed configuration shown in FIG. 1a, by reversing the steps described above. That is, they may first move one additional monitor 270 so that it is positioned over or stacked relative to the other additional monitor 270. Then the folded or stacked monitors 270 may be repositioned relative to monitor mount 260. Once moved to a storage configuration, monitors 270 may be locked relative to monitor mount 260. Then monitor mount 260 may be unlocked from lid 30 and placed back within recess 32 of lid 30. This storage process may be aided by a spring, pneumatic cylinder or other damping mechanism to slow the movement of monitor mount 260 relative to lid 30. Then monitor mount 260, or another part of monitors 270, or related component, may be locked relative to lid 30. As described above, monitor mount release 410 may perform this function, though other locking mechanism are contemplated. Next the user may close lid 30 relative to base 20. Before closing, a user may need to properly position laptop 230 and mouse 220 so that mouse 220 is in general alignment with mouse cushion 400. Further, other components used with case 10 may require placing in storage compartment 380. Lid stay 210 may not require an active step to close lid 30, but such a manual lock could be added as needed. Once lid 30 has been locked to base 20, case 10 could be placed on one side so that one or more legs 110 can be returned to leg box 100. Once legs 110 are stowed, case 10 can be used or stored in this travel configuration as needed. Various locks may require unlocking, though friction fit and other movement limiting mechanisms are also contemplated. Overall, such an easy and simple set-up and take-down process allows for greater usability of case 10.

As described above, case 10 can include one or more legs 110 that extend from base 20. Base 20 can be positioned generally horizontally to provide a generally horizontal working surface for laptop 230 and/or mouse 220. Moreover, lid 30 can be positioned at an angle relative to base 20 to allow a monitor of laptop 230 to be appropriately positioned on computing surface 360 of base 20. In addition, monitor mount 260 can be positioned relative to base 20 to provide ergonomic and stable support for one or more monitors 270.

FIG. 12a shows case 10 in a first operational configuration, where one or more monitors 270 are generally positioned parallel to a side surface of lid 30. As generally understood, laptop monitor 250 can be readily adjusted to a variety of angles relative to laptop keyboard 240 and base 20. FIG. 12b shows case 10 in a second operational configuration, where one or more monitors 270 are tilted to about 90 degrees relative to keyboard 240 and base 20. Monitor 250 is also shown in a more upright configuration compared with FIG. 12a, These independently adjustable positions of monitors 250, 270 can allow a user to readily set-up, take-down, optimize, and vary, their working environment. Such ergonomic enhancements are designed to improve a user's experience.

As described above, legs 110 can extend from base 20 to further enhance a user's working environment. Legs 110 can be easily opened or closed in a number of configurations. The length and/or angle of legs 110 can also be adjusted if needed by a user. Moreover, legs 110 can be sufficiently strong to generally resist unwanted movement and/or have sufficient friction with working surface 190 to generally resist slipping.

In addition, one or more back legs 114 can extend beyond a back edge of base 20 to provide adequate stability to case 10 and its associated computer hardware when case 10 is in its various operational configurations. Legs 114 may have limited flexibility to absorb some vibrations and/or accommodate slightly uneven working surfaces. Also, a center-of-mass of one or more monitors 270 and lid 30 can pass generally in front of the distal ends of the back legs 114. Moreover, forces from the weight of the one or more monitors 270, mount 260, and other components can extend through appropriately engineered sections of lid 30 to provide a stable working assembly. In addition, a general vertical positioning of front legs 112 can provide stability by absorbing forces associated with vigorous typing.

The overall stability of case 10 can be provided with legs 110 extended as in FIGS. 12a, b, or with legs 110 retracted as in FIG. 4c. Like distal ends of legs 114 extending backwards past a center-of-mass of case 10 in an open configuration as shown in FIG. 12a, lid surface 204 may be similarly positioned behind the center-of-mass of case 10 as shown in FIG. 4c.

Safety can also be provided by components that can be locked in their movement relative to other components. For example, monitor brackets 430 can be releasably lockable to monitor mount 260, monitor mount 260 can be releasably lockable to lid 30, and lid 30 can be releasably lockable to base 20. As described above, legs 110 can be releasably lockable relative to base 20.

In some embodiments, case 10 can be configured for use as standard carry-on luggage. That is, the dimensions of case 10 may not generally exceed about 9 inches by about 14 inches by about 22 inches, depending on airline requirements. Moreover, case 10 may provide the ability to position a center of one or more monitors 270 at about 12 to 20 inches above keyboard 240 or computing surface 360. In addition, computing surface 360 may be located about 2 to 15 inches above working surface 190. And a total depth of case 10 in a fully open configuration may be less than about 24 inches, making it suitable for use on a standard kitchen countertop.

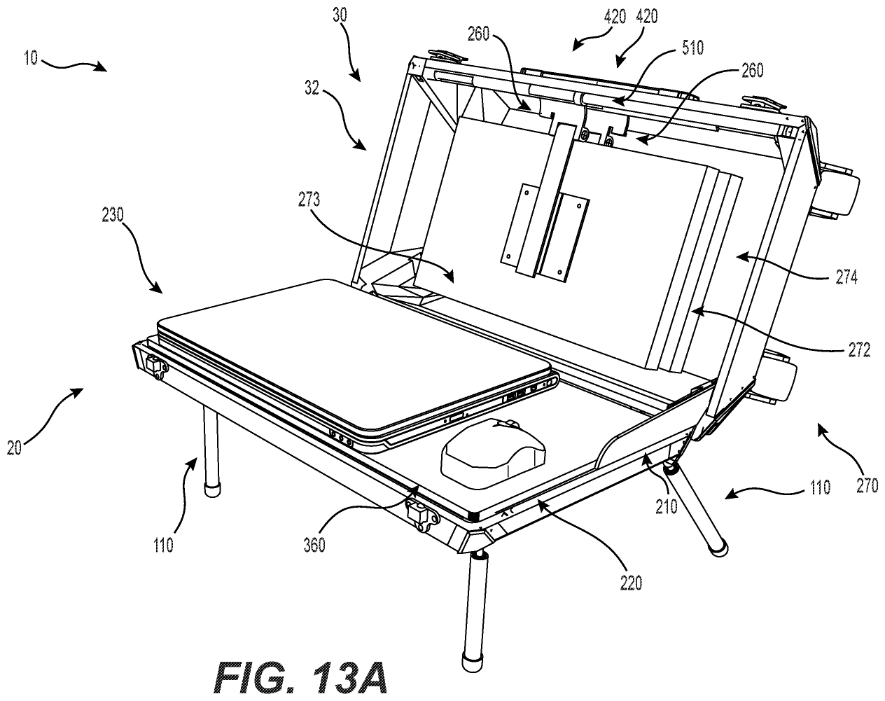

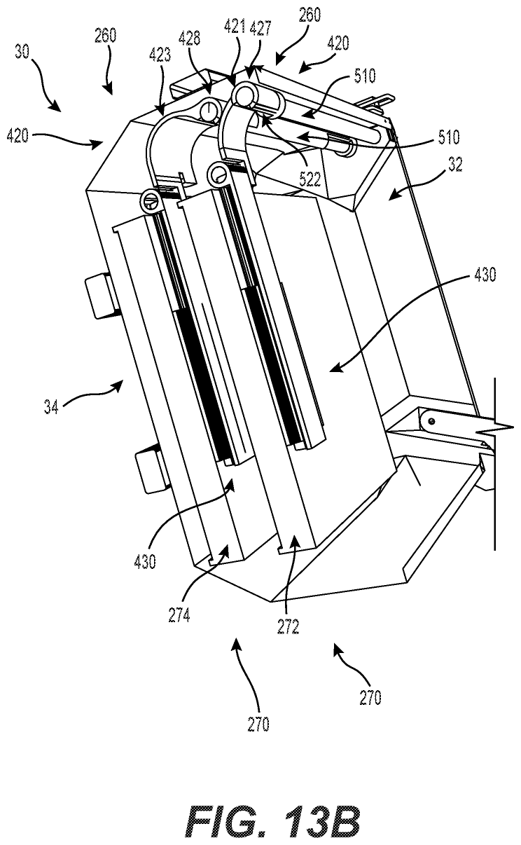

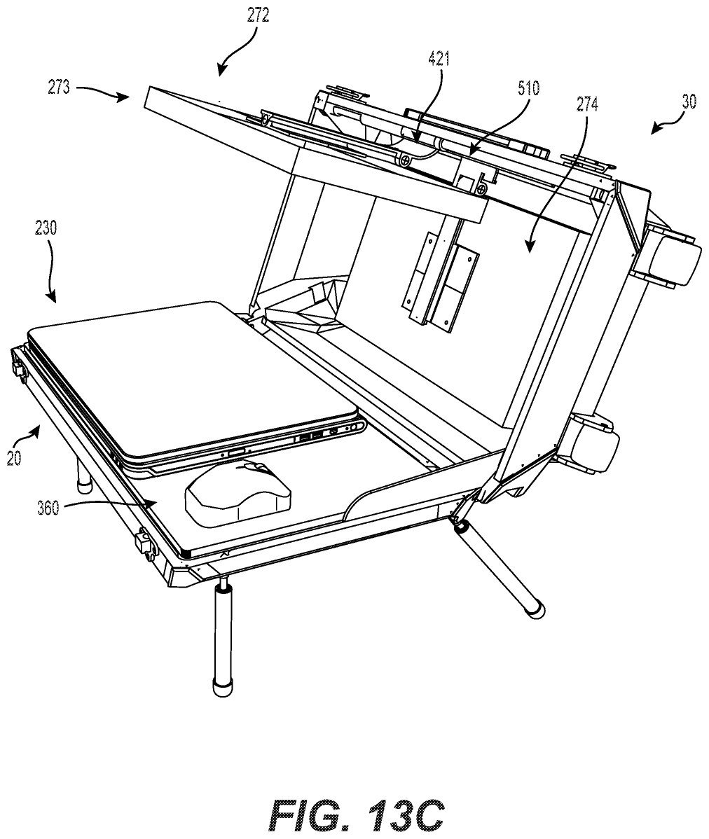

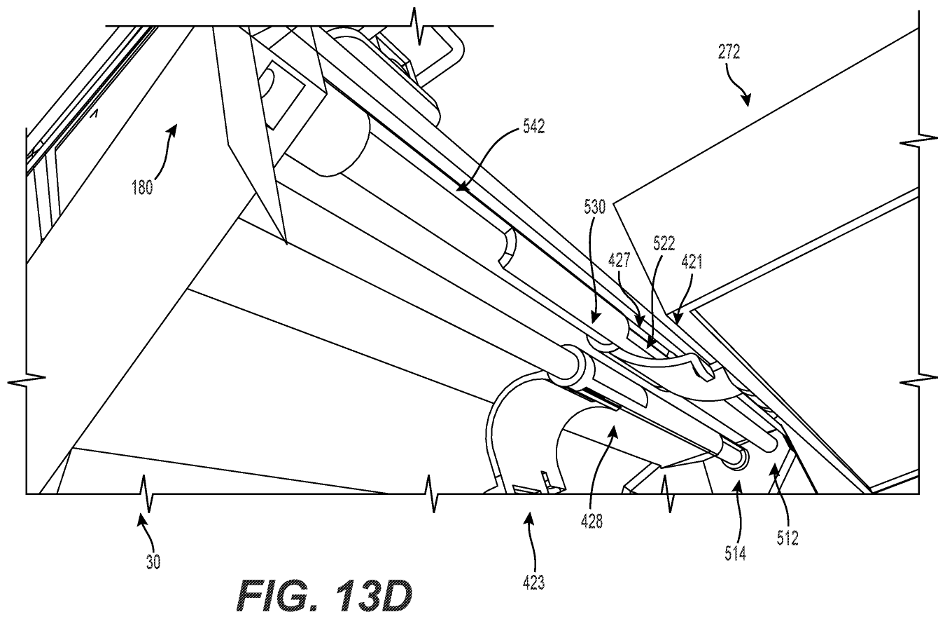

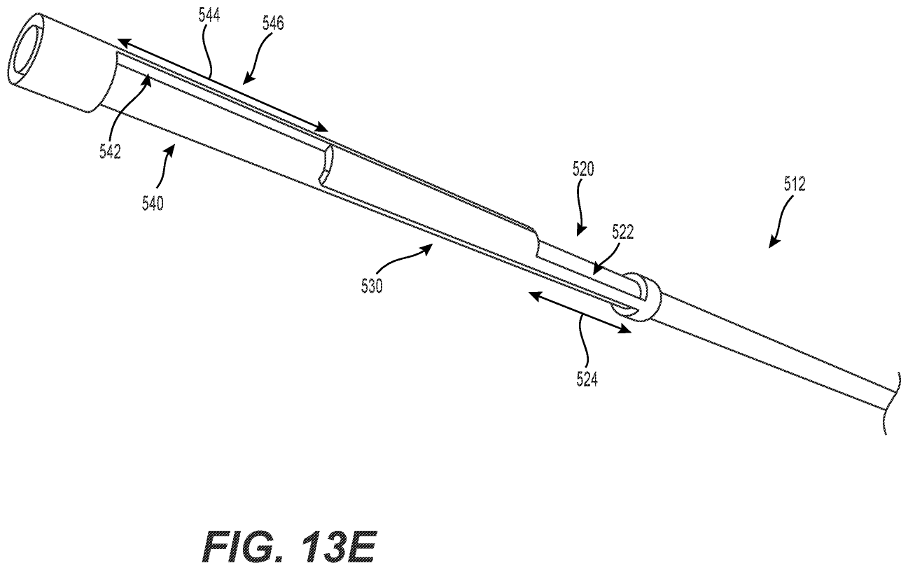

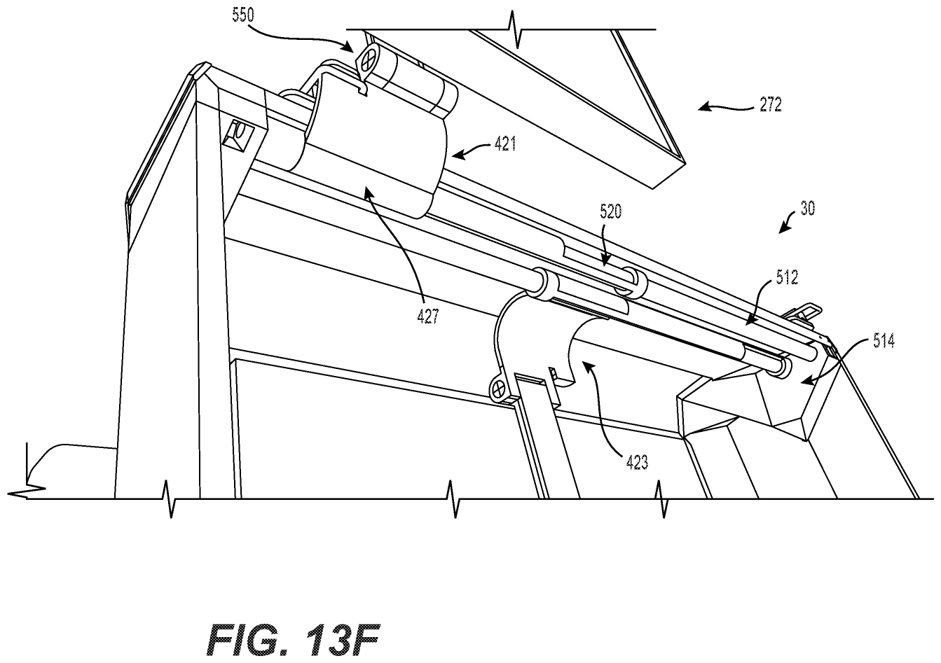

FIG. 13a shows case 10 according to another embodiment. As described above, case 10 includes base 20 moveably coupled to lid 30. Lid stay 210 can limit movement between lid 30 and base 20 in the open configuration, as shown. It is also contemplated that lid stay 210 may releasably lock and unlock movement between lid 30 and base 20 in the open configuration.

Also shown in FIG. 13a are mouse 220 and laptop 230 (in closed configuration) located generally on computing surface 360. One or more legs 110 are shown extending from beneath base 20, and as described above, these legs 110 may be retracted into or against base 20 in travel or operational configurations of case 10.

FIG. 13a also shows two monitors 270 located in lid recess 32. Specifically, front additional monitor 272 and back additional monitor 274. As described above, one monitor 270 or more than two monitors 270, are also contemplated. Also shown are two monitor mounts 260, wherein each monitor mount 260 is coupled to one monitor 270. Each monitor mount 260 is moveably coupled to a monitor rail 510, wherein each monitor rail 510 is fixedly coupled at one or both ends to lid 30. Only a single front monitor rail 510 is shown in FIG. 13a because a second back monitor rail (not shown) is located behind the front monitor rail 510.

FIG. 13b shows a cut-through sagittal view of lid 30 and monitors 270 shown in FIG. 13a. Two monitors 270 are shown in a stacked configuration for storage within lid recess 32, In such a configuration, monitors 270 are aligned generally parallel to a back surface 34 of lid 30. Also shown are two monitor mounts 260, wherein each monitor mount 260 can be coupled to each monitor 270. As described above, each monitor mount 260 can be configured to move to position each monitor 270 in one or more configurations

In some embodiments, monitor mount 260 can include a plurality of L-brackets 420 and a plurality of monitor brackets 430, as shown in FIGS. 8a-9d. FIG. 13b shows another embodiment wherein each monitor mount 260 includes a single L-bracket 420 coupled to a single monitor bracket 430. Moreover, each L-bracket 420 is shown in FIG. 13b coupled to a single monitor rail 510.

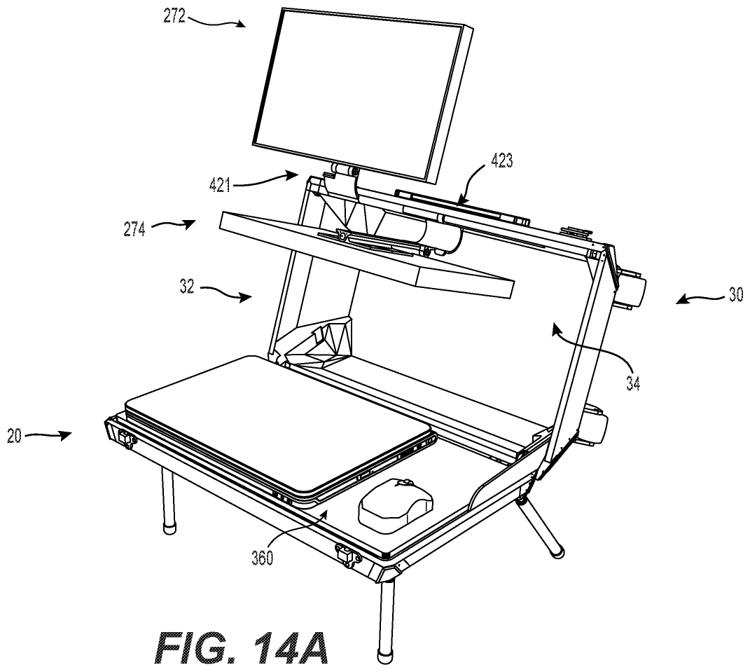

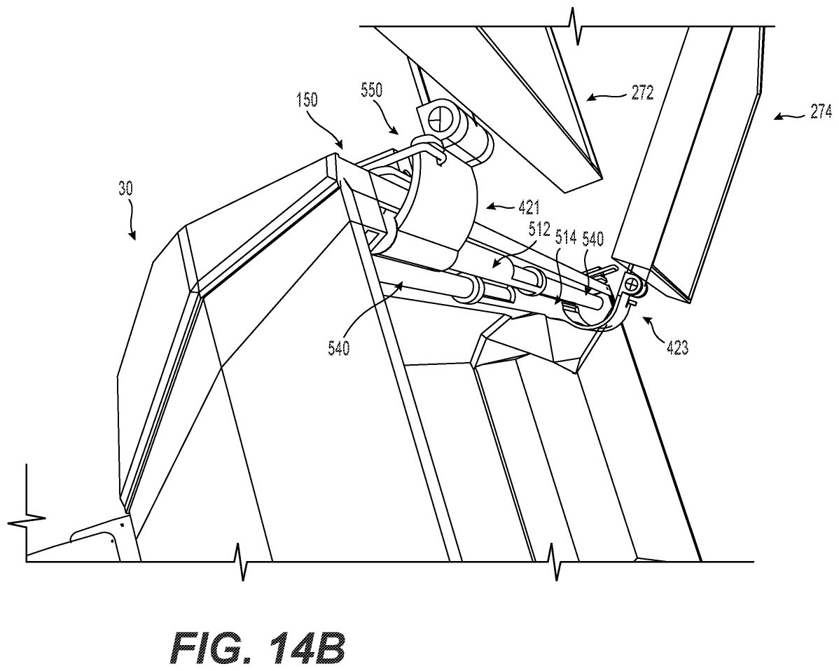

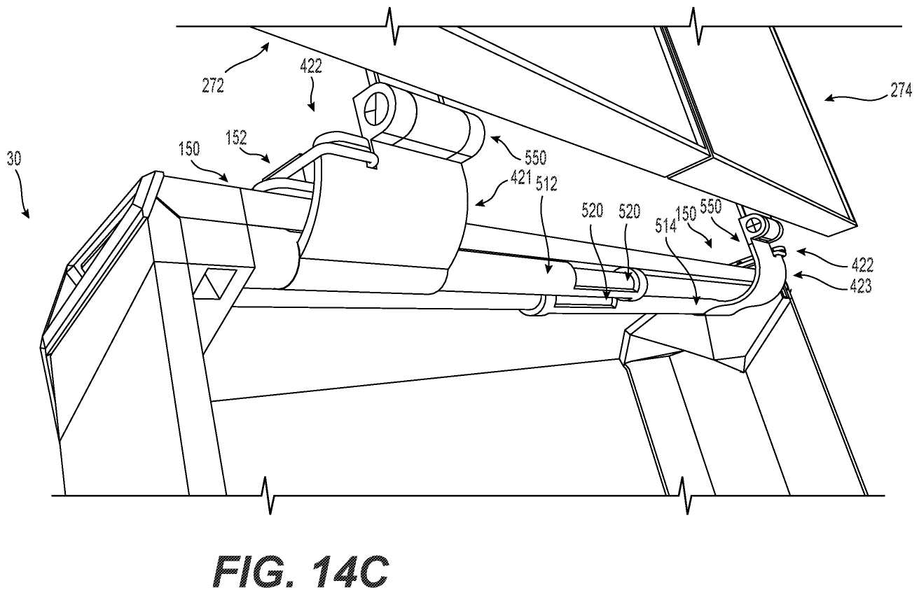

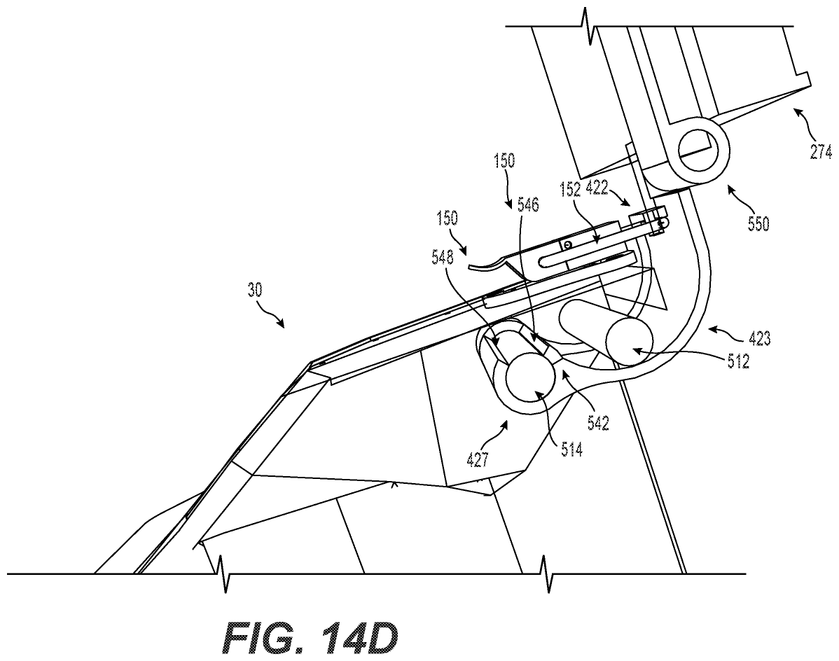

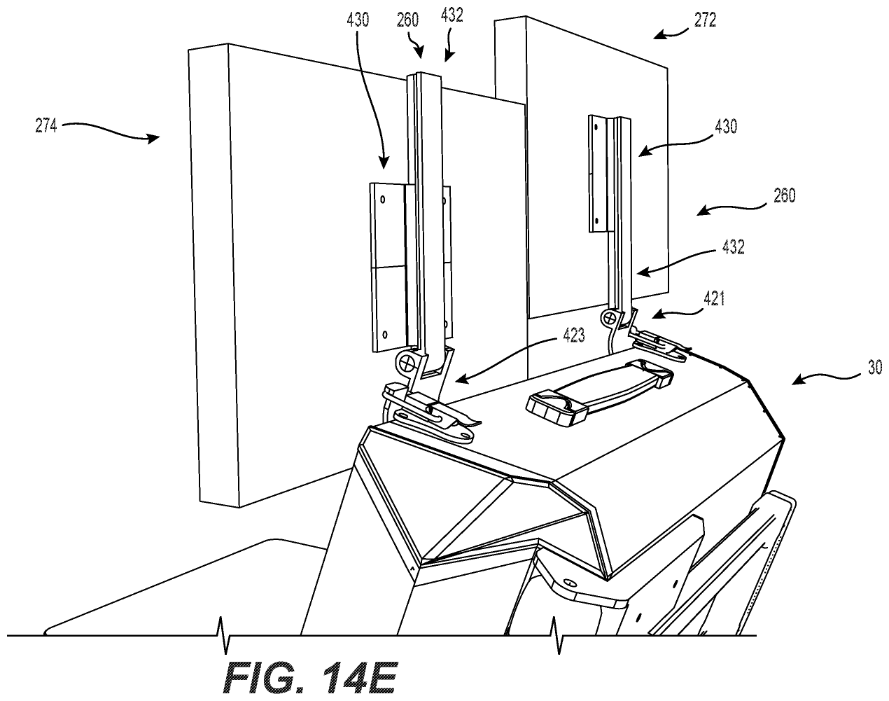

As shown in FIG. 13b, a front L-bracket 421 can be generally located in front of a back L-bracket 423. FIG. 13b also shows front L-bracket 421 with a generally curvilinear shape compared with back L-bracket 423, which has more of a general “L” shape (see also FIGS. 14d, e). These and other shapes of brackets 420, 421, & 423 are contemplated. In part, one or more shapes of brackets 420, 421, & 423 can depend on the space requirements within recess 32, the relative positioning of one or more rails 510, the movement of brackets 420, 421, & 423, and the final positioning of brackets 420, 421, & 423 relative to lid 30.

One or more monitor rails 510 may be fixedly attached to one or more surfaces of lid 30. FIG. 13b shows two monitor rails 510 located generally against an inner upper surface of lid recess 32. Monitor rail 510 may extend generally from one side of lid 30 to the other side of lid 30. For example, each end of monitor rail 510 may be fixedly attached to an inner side surface of lid recess 32, And as shown and explained below, monitor mount 260 may be moveably coupled to monitor rail 510 to allow positioning of monitor 270 in a closed or travel configuration and an open or operational configuration.

FIG. 13b also shows front L-bracket 421 with a front L-bracket pivot 427 and back L-bracket 423 with a back L-bracket pivot 428. Both front and back L-bracket pivots 427, 428 and each coupled to, respectively, front and back monitor rails 510. As explained below in detail, each front and back L-bracket pivot 427, 428 can independently move slidably and rotatably relative to each monitor rail 510.

FIG. 13c shows case 10 with a front additional monitor 272 partially rotated relative to lid 30. Before reaching such a positioning of front monitor 272, a user may unlock movement of monitor 272 relative to lid 30. As described above, this may be achieved using one or more monitor mount releases 410 (see FIG. 7c, e, but not shown in FIG. 13a, c). Then, with monitor 272 located generally parallel to back monitor 274 as shown in FIG. 13a, the user may rotate a top edge 273 of monitor 272 towards base 20. Note that top edge 273 of monitor 272 as shown in FIG. 13a is generally located in the bottom of lid recess 32. And this top edge 273 is shown generally above computing surface 360 and laptop 230 when monitor 272 is partially open in FIG. 13c. Front L-bracket 421 is shown partially rotated relative to monitor arm 510. Moreover, this movement of front monitor 272 can occur independently of back monitor 274, which may remain generally parallel to back surface 34 of lid 30, as shown in FIG. 13b.

FIG. 13d shows a detailed internal perspective view of lid 30 when front additional monitor 272 is in a partially open configuration as shown in FIG. 13c. Specifically, FIG. 13d shows a front monitor rail 512 coupled to front L-bracket 421 and a back monitor rail 514 coupled to back L-bracket 423. While back bracket 423 is shown in FIG. 13d as shown in FIG. 13b in a closed configuration relative to lid 30 and surface 34, front bracket 421 in FIGS. 13d, c is shown in a partially opened configuration rotated about 90 degrees relative to the closed position shown in FIGS. 13a, b. Once in this partially opened configuration, front bracket 421 (and front monitor 272) may be slide along rail 512. Specifically, bracket 421 and monitor 272 may be slide to the left due to the coupling between front L-bracket pivot 427 and one or more features of front monitor ail 512.

FIG. 13e shows a detailed perspective view of front monitor rail 512 alone. Rails 510, 512, 514 can be variously dimensioned and fixedly located within, or attached to, lid 30. As shown in FIGS. 13d, e, a left end of rail 512 may be fixed to an internal surface of lid 30. This may include, for example, lid-hinge component 180 as shown in FIG. 13d. Rails 510, 512, 514 may further include one or more recess 520, 540, and/or one or more surfaces 530 as described below.

Front monitor rail 512 is shown with a first rail recess 520, a rail surface 530, and a second rail recess 540. In some embodiments, recesses 520, 540 may be configured to receive one or more L-bracket pivots 427, 428. For example, FIG. 13b shows front bracket pivot 427 generally located within first rail recess 520. In some embodiments, movement of front bracket 421 relative to first rail 512 may be limited by a first rail recess surface 522. This surface 522 may contact a corresponding surface of pivot 427 (not shown in FIG. 13e), when bracket 421 is in the closed configuration shown in FIG. 13b. However, surface 522 may not contact the corresponding surface of pivot 427, when bracket 421 is in the partially open configuration shown in FIG. 13d. When in this partially open configuration shown in FIG. 13d, a back surface of front L-bracket 421 may contact rail surface 530.

To allow general rotation from closed (FIGS. 13a, b) to partially open (FIGS. 13c, d) configuration of front monitor 272, a first rail recess width 524 (FIG. 13e) of rail 512 may be about a width of front L-bracket pivot 427 (not shown in FIG. 13e). Further, second rail recess 540 may have a second rail recess width 544 that is about the same as first rail recess width 524. Recesses 520, 540 with such one or more dimensions corresponding approximately to one or more dimensions of bracket pivot 427 can allow for limited horizontal movement along rail 512 when front monitor 272 is in a closed (FIGS. 13a, b) and fully open configuration (FIGS. 13f, 14a, b).

Conversely, rail surface 530, located generally between first recess 520 and second recess 540, can be configured to allow horizontal movement of front monitor 272. For example, when front monitor 272 and L-bracket 421 are in the partially open configuration shown in FIGS. 13c, d, front L-bracket pivot 427 may be positioned out of alignment with first recess 520. Once pivot 427 is located outside recess 520, L-bracket 421 may be moved horizontally. As shown in FIGS. 13c, d, monitor 272 may be slid to the left whereby bracket 421 can slide along rail surface 530.

In some embodiments, monitor rail 510 can be dimensioned for positioning within case 10 approximately sized for carry-on luggage. For example, a total length of rail 512 may be about 500 mm. The larger diameter left-sided section of rail 512 encompassing recesses 520, 540 shown in FIG. 13e may be about 255 mm in length. This larger diameter section may be about 18 mm in diameter, and the right-sided smaller diameter section may be about 12 mm in diameter. Moreover, widths 524, 544 of recesses 520, 540 may be about 67 mm, and a total length of rail surface 530 shown in FIG. 13e, including first rail recess width 524, may be about 160 mm.

As shown in FIG. 14D, the centers of rails 512, 514 may be about 15 mm from an inner top surface of lid 30. Also, a center of front rail 512 may be about 11 mm from a front surface of lid 30, and a center of back rail 514 may be about 37 mm from the front surface of lid 30.

For front L-bracket 421, as shown in FIG. 13B, a center of front L-bracket pivot 427 may be about 31 mm from a back surface of front L-bracket 421. Also, a center of front L-bracket pivot 427 may be about 39 mm from a center of a front monitor tilt point 550 (see also FIG. 14c). For back L-bracket 423, as shown in FIG. 13B, a center of back L-bracket pivot 428 may be about 56 mm from a back surface of back L-bracket 423. Also, a center of back L-bracket pivot 428 may be about 39 mm from a center of a front monitor tilt point 550 (see also FIG. 14c),

FIG. 13f shows monitor 272 after bracket 421 has slid along the full length of rail surface 530. Once positioned to the far left of rail 512, front L-bracket pivot 427 may rotate upwards and into recess 540 (see FIG. 13e). A final fully open position of monitor 272 can be at least partially defined by contact between a back surface of front L-bracket pivot 427 and a second rail recess surface 542 (see FIG. 13e). However, as described above one or more other surfaces or features of lid 30 may define a fully open configuration for monitor 272. And once monitor 272 has reached its fully open configuration, one or more base-lid latches 150 may lock monitor 272 in this fully open configuration. As described and shown above in FIGS. 8a-d, monitor 272 may be tilted into one or more positions using select positioning of latch 150. Alternatively, or in addition, as shown in FIG. 13f, monitor mount 260 can include a monitor tilt point 550 configured to tilt monitor 270 relative to lid 30 or base 20.

Another advantage of rail 512 is that it can include a back-stop surface 546 located at an angle relative to surface 542 (see FIGS. 13e, 14d). Back-stop surface 546 can be configured to contact a L-bracket pivot surface 548 (see FIG. 14d) when monitor 270 and L-bracket 420 are in partially open configurations, such as shown in FIGS. 13c, d for monitor 272 and L-bracket 421. Such contact between surfaces 546 and 548 can limit the movement of monitor 270 and bracket 420, providing a safety mechanism if monitor 270 is accidently dropped during set-up or take down. Instead of monitor 270 “falling” or rotating through about 180 degrees from fully open configuration (e.g., FIG. 13f for monitor 272) to fully closed configuration (e.g. FIGS. 13a, b for monitor 272), monitor 270 may “fall” or rotate through only about 90 degrees to a partially open configuration (e.g. FIGS. 13c, d for monitor 272). Such a partial “fall” or rotation of monitor 270 may reduce the impact forces on monitor 270 and lid 30. Various surfaces 546, 548 may be adjusted to provide other angles of partial “fall” or rotation as needed to improve the safe set-up or take down of one or more monitors 270.

Yet another advantage of the second embodiment shown in FIGS. 13, 14 is that one monitor 272, 274 may be moved at one time. The other embodiments generally require a user to move two or more monitors 270 at the same time from a closed or storage configuration to an open or operational configuration. Such movement can be mechanically assisted with springs, pistons, and other biasing devices, but it may still be difficult for some users to routinely (e.g., daily) set up and take down multiple monitors. However, it is also possible that case 10 includes only one additional monitor 270. Such cases 10 could find similar advantages with any of the configurations described herein as only one monitor 270 is being moved at any time.

FIG. 14a shows case 10 with front monitor 272 in a fully open configuration and back monitor 274 in a partially open configuration. Specifically, front L-bracket pivot 427 of front L-bracket 421 can be located within second rail recess 540 of front monitor rail 512. And back L-bracket pivot 428 of back L-bracket 423 can be located outside first rail recess 520 of back monitor rail 514. As described and shown above for front monitor rail 512, back monitor rail 514 can include one or more recesses and surfaces. Like those shown in FIG. 13e for front rail 512, back rail 514 can include first recess 520, second recess 540, and rail surface 530 located generally between first and second recess 520, 540. And similar to front L-bracket 421, back L-bracket 423 can be configured to selectively engage, disengage, and move relative to, recesses 520, 540 and surfaces 522, 530, 542 of back rail 514. Thus, once in the partially open configuration shown in FIG. 14a, monitor 274 can be slid to the right along rail 514. When monitor 274 and back L-bracket 423 are located at a right end of rail 514, as shown in FIG. 14b, back L-bracket 423 may be rotated upwards into recess 540 of rail 514, as shown in FIG. 14c. Back L-bracket 423 may then be releasably locked to lid 30 to lock the position of monitor 274.

FIG. 14c shows monitors 272, 274 locked relative to lid 30. Specifically, base-lid latch arms 152 of lid 30 are shown coupled to L-bracket catches 422 of front L-bracket 421 and back L-bracket 423. Tilting of either monitor 272, 274 can be independently achieved via select adjustment of base-lid latch 150, as described above for FIGS. 8a-d, Alternatively, or in addition to, either monitor 272, 274 can be independently tilted about respective monitor tilt points 550.

FIG. 14d shows a detailed cut-through sagittal view of back L-bracket 423 when monitor 274 is in the fully open configuration as shown in FIG. 14c. Specifically, latch 150 is shown locked with latch member 154 fully engaging latch arm 152 such that catch 422 is fully engaged. This is like the configuration described and shown above in FIGS. 8a,c.

FIG. 14d also shows a back surface of back L-bracket 423 contacting front monitor rail 512. This contact can be configured to occur as an alternative to, or in addition to, contact between front L-bracket pivot 427 and second rail recess surface 542 of rail 514. Note also that the width of bracket 423 and pivot 427 can allow for significant lateral contact between these components and corresponding contact surfaces. These features, along with the releasably locking and unlocking of latch 150 can provide a high degree of stability between monitor 274 and lid 30 in the fully open configuration. Such stability, maintaining such stability through low wear and large contact surfaces, and allowing only pre-defined movements of brackets 421, 423 relative to rails 512, 514, can provide significant advantages. Such features can allow a user to easily and repeatably, open, close, and position monitors 272, 274.

FIG. 14e shows a perspective back top view of lid 30 with monitors 272, 274 having different heights. As shown, monitor mounts 260 can include a monitor bracket track 432 configured to allow individual movement of monitors 272, 274 relative to L-brackets 421, 423. Monitor brackets 430 may be fixedly coupled to monitors 272, 274 as described above. Further, a single monitor bracket 430 may slidably engage a single monitor bracket track 432. Thus, a user can readily adjust the height of one or both monitors 272, 274 relative to base 20 and lid 30 as desired.

Such movement of one or more monitors 272, 274 from a closed, to a partially open, to a fully open configuration may be needed to avoid monitors 272, 274 contacting other components of case 10. For example, sliding either monitor 272, 274 horizontally immediately without any rotation would bring either monitor 272, 274 in contact with a sidewall of lid 30. And completely rotating monitors 272, 274 through about 180 degrees relative to back surface 34 of lid 30 may cause monitors 272, 274 to contact each other. Employing one or more monitor rails 510 that allow for selective rotation and sliding of monitors 272, 274 relative to lid 30 can alleviate these limitations of one-dimensional monitor movement.

Like described above, one or more monitor mounts 260, brackets 421, 423, rails 510, or other components of this second embodiment shown and described in FIGS. 13 and 14 can be biased or otherwise assist movement of one or more monitors 272, 274. For example, pivots 427, 428 could include a spring to assist general positioning of monitors 272, 274 in the open configuration. Further, rails 510 may provide a damping mechanism to reduce the speed of movement of monitors 272, 274 when transitioning from one configuration to another. Other releasably locking, unlocking, or movement limiting mechanisms are also possible to assist the user. It should also be noted that moving one additional monitor 270 individually will likely involve less force than simultaneously moving a plurality of additional monitors 270.

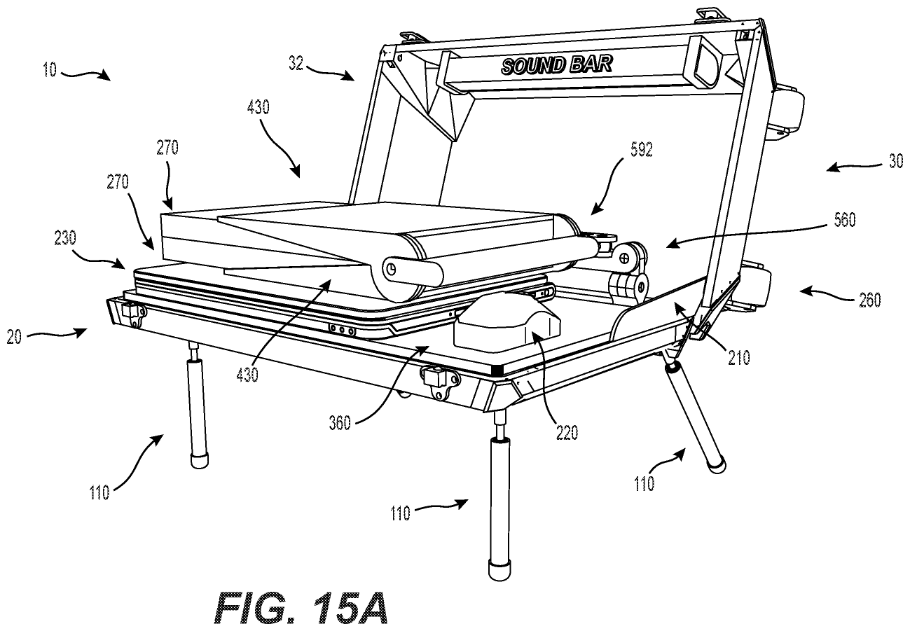

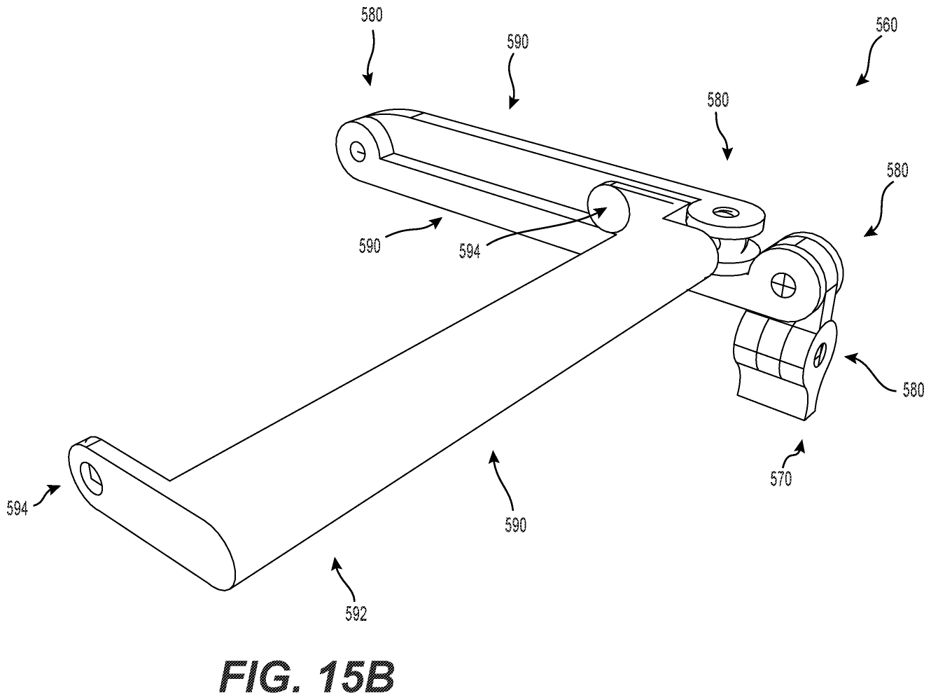

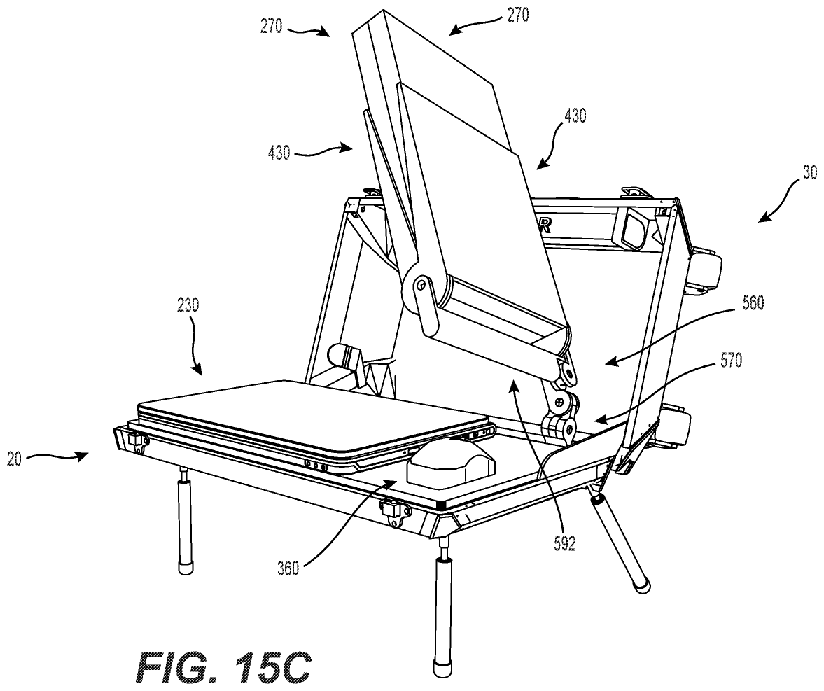

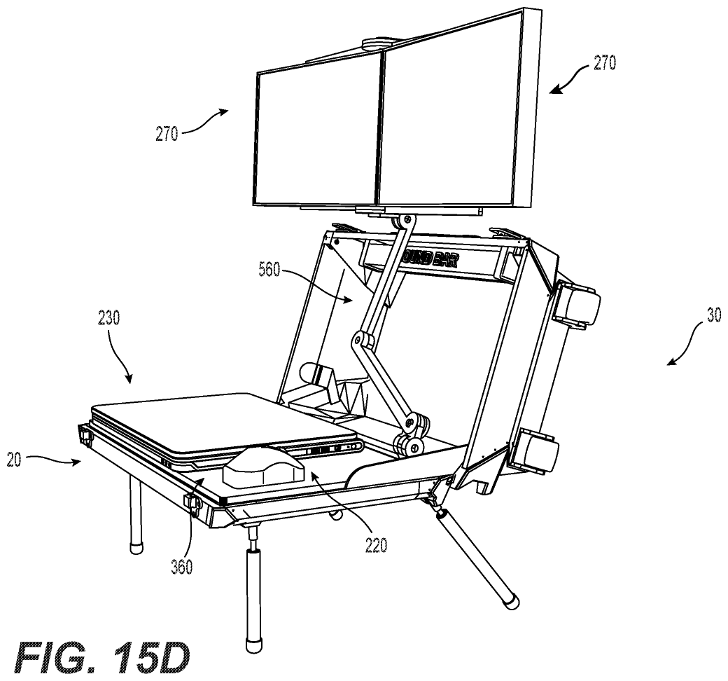

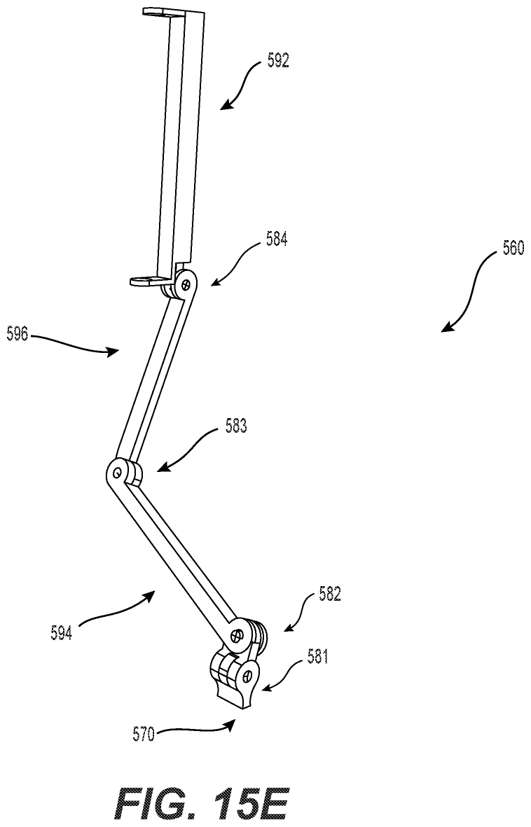

A third embodiment of case 10 is also contemplated, as shown with reference to FIGS. 15a-e. As described above, case 10 can include lid 30 moveably coupled to base 20. FIG. 15a shows case 10 with lid 30 in an open configuration. Also shown are two monitors 270 in a closed or storage configuration. When lid 30 is closed, these two monitors 270 could reside generally within recess 32 of lid 30. One of ordinary skill will appreciate that the dimensions of lid 30 may be adjusted to accommodate more or less monitors 270. For example, and as with the other embodiments described above, the height of lid 30 may be increased to accommodate more monitors 270 stacked higher. Conversely, the height of lid 30 may be decreased if one or thin monitors 270 are required or developed. However, generally the dimensions of lid 30 should allow lid recess 32 to generally cover one or more monitors 270, laptop 230, and mouse 220 located on computing surface 360.

The embodiment shown in FIGS. 15a-e and described below may or may not include lid stay 210. This is in part because monitor mount 260 including an articulating monitor arm 560 may be coupled to base 20 rather than lid 30 in the embodiments described above. However, it is also contemplated that articulating monitor arm 560 could be coupled to lid 30, where in may be advantageous to include lid stay 210 to releasably lock and unlock movement between lid 30 and base 20 in the open configuration. FIG. 15a also shows one or more legs 110 extending from beneath base 20, and as described above. These legs 110 may be retracted into or against base 20 in travel or operational configurations of case 10.

FIG. 15a shows two monitors 270 located generally parallel to computing surface 360, and positioned in a stacked configuration generally on top of laptop 230. As described above, one monitor 270 or more than two monitors 270, are also contemplated. These one or more monitors 270 can be coupled to monitor mount 260 having articulating monitor arm 560. Movement of monitor mount 260 and articulating monitor arm 560 relative to computing surface 360 or base 30 can allow one or more additional monitors 270 to be positioned in a final open and operating configuration generally above laptop 230 or computing surface 360.

FIG. 15b shows articulating monitor arm 560 alone in the closed monitor configuration shown in FIG. 15a. Articulating monitor arm 560 can include an articulating arm anchor 570 fixedly or moveably coupled to base 20 or lid 30. As shown in FIG. 15a, anchor 570 is fixedly attached to a back right corner of base 20. Arm 560 can further include one or more articulating knuckles 580. While three articulating knuckles 580 are shown in FIG. 15b, more or less are also contemplated. Articulating knuckle 580 may be configured to move or rotate two adjacent articulating members 590. This movement may be freely lockable or unlockable via various mechanisms. It is also contemplated that one or more mechanical assist mechanisms may be used to allow a user to position arm 560 in a certain location, and have arm 560 generally remain in that location. Such spring, pneumatic, and other mechanisms are generally well known in the art.

One or more monitor brackets 430 may also moveably or fixedly couple to one or more articulating knuckles 580 and/or articulating members 590. As shown in FIGS. 15a, b, an articulating monitor member 592 may pivotably couple to two monitor brackets 430 at one or more articulating monitor member pivots 594. Monitor bracket 430 is described and shown above with reference to FIG. 9b. Such components may allow sufficient movement of monitors 270 to assume a closed or storage configuration and an open or operational configuration. Like described above, one or more articulating knuckles 580, articulating members 590, or other components of this third embodiment shown and described in FIG. 15 can be mechanically biased or otherwise assist movement of one or more monitors 272, 274.

FIG. 15c shows case 10 from FIG. 15a with monitors 270 in a partially open configuration, That is, monitors 270 have been moved from a stacked configuration relative to laptop 230 and computing surface 360 to a position whereby monitors 270 are generally located above and out of alignment with laptop 230 and computing surface 360. This can be achieved, for example, by moving one or more knuckles 580 located closest to anchor 570. It is also contemplated that other knuckles 580 could be moved to reposition members 590 relative to each other. Numerous partial open configurations are possible with articulating monitor arm 560.

FIG. 15d shows articulating monitor arm 560 in a final operational configuration, though many such configurations are possible. As shown, monitors 270 can be positioned generally above laptop 230 and computing surface 360. Similar to described above, one or more monitor brackets 430 can pivot relative to monitor mount 260 and arm 560. In some embodiments, articulating monitor arm 560 can be mechanically biased. In addition, articulating monitor arm 560 can permit general movement of one or more additional monitors 270 by about 40 degrees in front and backwards directions. Further, case 10 could include two or more articulating monitor arms 560. And articulating monitor arm 560 can be directly coupled to base 20.

FIG. 15e shows articulating monitor arm 560 alone in the final open or operational configuration shown in FIG. 15d. In particular, FIG. 15e shows articulating knuckles 581, 582, 583, 584 and articulating monitor members 594, 596. In some embodiments, knuckle 581 may move from about 90 to about 70 degrees relative to a horizontal plane. Knuckle 581 may also be lockable in the closed and open positions. One or more other knuckles may also be lockable in open or closed configurations. In some embodiments, knuckle 582 may move from about 180 to about 120 degrees relative to a horizontal plane. In some embodiments, knuckle 583 may move from about 0 to about 150 degrees relative to a horizontal plane. In some embodiments, knuckle 584 may move from about 90 to about 180 degrees relative to a horizontal plane.

In operation, case 10 may be generally transported and stored as described above. Then, a user may desire to work with case 10 in an operation configuration on working surface 190. The user may then use case 10 as described below.

Initially, a user may position base 20 of case 10 on working surface 190. They may then unlock lid 30 of case 10 from base 20. The user may then move lid 30 relative to base 20 to reveal computing surface 360, where surface 360 can be configured to receive a computing device. Movement of lid 30 relative to base 20 can be releasably lockable and unlockable. Movement of lid 30 relative to base 20 may be limited, by for example, one or more lid stays 210. Once lid 30 is appropriately positioned and secured relative to base 20, monitor mount 260 may be unlocked from lid 30. Movement of the monitor mount 260 relative to case 10 can be releasably lockable and unlockable. One or more additional monitors 270 and/or one or more monitor mounts 260 may be moved relative to case 10 to generally position one or more additional monitors 270 generally above computing surface 360. The user may use case 10 in a fully open and operational configuration either standing or sitting.

The method above can further include positioning a center of one or more additional monitors 270 about 12 to about 20 inches above computing surface 360. Also, monitor 270 can be tilted relative to case 10 when lid 30 is in a fully open configuration.

The method above can further include deploying at least one leg 110 from base 20 to generally position a bottom surface of base 20 about 4 inches to about 12 inches above working surface 190 located underneath base 20. Two front legs 112 and two rear legs 114 can be deployed from base 20, wherein the distal ends of two rear legs 114 can extend past a back edge of base 20. And the distal ends of two rear legs 114 can extend past a back edge of lid 30 in a fully open configuration.

These and other advantage of case 10 will be readily apparent to those of ordinary skill in the art. They will also appreciate that case 10 need not have all the functions or features described herein. As such, the scope of this disclosure can include various omissions of components described herein; and/or additional features and functions to those described or shown above.

1. A case configured to receive a computing device and at least one additional monitor, comprising:
a base having a computing surface configured to receive the computing device;
a lid moveable relative to the base from a closed configuration to an open configuration, the closed configuration permitting transport of the computing device and the at least one additional monitor within the case, and the open configuration permitting use of the computing device in conjunction with the at least one additional monitor; and
a monitor mount configured to fixedly couple to the at least one additional monitor and move to position the at least one additional monitor for use generally above the computing device when the lid is in the open configuration and position the at least one additional monitor for storage generally parallel to the computing surface when the lid is in the closed configuration.

2. The case of claim 1, wherein the base is generally flat, the lid further includes a recess configured to receive the at least one additional monitor in the closed configuration, and the computing device includes at least one of a laptop, a tablet, and a mouse.

3. The case of claim 1, when in the open configuration, the lid is positioned at about 110 degrees relative to base and a center of the at least one additional monitor is located about 12 inches to about 20 inches above the computing surface of the base.

4. The case of claim 1, further including at least one lid stay configured to limit the rotational movement of the lid relative to the base and releasably secure the lid and the base in the open configuration, wherein the at least one lid stay is slidably or pivotably coupled to at least one of the lid and the base.

5. The case of claim 1, wherein the at least one additional monitor is moveable from a first position wherein the at least one additional monitor is located generally within the lid to a second position wherein the at least one additional monitor is located generally above the lid.

6. The case of claim 1, wherein the base is coupled to at least one leg configured to move from a retracted configuration wherein the at least one leg is generally parallel to a bottom surface of the base to an extended configuration wherein a distal end of the at least one lea is in contact with a working surface located about 28 to about 38 inches above a travel surface to locate the bottom surface of the base about 4 inches to about 12 inches above the working surface.

7. The case of claim 6, wherein the at least one leg in the extended configuration extends from the bottom surface of the base at an angle greater than 90 degrees such that the distal end of the at least one leg contacts the working surface generally behind a back edge of the bottom surface of the base.

8. The case of claim 7, wherein the at least one leg includes a front leg having a length between about 6 inches to about 9 inches and angled at about 90 degrees relative to the base in the extended configuration, and a back leg having a length between about 8 inches and about 12 inches and angled at about 125 to about 145 degrees relative to the base in the extended configuration.

9. The case of claim 6, wherein the base further includes at least one leg box configured to receive at least one of the at least one legs, wherein in the retracted configuration, the at least one leg is generally within the leg box.

10. The case of claim 9, wherein the leg box further includes a leg mounting mechanism configured to releasable lock and unlock the at least one leg in at least one of the retracted and extended configurations.

11. The case of claim 1, wherein the base has at least one base surface configured to contact a working surface when the case is in the open and closed configurations, and the lid has at least one lid surface configured to contact the working surface in only the open configuration when the at least one base surface is in contact with the working surface to maintain the lid at an angle relative to the base of greater than about 90 degrees.

12. The case of claim 11, wherein the at least one lid surface is located generally behind a center-of-mass of the case when the lid is in the open configuration and the at least one additional monitor is located generally above the computing device.

13. The case of claim 1, wherein the monitor mount further includes an L-bracket and the lid further includes a latch, wherein the L-bracket and the latch are configured to releasably lock and unlock to releasably lock and unlock the monitor mount to the lid.

14. The case of claim 13, wherein the L-bracket is pivotably coupled to the lid.

15. The case of claim 14, wherein the L-bracket is pivotably and slidably coupled to the lid via a rail that extends from a first internal surface of the lid to a second internal surface of the lid generally located opposite the first internal surface of the lid.

16. The case of claim 15, wherein the rail includes at least one recess configured to receive a pivot of the L-bracket.

17. The case of claim 1, wherein the monitor mount includes an articulating monitor arm configured to provide general movement and fixed positioning of the monitor relative to the base.

18. The case of claim 1, wherein the monitor mount further includes at least one monitor bracket configured to receive one of the at least one additional monitors and allow movement of the one additional monitor relative to the monitor mount.

19. The case of claim 18, wherein the monitor mount includes two monitor brackets, each configured to receive one of the at least one additional monitors, wherein the two monitor brackets include at least one hinge configured to allow the two monitors to rotate relative to each other from a closed configuration to an open configuration.

20. The case of claim 1, further including a monitor mount release configured to releasable lock and unlock movement of the monitor mount relative to the lid.
